(19) United States
(12) Patent Application Publication
(10) Pub. No.: US 2024/0361779 A1
(43) Pub. Date: Oct. 31, 2024

(54) LIGHT OUTPUT USING LIGHT SOURCES OF A ROBOT

(71) Applicant: Boston Dynamics, Inc., Waltham, MA (US)

(72) Inventors: Brian Todd Dellon, West Roxbury, MA (US); Federico Vicentini, Lexington, MA (US); John Frederick Needleman, Nashua, NH (US); Leland Hepler, Lexington, MA (US); Mario Bollini, Somerville, MA (US); David Yann Robert, Somerville, MA (US)

(21) Appl. No.: 18/640,544

(22) Filed: Apr. 19, 2024

Related U.S. Application Data
(60) Provisional application No. 63/497,536, filed on Apr. 21, 2023.

(51) Int. Cl. G05D 1/622; G05D 109/12; G05D 111/10

(52) U.S. Cl. CPC G05D 1/622; G05D 2109/12; G05D 2111/10

(57) ABSTRACT

Systems and methods are described for outputting light and/or audio using one or more light and/or audio sources of a robot. The light sources may be located on one or more legs of the robot, a bottom portion of the robot, and/or a top portion of the robot. The audio sources may include a speaker and/or an audio resonator. A system can obtain sensor data associated with an environment of the robot. Based on the sensor data, the system can identify an alert. For example, the system can identify an entity based on the sensor data and identify an alert for the entity. The system can instruct an output of light and/or audio indicative of the alert using the one or more light and/or audio sources. The system can adjust parameters of the output based on the sensor data.

### CROSS REFERENCE TO RELATED APPLICATIONS

This application claims priority under 35 U.S.C. § 119 (e) to U.S. Provisional Application 63/497,536, filed on Apr. 21, 2023. The disclosure of this prior application is considered part of the disclosure of this application and is hereby incorporated by reference in its entirety.

### TECHNICAL FIELD

This disclosure relates generally to robotics, and more specifically, to systems, methods, and apparatuses, including computer programs, for outputting light and/or audio (e.g., indicative of an alert for an entity within an environment of the robot) using light and/or audio sources of the robot.

### BACKGROUND

Robotic devices can autonomously or semi-autonomously navigate environments to perform a variety of tasks or functions. The robotic devices can utilize sensor data to navigate the environments without contacting obstacles or becoming stuck or trapped. As robotic devices become more prevalent, there is a need to enable the robotic devices to output light and/or audio in a specific manner as the robot navigates the environment. For example, there is a need to enable the robotic devices to output light and/or audio to indicate an alert to an entity in the environment in a safe and reliable manner.

### SUMMARY

An aspect of the present disclosure provides a robot may include a body, two or more legs coupled to the body, and one or more light sources positioned on the body. The one or more light sources may project light on a ground surface of an environment of the robot.

In various embodiments, the one or more light sources may be positioned on a bottom of the body inwardly of the two or more legs.

In various embodiments, the light may be indicative of an alert.

In various embodiments, the one or more light sources may be located on a bottom portion of the body relative to the ground surface of the environment of the robot.

In various embodiments, the one or more light sources may face the ground surface of the environment of the robot.

In various embodiments, the one or more light sources may be recessed within the body.

In various embodiments, the one or more light sources may be located on a side of the body. The one or more light sources may be at least partially shielded to prevent upward projection of light in a stable position.

In various embodiments, the one or more light sources may project light having an angular range on the ground surface of the environment of the robot such that the light extends beyond a footprint of the two or more legs based on the angular range.

In various embodiments, the one or more light sources may project the light on the ground surface of the environment of the robot such that a modifiable image or a modifiable pattern is projected on the ground surface of the environment of the robot.

In various embodiments, the one or more light sources may be positioned on a bottom of the body inwardly of the two or more legs. The one or more light sources may be positioned and may project light downwardly and outwardly beyond a footprint of the two or more legs such that inner surfaces of the two or more legs are illuminated.

In various embodiments, the one or more light sources may be associated with a minimum brightness of light. The light may have a brightness of light greater than the minimum brightness of light.

According to various embodiments of the present disclosure, a legged robot may include a body, four legs coupled to the body, and one or more light sources located on one or more of a leg of the four legs, a bottom portion of the body, the bottom portion of the body closer in proximity to a ground surface of an environment about the legged robot as compared to a top portion of the body when the robot is in a stable position, or a side of the body. Any light sources located on the top portion of the body may be at least partially shielded to prevent upward projection of light in the stable position. The one or more light sources may be positioned and may project light on the ground surface of the environment of the legged robot.

In various embodiments, the one or more light sources may project the light on the ground surface according to a light pattern. The light pattern may include one or more of a temporal pattern of lights to be emitted by the one or more light sources or a visual pattern of lights to be emitted by the one or more light sources.

In various embodiments, the one or more light sources may project light downwardly and outwardly beyond a footprint of the four legs such that one or more dynamic shadows associated with the four legs are projected on a surface of the environment.

In various embodiments, the one or more light sources may illuminate one or more inner surfaces of the four legs.

In various embodiments, the light may be indicative of an alert.

In various embodiments, the one or more light sources may be recessed within a portion of the legged robot.

In various embodiments, the one or more light sources may project light having an angular range on the ground surface of the environment of the legged robot such that the light extends beyond a footprint of one or more of the four legs based on the angular range.

In various embodiments, the one or more light sources may project the light on the ground surface of the environment of the legged robot such that a modifiable image or a modifiable pattern is projected on the ground surface of the environment of the legged robot.

According to various embodiments of the present disclosure, a method for operating a legged robot may include obtaining sensor data associated with an environment of a legged robot from one or more sensors of the legged robot. The method may further include determining an alert based on the sensor data. The method may further include instructing a projection of light on a surface of the environment of the legged robot indicative of the alert using one or more light sources of the legged robot.

In various embodiments, the surface of the environment of the legged robot may include a ground surface of the environment of the legged robot, a wall of the environment of the legged robot, or a surface of a structure, object, entity, or obstacle within the environment of the legged robot.

In various embodiments, the surface of the environment of the legged robot may include a grated surface of the environment of the legged robot, a permeable surface of the environment of the legged robot, a surface of the environment of the legged robot with one or more holes, or a viscous surface of the environment of the legged robot.

In various embodiments, the surface of the environment of the legged robot may include a ground surface of the environment of the legged robot. The ground surface of the environment of the legged robot may include at least one stair.

In various embodiments, the one or more light sources may be associated with a minimum brightness of light.

In various embodiments, the method may further include determining a brightness of light to be emitted based on the sensor data. Instructing the projection of light on the surface of the environment of the legged robot may include instructing the projection of light on the surface of the environment of the legged robot according to the determined brightness of light.

In various embodiments, the one or more light sources may be associated with a minimum brightness of light. The determined brightness of light may be greater than the minimum brightness of light.

In various embodiments, instructing the projection of light on the surface of the environment of the legged robot may include instructing display of image data on the surface of the environment of the legged robot.

In various embodiments, the method may further include detecting a moving entity in the environment of the legged robot. Instructing display of the image data on the surface of the environment of the legged robot may be based on detecting the moving entity in the environment of the legged robot.

In various embodiments, the method may further include detecting a human in the environment of the legged robot. Instructing display of the image data on the surface of the environment of the legged robot may be based on detecting the human in the environment of the legged robot.

In various embodiments, the method may further include obtaining environmental association data linking the environment of the legged robot to one or more entities. Instructing display of the image data on the surface of the environment of the legged robot may be based on the environmental association data.

In various embodiments, the method may further include determining the image data to be displayed. Determining the image data to be displayed may include, based on the sensor data, determining one or more of a light intensity of the image data to be displayed, a light color of the image data to be displayed, a light direction of the image data to be displayed, or a light pattern of the image data to be displayed.

In various embodiments, the method may further include determining the image data to be displayed. Determining the image data to be displayed may include determining an orientation of the legged robot with respect to the environment of the legged robot based on the sensor data. Determining the image data to be displayed may further include determining a light intensity of the image data based on the orientation of the legged robot.

In various embodiments, the method may further include determining the image data to be displayed. Determining the image data to be displayed may include determining that a body of the legged robot is not level based on the sensor data. Determining the image data to be displayed may further include decreasing a light intensity of the image data based on determining that the body of the legged robot is not level.

In various embodiments, the method may further include determining the image data to be displayed. Determining the image data to be displayed may include determining that a body of the legged robot is level based on the sensor data. Determining the image data to be displayed may further include maintaining a light intensity of the image data based on determining that the body of the legged robot is level.

In various embodiments, the one or more light sources may be located on a lower half of a body of the legged robot.

In various embodiments, the one or more light sources may be at least partially covered by one or more shields.

In various embodiments, the one or more light sources may be at least partially covered by at least one leg of the legged robot.

In various embodiments, the one or more light sources may be located on a bottom portion of a body of the legged robot relative to the surface of the environment of the legged robot.

In various embodiments, the one or more light sources may be located on at least one leg of the legged robot.

In various embodiments, the image data may include visual text.

In various embodiments, the method may further include determining the image data to be displayed. Determining the image data to be displayed may include, based on the sensor data, determining one or more of a light intensity of the image data to be displayed, a light color of the image data to be displayed, a light direction of the image data to be displayed, or a light pattern of the image data to be displayed.

In various embodiments, the one or more light sources may include one or more projectors.

In various embodiments, the one or more light sources may include one or more optical devices.

In various embodiments, the alert may include a visual alert. Determining the alert may include determining the visual alert of a plurality of visual alerts based on the sensor data. Each of the plurality of visual alerts may be associated with one or more of a respective light intensity, a respective light color, a respective light direction, or a respective light pattern. Determining the alert may include determining the one or more light sources of a plurality of light sources of the legged robot based on the sensor data and the visual alert. The plurality of light sources may include at least two light sources each associated with different visual alerts of the plurality of visual alerts.

In various embodiments, the plurality of light sources may include one or more of a light emitting diode or a laser.

In various embodiments, the plurality of light sources may include one or more of a light source located at a front portion of the legged robot relative to a traversal direction of the legged robot, a light source located on a bottom portion of a body of the legged robot, the bottom portion of the body of the legged robot may be closer in proximity to the surface of the environment of the legged robot as compared to a top portion of the body of the legged robot, or a light source located on the top portion of the body of the legged robot.

In various embodiments, the determined visual alert may include at least one of a warning, a communication, a notification, a caution, or a signal.

In various embodiments, the determined visual alert may include a warning. The determined visual alert may be indicative of a level of danger associated with the warning.

In various embodiments, the method may further include determining lighting conditions in the environment of the legged robot based on the sensor data. Determining the visual alert may further be based on the lighting conditions in the environment of the legged robot.

In various embodiments, the method may further include determining lighting conditions in the environment of the legged robot based on the sensor data. The method may further include automatically adjusting one or more of the determined visual alert or a manner of displaying the determined visual alert based on the lighting conditions in the environment of the legged robot.

In various embodiments, the method may further include determining one or more light sources in the environment of the legged robot based on the sensor data. The method may further include automatically adjusting one or more of the determined visual alert or a manner of displaying the determined visual alert based on the one or more light sources in the environment of the legged robot.

In various embodiments, determining the visual alert may include determining the visual alert to communicate with a detected entity.

In various embodiments, the determined visual alert may include an indication of one or more of a path of the legged robot, a direction of the legged robot, an action of the legged robot, an orientation of the legged robot, a map of the legged robot, a route waypoint, a route edge, a zone of the legged robot, a state of the legged robot, a zone associated with one or more of an obstacle, entity, object, or structure in the environment of the legged robot, or battery information of a battery of the legged robot. The zone of the legged robot may indicate an area of the environment of the legged robot in which one or more of an arm, a leg, or a body of the legged robot may operate.

In various embodiments, the method may further include identifying an action based on the sensor dat. The sensor data may indicate a request to perform the action. The method may further include instructing movement of the legged robot according to the action. The visual alert may indicate the action.

In various embodiments, the determined visual alert may be based on light output by the light source and one or more shadows caused by one or more legs of the legged robot.

In various embodiments, the method may further include determining data associated with the environment of the legged robot. The method may further include determining an action of the legged robot based on the data. The method may further include selecting an output from a plurality of outputs based on the action. Each of the plurality of outputs may be associated with one or more of a respective intensity, a respective direction, or a respective pattern. The selected output may indicate the action. The projection of light may be associated with the selected output.

In various embodiments, audio output may be associated with the selected output. The method may further include instructing output of the audio output.

In various embodiments, audio output may be associated with the selected output. The method may further include instructing output of the audio output via an audio source.

In various embodiments, selecting the output from the plurality of outputs may include selecting a light output from a plurality of light outputs.

In various embodiments, the selected output may include a light output and an audio output, the projection of light may be associated with the light output. The legged robot may include an audio source. Instructing output of the selected output may include instructing output of the light output using the one or more light sources. Instructing output of the selected output may further include instructing output of the audio output using the audio source.

In various embodiments, the method may further include instructing movement of the legged robot according to the action in response to instructing the projection of light on the surface of the environment of the legged robot.

In various embodiments, selecting the output from the plurality of outputs may be based on determining that a combination of a light output and an audio output correspond to the selected output. The projection of light may be associated with the light output.

In various embodiments, the data may include audio data associated with a second component of the legged robot.

In various embodiments, the method may further include predicting a second component of the legged robot to generate audio data. Determining the data may be based on predicting the second component to generate the audio data.

In various embodiments, the method may further include detecting an entity in the environment of the legged robot based on the sensor data. The data may indicate detection of the entity in the environment of the legged robot.

In various embodiments, the method may further include detecting one or more features in the environment of the legged robot based on the sensor data. The data may indicate detection of the one or more features in the environment of the legged robot. The one or more features may correspond to one or more of an obstacle, an object, a structure, or an entity.

In various embodiments, the method may further include detecting an entity in the environment of the legged robot based on the sensor data. Selecting the output from the plurality of outputs may further be based on detecting the entity in the environment of the legged robot. The entity and the legged robot may be separated by one or more of an obstacle, an object, a structure, or another entity.

In various embodiments, instructing the projection of light on the surface of the environment of the legged robot may include one or more of instructing simultaneous display of a light output using a plurality of light sources of the legged robot or instructing iterative display of the light output using the plurality of light sources. A first light source of the legged robot may correspond to a first portion of the light output and a second light source of the legged robot may correspond to a second portion of the light output.

In various embodiments, the method may include one or more of instructing simultaneous display of an audio output using a plurality of audio sources of the legged robot or instructing iterative display of the audio output using the plurality of audio sources. A first audio source of the legged robot may correspond to a first portion of the audio output and a second audio source of the legged robot may correspond to a second portion of the audio output.

In various embodiments, the method may further include selecting a light pattern to output based on data associated with the environment of the legged robot. The selected light pattern may include one or more of a temporal pattern of lights to be emitted or a visual pattern of lights to be emitted. Instructing the projection of light on the surface of the environment of the legged robot may include instructing the projection of light on the surface of the environment of the legged robot according to the light pattern.

In various embodiments, the light pattern may indicate a path of the legged robot.

In various embodiments, the one or more light sources may include a plurality of light emitting diodes.

According to various embodiments of the present disclosure, a method for operating a robot may include obtaining data associated with an environment about a robot. The method may further include determining an orientation of the robot with respect to the environment about the robot based on the data. The method may further include determining an intensity of light for emission based on the orientation of the robot. The method may further include instructing emission of light according to the determined intensity of light using one or more light sources of the robot.

In various embodiments, the method may further include detecting an entity in the environment about the robot. Instructing emission of light according to the determined intensity of light may further be based on detecting the entity in the environment about the robot.

In various embodiments, the data associated with an environment about the robot may include a map of the environment about the robot.

In various embodiments, the data associated with an environment about the robot may include a map of the environment. The map may indicate one or more of an obstacle, a structure, a corner, an intersection, or a path of one or more of the robot or a human.

In various embodiments, the data associated with an environment about the robot may include a map of the environment. The map may indicate one or more of an obstacle, a structure, a corner, an intersection, or a path of one or more of the robot or a human. The method may further include determining to project light based on the one or more of the obstacle, the structure, the corner, the intersection, or the path. Instructing emission of light according to the determined intensity of light may be based on determining to project light.

In various embodiments, the method may further include detecting a human in the environment about the robot. Instructing emission of light according to the determined intensity of light may further be based on detecting the human in the environment about the robot.

In various embodiments, the method may further include determining that a tilt of a body of the robot one or more of matches, exceeds, is predicted to match, or is predicted to exceed a threshold tilt level based on the orientation of the robot. The determined intensity of light may be less than an intensity of light for emission for the robot with a tilt of the body of the robot one or more of less than or predicted to be less than the threshold tilt level.

In various embodiments, the method may further include determining that a tilt of a body of the robot one or more of matches, exceeds, is predicted to match, or is predicted to exceed a threshold tilt level based on the orientation of the robot. The determined intensity of light may be less than a threshold intensity level based on determining that the tilt of the body of the robot one or more of matches, exceeds, is predicted to match, or is predicted to exceed the threshold tilt level.

In various embodiments, the method may further include defining a threshold intensity level based on one or more of a light level associated with the environment about the robot, a distance between the one or more light sources and an entity within the environment about the robot, a distance between the one or more light sources and a surface of the environment about the robot. The method may further include determining whether a tilt of a body of the robot one or more of matches, exceeds, is predicted to match, or is predicted to exceed a threshold tilt level based on the orientation of the robot. Determining the intensity of light for emission may include determining the intensity of light for emission with respect to a threshold intensity level based on determining whether the tilt of the body of the robot one or more of matches, exceeds, is predicted to match, or is predicted to exceed the threshold tilt level.

In various embodiments, the method may further include determining that a tilt of a body of the robot one or more of matches, exceeds, is predicted to match, or is predicted to exceed a threshold tilt level based on the orientation of the robot. Determining the intensity of light for emission may include decreasing the intensity of light based on determining that the tilt of the body of the robot one or more of matches, exceeds, is predicted to match, or is predicted to exceed the threshold tilt level.

In various embodiments, the method may further include determining that a tilt of a body of the robot one or more of is less than or is predicted to be less than a threshold tilt level based on the orientation of the robot. The determined intensity of light may be a high intensity of light based on determining that the tilt of the body of the robot one or more of is less than or is predicted to be less than the threshold tilt level.

In various embodiments, the method may further include determining that a tilt of a body of the robot one or more of is less than or is predicted to be less than a threshold tilt level based on the orientation of the robot. The determined intensity of light may exceed a threshold intensity level based on determining that the tilt of the body of the robot one or more of is less than or is predicted to be less than the threshold tilt level.

In various embodiments, the method may further include determining that a tilt of a body of the robot one or more of is less than or is predicted to be less than a threshold tilt level based on the orientation of the robot. The determined intensity of light may exceed a threshold intensity level based on determining that the tilt of the body of the robot one or more of is less than or is predicted to be less than the threshold tilt level. The threshold intensity level may be 200 lumens.

In various embodiments, instructing emission of light may include instructing display of an image.

In various embodiments, instructing emission of light may include instructing projection of light on a ground surface of the environment about the robot.

In various embodiments, the one or more light sources may include a plurality of light emitting diodes.

In various embodiments, at least a portion of the one or more light sources are one or more of oriented towards a ground surface of the environment about the robot or at least partially covered.

In various embodiments, instructing emission of light may include instructing projection of light according to the determined intensity of light and one or more of a particular pattern of light, a particular color of light, or a particular frequency of light.

In various embodiments, the method may further include determining a second intensity of light for emission based on the orientation of the robot. The method may further include instructing emission of light according to the determined second intensity of light using one or more second light sources of the robot.

In various embodiments, the method may further include determining a second intensity of light for emission based on the orientation of the robot. The method may further include instructing emission of light according to the determined second intensity of light using one or more second light sources of the robot. Instructing emission of light according to the determined intensity of light and instructing emission of light according to the determined second intensity of light may include simultaneously instructing emission of light according to the determined intensity of light and the determined second intensity of light using the one or more light sources of the robot and the one or more second light sources of the robot.

In various embodiments, instructing emission of light according to the determined intensity of light may include instructing emission of light according to the determined intensity of light during a first time period. The method may further include obtaining second data associated with the environment about the robot. The method may further include determining a second orientation of the robot with respect to the environment about the robot based on the second data. The method may further include determining a second intensity of light for emission based on the second orientation of the robot. The method may further include instructing emission of light according to the determined second intensity of light using the one or more light sources of the robot during a second time period.

In various embodiments, the data may include sensor data from one or more sensors of the robot.

In various embodiments, the orientation of the robot may include an orientation of a body of the robot.

In various embodiments, determining the orientation of the robot may include predicting a future orientation of the robot based on one or more of performance of a roll over action by the robot, performance of a lean action by the robot, performance of a climb action by the robot, a map associated with the robot, or a feature within the environment about the robot.

In various embodiments, the method may further include determining one or more parameters of a perception system of the robot. Determining the intensity of light for emission may further be based on the one or more parameters of the perception system.

In various embodiments, the method may further include determining one or more parameters of one or more sensors of the robot. The one or more parameters may include one or more of a shutter speed or a frame rate. The method may further include determining a data capture time period based on the one or more parameters of the one or more sensors. Determining the intensity of light for emission may further be based on the data capture time period.

In various embodiments, the robot may be a legged robot or a wheeled robot.

According to various embodiments of the present disclosure, a method for operating a robot may include determining one or more parameters of a perception system of a robot. The method may further include determining at least one light emission variable based on the one or more parameters of the perception system. The method may further include instructing emission of light according to the determined at least one light emission variable using one or more light sources of the robot.

In various embodiments, the one or more parameters of the perception system may include one or more parameters of one or more sensors of the robot.

In various embodiments, the one or more sensors may include an image sensor, and the at least one light emission variable may include an intensity of light to be emitted.

In various embodiments, the one or more parameters of the perception system may include one or more of a shutter speed or a frame rate of an image sensor. Determining the at least light emission variable may include determining a light emission pulse frequency and timing to avoid overexposing the image sensor.

In various embodiments, the at least one light emission variable may include a brightness or an intensity.

In various embodiments, the robot may be a legged robot or a wheeled robot.

According to various embodiments of the present disclosure, a method for operating a robot may include obtaining sensor data associated with an environment about a robot. At least a portion of a body of the robot may be an audio resonator. The method may further include determining an audible alert of a plurality of audible alerts based on the sensor data. The method may further include instructing output of the audible alert using the audio resonator. The audio resonator may resonate and output the audible alert based on resonation of the audio resonator.

In various embodiments, the method may further include determining a visual alert based on the sensor data and the audible alert. The method may further include instructing display of the visual alert using one or more light sources of the robot.

In various embodiments, the method may further include obtaining second sensor data associated with the environment about the robot. The method may further include determining a sound level associated with the environment about the robot matches or exceeds a threshold sound level based on the second sensor data. The method may further include determining a visual alert based on the sensor data and determining the sound level matches or exceeds the threshold sound level. The method may further include instructing output of the visual alert using one or more light sources of the robot.

In various embodiments, the method may further include obtaining second sensor data associated with the environment about the robot. The method may further include determining a sound level associated with the environment about the robot matches or is less than a threshold sound level based on the second sensor data. Instructing output of the audible alert may be based on determining the sound level matches or is less than the threshold sound level.

In various embodiments, the method may further include obtaining second sensor data associated with the environment about the robot. The method may further include determining a view of an entity is obstructed based on the second sensor data. Instructing output of the audible alert may be based on determining the view of the entity is obstructed.

In various embodiments, the method may further include obtaining second sensor data associated with the environment about the robot. The method may further include determining a light level associated with the environment about the robot matches or exceeds a threshold light level based on the second sensor data. Instructing output of the audible alert may be based on determining the light level matches or exceeds the threshold light level.

In various embodiments, the method may further include obtaining second sensor data associated with the environment about the robot. The method may further include determining a light level associated with the environment about the robot matches or is less than a threshold light level based on the second sensor data. The method may further include determining a visual alert based on the sensor data and determining the light level matches or is less than the threshold light level. The method may further include instructing output of the visual alert using one or more light sources of the robot.

In various embodiments, the robot may include a piezo transducer. The piezo transducer may resonate the body of the robot.

In various embodiments, a transducer may be affixed to a body of the robot. The transducer may resonate the body of the robot.

In various embodiments, the robot may include a speaker. The speaker and the audio resonator may include different audio sources.

In various embodiments, the robot may include a speaker. Each of the plurality of audible alerts may be associated with the audio resonator or the speaker. The method may further include determining the audible alert is associated with the audio resonator. Instructing output of the audible alert using the audio resonator may be based on determining the audible alert is associated with the audio resonator.

In various embodiments, the method may further include determining a sound level associated with the environment about the robot matches or is less than a threshold sound level based on the sensor data. Determining the audible alert may be based on determining that the sound level matches or is less than the threshold sound level. Instructing output of the audible alert using the audio resonator may be based on determining that the sound level matches or is less than the threshold sound level.

In various embodiments, the method may further include obtaining second sensor data associated with the environment about the robot. The method may further include determining a sound level associated with the environment about the robot matches or exceeds a threshold sound level based on the second sensor data. The method may further include determining a second audible alert of a plurality of audible alerts based on the second sensor data and determining that the sound level matches or exceeds the threshold sound level. The method may further include instructing output of the second audible alert using a speaker of the robot based on determining that the sound level matches or exceeds the threshold sound level.

In various embodiments, determining the audible alert may include obtaining, from a user computing device, input. Determining the audible alert may further include identifying audio data based on the input. Determining the audible alert may further include identifying the audible alert based on the audio data.

In various embodiments, the robot may include two or more legs or two more wheels.

According to various embodiments of the present disclosure, a legged robot may include a body, a transducer, and two or more legs coupled to the body. The transducer may cause a structural body part to resonate and output a sound indicative of an alert.

In various embodiments, the structural body part may include a chassis of the legged robot.

In various embodiments, the structural body part may include one or more body panels of the legged robot.

According to various embodiments of the present disclosure, a robot may include a body, two or more legs coupled to the body, and one or more light sources positioned on a bottom of the body inwardly of the two or more legs. The one or more light sources may be positioned and may project light downwardly and outwardly beyond a footprint of the two or more legs such that inner surfaces of the two or more legs are illuminated.

In various embodiments, the one or more light sources may project light downwardly and outwardly beyond the footprint of the two or more legs such that one or more dynamic shadows associated with the two or more legs are projected on a surface of an environment of the robot.

According to various embodiments of the present disclosure, a robot may include a body, two or more legs coupled to the body, and a plurality of light sources. The plurality of light sources may project light at a surface of an environment of the robot according to a light pattern. The light pattern may include one or more of a temporal pattern of lights to be emitted by the plurality of light sources or a visual pattern of lights to be emitted by the plurality of light sources.

In various embodiments, the plurality of light sources may include a plurality of light emitting diodes.

According to various embodiments of the present disclosure, a robot may include a base, an arm coupled to a top of the base, two or more wheels coupled to a bottom of the base, and one or more light sources positioned on the bottom of the base. The one or more light sources may be positioned and configured to project light downwardly.

In various embodiments, the bottom of the base may face a ground surface of an environment of the robot.

In various embodiments, the bottom of the base may be illuminated.

According to various embodiments of the present disclosure, a robot may include a body, two or more wheels coupled to the body, and one or more light sources positioned on the body and configured to project light on a ground surface of an environment of the robot.

According to various embodiments of the present disclosure, a wheeled robot may include a body, four wheels coupled to the body, and one or more light sources located on one or more of: a bottom portion of the body or a side of the body. Any light sources located on the top portion of the body may be at least partially shielded to prevent upward projection of light in the stable position The bottom portion of the body may be closer in proximity to a ground surface of an environment about the wheeled robot as compared to a top portion of the body when the wheeled robot is in a stable position.

According to various embodiments of the present disclosure, a method may include obtaining data associated with an environment about a robot. The method may further include determining one or more lighting parameters of light for emission based on the data associated with the robot. The method may further include instructing emission of light according to the one or more lighting parameters using one or more light sources of the robot.

In various embodiments, the robot may be a legged robot or a wheeled robot.

The details of the one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an example robot for navigating an environment.

FIG. 1B is a schematic view of a navigation system for navigating the robot of FIG. 1A.

FIG. 2 is a schematic view of exemplary components of the navigation system.

FIG. 3A is a schematic view of a topological map.

FIG. 3B is a schematic view of a topological map.

FIG. 4 is a schematic view of an exemplary topological map and candidate alternate edges.

FIG. 5A is a schematic view of confirmation of candidate alternate edges.

FIG. 5B is a schematic view of confirmation of candidate alternate edges.

FIG. 6A is a schematic view of a large loop closure.

FIG. 6B is a schematic view of a small loop closure.

FIG. 7A is a schematic view of a metrically inconsistent topological map.

FIG. 7B is a schematic view of a metrically consistent topological map.

FIG. 8A is a schematic view of a metrically inconsistent topological map.

FIG. 8B is a schematic view of a metrically consistent topological map.

FIG. 9 is a schematic view of an embedding aligned with a blueprint.

FIG. 10A is a schematic view of a plurality of systems of a robot of FIG. 1A FIG. 10B is a schematic view of a plurality of systems of a robot of FIG. 1A.

FIG. 10C is a schematic view of a robot of FIG. 1A.

FIG. 11A is a schematic view of a robot navigating in an environment with a stationary feature.

FIG. 11B is a schematic view of a robot navigating in an environment with a stationary feature with a corresponding threshold.

FIG. 11C is a schematic view of a robot navigating in an environment with a mover.

FIG. 11D is a schematic view of a robot navigating in an environment with a mover with a corresponding threshold.

FIG. 12 is a schematic view of a robot in an environment with a feature with a plurality of thresholds.

FIG. 13A is a schematic view of a route of a robot and corresponding point cloud data.

FIG. 13B is a schematic view of a route of a robot and point cloud data associated with identified features.

FIG. 13C is a schematic view of a route of a robot and identified features.

FIG. 13D is a schematic view of a route of a robot and identified features with corresponding movements.

FIG. 13E is a schematic view of an altered route of a robot based on an identified feature.

FIG. 13F is a schematic view of an altered route of a robot based on an identified feature.

FIG. 14 is a schematic view of an example robot implementing an example communication action based on an identified entity.

FIG. 15 is a schematic view of an example robot implementing an example communication action based on an identified entity.

FIG. 16 is a schematic view of a plurality of systems of a robot similar to that of FIG. 1A.

FIG. 17 is a schematic view of an example robot with one or more example indirect light sources.

FIG. 18A is a schematic view of an example robot with one or more example light sources outputting light.

FIG. 18B is a schematic view of a front portion example robot with one or more example light sources outputting light.

FIG. 18C is a schematic bottom plan view of an example robot with one or more example light sources.

FIG. 18D is a schematic bottom plan view of an example robot with one or more example light sources that output light.

FIG. 18E is a schematic view of an example robot with one or more example indirect light sources located on a side of the example robot.

FIG. 18F is a schematic view of an example robot with one or more example indirect light sources located on a leg of the example robot.

FIG. 19A is a schematic view of an example robot with one or more example light sources outputting light on a surface of the environment.

FIG. 19B is a schematic view of an example robot with one or more example light sources outputting light as the example robot performs an action.

FIG. 20A, FIG. 20B, FIG. 20C, and FIG. 20D are each a schematic view of an example robot with one or more example light sources outputting light indicative of an example alert.

FIG. 21 is a schematic view of an example robot with one or more example light sources outputting light.

FIG. 22A, FIG. 22B, FIG. 22C, FIG. 22D, and FIG. 22E are each a schematic view of an example robot with one or more example light sources outputting light indicative of an example alert.

FIG. 23A, FIG. 23B, FIG. 23C, FIG. 23D, and FIG. 23E are each a schematic view of an example robot with one or more example light sources outputting light as the example robot navigates an environment.

FIG. 24A, FIG. 24B, FIG. 24C, FIG. 24D, and FIG. 24E are each a schematic view of an example robot performing an action based on input from a device.

FIG. 25A, FIG. 25B, FIG. 25C, and FIG. 25D are each a schematic view of an example robot navigating an environment based on input from a device.

FIG. 26 is a flowchart of an example arrangement of operations for a method of communicating with an entity.

FIG. 27A, FIG. 27B, FIG. 27C, FIG. 27D, and FIG. 27E are each a schematic view of an example robot with one or more example light sources outputting light indicative of an example alert.

FIG. 28A, FIG. 28B, FIG. 28C, and FIG. 28D are each a schematic view of an example wheeled robot with one or more example light sources outputting light.

FIG. 29A, FIG. 29B, FIG. 29C, FIG. 29D, FIG. 29E, FIG. 29F, and FIG. 29G are each a schematic view of an example robot operating in an environment that includes one or more example light sources outputting light.

FIG. 30 is a schematic view of an example computing device that may be used to implement the systems and methods described herein.

Like reference symbols in the various drawings indicate like elements.

### DETAILED DESCRIPTION

Generally described, autonomous and semi-autonomous robots can utilize mapping, localization, and navigation systems to map an environment utilizing sensor data obtained by the robots. The robots can obtain data associated with the robot from one or more components of the robots (e.g., sensors, sources, outputs, etc.). For example, the robots can receive sensor data from an image sensor, a lidar sensor, a ladar sensor, a radar sensor, pressure sensor, an accelerometer, a battery sensor (e.g., a voltage meter), a speed sensor, a position sensor, an orientation sensor, a pose sensor, a tilt sensor, and/or any other component of the robot. Further, the sensor data may include image data, lidar data, ladar data, radar data, pressure data, acceleration data, battery data (e.g., voltage data), speed data, position data, orientation data, pose data, tilt data, etc.

The robots can utilize the mapping, localization, and navigation systems and the sensor data to perform navigation and/or localization in the environment and build navigation graphs that identify route data. During the navigation and/or localization in the environment, the robots may identify an output based on identified features representing entities, objects, obstacles, or structures within the environment and/or based on parameters of the robots.

The present disclosure relates to providing an output (e.g., an audio output, a visual output, a haptic output, etc.) via one or more components (e.g., a visual source, an audio source, a haptic source, etc.) of the robot. For example, the visual output may be a light output provided via a light source of the robot. In some examples described herein, the light output may be particularly useful for interacting with entities in the environment, and particularly with any humans in the environment. Indirect lighting can be provided with greater brightness than direct lighting, and can serve as a warning to humans from a significant distance, or with intervening obstacles, without risk of blinding or alarming any humans in the environment. A system can customize the output according to sensor data associated with the robot (e.g., sensor data obtained via one or more components of the robot).

The system may be located physically on the robot, remote from the robot (e.g., a fleet management system), or located in part on board the robot and in part remote from the robot (e.g., the system may include a fleet management system and a system located physically on the robot).

The robot may be a stationary robot (e.g., a robot fixed within the environment), a partially stationary robot (e.g., a base of the robot may be fixed within the environment, but an arm of the robot may be maneuverable), or a mobile robot (e.g., a legged robot, a wheeled robot, etc.).

In a particular example of a light source of the robot, the present disclosure relates to outputting light by a robot using one or more light sources (e.g., sources of light, lighting, optical devices, projectors, displays, lasers, laser projectors, light bulbs, lamps, etc.) of the robot. In some cases, the robot may include a plurality of light sources. For example, the one or more light sources may include a row, a column, an array, etc. of light sources. A system may utilize the plurality of light sources to output patterned light (e.g., visually patterned light such as a symbol or temporally patterned light such as a video). In some cases, the plurality of light sources may include multiple types, sizes, etc. of light sources. For example, the plurality of light sources may include different types and/or sizes of light emitting diodes (LEDs) (e.g., miniature LEDs, high-power (ground effect) LEDs, etc.).

The one or more light sources can be positioned such that the one or more light sources project light on a surface of the environment. For example, the one or more light sources may project light on a ground surface of the environment of the robot.

In one example, the present disclosure relates to the output of light on a surface of an environment of the robot. For example, a system can identify light to be output indicative of a particular alert and may instruct output (e.g., projection, display, production, emission, generation, provision, etc.) of the light on a surface of the environment of the robot. The surface may include a ground surface (robot-supporting surface) of the environment, a wall, a ceiling, one or more stairs, a surface of an obstacle, entity, structure, or object, etc. Further, the surface may be a grated surface (e.g., a surfaces with one or more grates), a permeable surface, a surface with one or more holes, a surface with a layer of liquid on the surface, or a viscous surface. In some cases, the surface may include a surface of the robot (e.g., a leg of the robot).

To output the light on the surface of the environment of the robot, the robot may include one or more light sources. The one or more light sources may include incandescent light sources and/or luminescent light sources. For example, the one or more light sources may include one or more light emitting diodes. In some cases, the one or more light emitting diodes may include light emitting diodes associated with a plurality of colors. For example, the one or more light emitting diodes may include a red light emitting diode, a green light emitting diode, and/or a blue light emitting diode. In some cases, the one or more light sources may be associated with a diffraction element (e.g., a diffractive grating) of the robot such that light emitted or projected by the one or more light sources is diffracted.

The one or more light sources may be located (e.g., mounted, placed, affixed, installed, equipped, etc.) at one or more locations on the robot. The one or more light sources may be recessed within the robot such that the one or more light sources may not protrude from the robot. In some cases, the one or more light sources may not be recessed within the robot and may protrude from the robot.

In some cases, the one or more light sources may be located on a bottom portion of the robot relative to a ground surface of the environment of the robot. For example, the bottom portion of the robot may include a portion of the robot closer to a ground surface of the environment of the robot as compared to a top portion of the robot. In a particular example, a body of the robot may include a bottom, a top, and four sides. In some cases, the bottom portion of the robot may include the bottom and the top portion of the robot may include the top. In some cases, the bottom portion of the robot may include the bottom and a portion of each of the four sides (e.g., a portion of each of the four sides located closer to the ground surface) and the top portion of the robot may include the top and a portion of each of the four sides (e.g., a portion of each of the four sides located further from the ground surface). For example, all or a portion of the four sides may be divided in half horizontally and the bottom half of each of the four sides may be associated with the bottom portion of the robot and the top half of each of the four sides may be associated with the top portion of the robot. In some cases, the body of the robot may not include one or more of a bottom, a top, or four sides. For example, the body of the robot may be cylindrical.

In some cases, the one or more light sources may be located on a top portion of the robot relative to the ground surface. For example, the one or more light sources may be located on a top portion of a side of the body of the robot. The one or more light sources may be at least partially covered with a cover (e.g., a shroud, a shade, a shield, a lid, a top, a guard, a screen, etc.) such that the one or more light sources output light towards the ground surface. Further, the one or more light sources may not output light and/or may output less light away from the ground surface (e.g., towards an entity) based on the cover. Additionally, the one or more light sources may be prevented from upward projection of light when in a stable position based on the cover.

In some cases, the one or more light sources may be located on one or more legs and/or an arm of the robot. For example, the one or more light sources may be recessed within a leg of the robot. In some cases, the one or more light sources may be affixed to a cover and at least partially covered with a cover such that the one or more light sources output light towards the ground surface.

The one or more light sources can include one or more projecting light sources. The angular range and orientation of the projecting light sources, combined with location on the robot and presence of any covers, can ensure light is projected downwardly, at least when the bottom of the robot is level with the supporting surface.

As discussed above, a system may identify an output (e.g., light to be output) and a manner of output of the light (e.g., lighting parameters of the light) based on data associated with the robot. For example, the system can identify light to be output based on sensor data (e.g., from one or more sensors of the robot, one or more sensors separate from the robot, etc.), route data (e.g., a map), environmental association data, environmental data, parameters of a particular system of the robot, etc. Further, the manner of output may include a direction, frequency (e.g., pulse frequency), pattern, color, brightness, intensity, illuminance, luminance, luminous flux, etc. of the light based on the sensor data.

In a particular example of the data associated with the robot, the system may identify the light and a manner of outputting the light based on parameters of a system of the robot (e.g., a perception system). For example, the parameters of the system of the robot may include a data capture rate of the system.

In another example of the data associated with the robot, the system may identify the light and a manner of outputting the light based on environmental data. The system may identify environmental data associated with the environment of the robot. For example, the system may account for ambient light intensity to determine output intensity to ensure good visibility of the output light.

In another example of the data associated with the robot, a system may obtain route data (e.g., navigational maps). For example, the system may generate the route data based on sensor data and/or may receive the sensor data from a separate computing system. In some cases, the system may process the sensor data to identify route data (e.g., a series of route waypoints, a series of route edges, etc.) associated with a route of the robot. For example, the system may identify the route data based on traversal of the site by the robot. The system can identify an output based on the route data. For example, the system may determine an output based on the route data (e.g., based on the route data indicating that the robot will be within a particular proximity of a human).

In another example of the data associated with the robot, a system may obtain environmental association data linking the environment to one or more entities. For example, the environmental association data may indicate that the environment has previously been associated with an entity (e.g., a human), has been associated with an entity for a particular quantity of sensor data (e.g., over 50% of the sensor data is associated with an entity), etc. The system can identify an output based on the environmental association data. For example, the system may determine an output based on the environmental association data (e.g., based on the environmental association data indicating that the environment has historically been associated with an entity).

In another example of the data associated with the robot, the system may identify the light and a manner of outputting the light based on sensor data. For example, the system may identify a position, location, pose, tilt, orientation, etc. of the robot. The system may identify an output based on the position, location, pose, tilt, orientation, etc. of the robot such that the parameters of the output are adjusted based on the position, location, pose, tilt, orientation, etc.

In some cases, the system may, using the sensor data, identify features (e.g., elements) representing entities, objects, obstacles, or structures within an environment and determine an output indicative of all or a portion of the features (e.g., a particular feature, a particular subset of features, all of the features, etc.). The features may be associated with (e.g., may correspond to, may indicate the presence of, may represent, may include, may identify) one or more obstacles, objects, entities, and/or structures (e.g., real world obstacles, real world objects, real world entities, and/or real world structures). For example, the features may represent or may indicate the presence of one or more obstacles, objects, entities, and/or structures in the real world (e.g., walls, stairs, humans, robots, vehicles, toys, animals, pallets, rocks, etc.) that may affect the movement of the robot as the robot traverses the environment. In some cases, the features may represent obstacles, objects, entities, and/or structures. In other cases, the features may represent a portion of the obstacles, objects, entities, and/or structures. For example, a first feature may represent a first edge of an obstacle, a second feature may represent a second edge of the obstacle, a third feature may represent a corner of the obstacle, a fourth feature may represent a plane of the obstacle, etc.

The features may be associated with static obstacles, objects, entities, and/or structures (e.g., obstacles, objects, entities, and/or structures that are not capable of self-movement) and/or dynamic obstacles, objects, entities, and/or structures (e.g., obstacles, objects, entities, and/or structures that are capable of self-movement). In one example, the obstacles, objects, and structures may be static and the entities may be dynamic. For example, the obstacles may not be integrated into the environment, may be bigger than a particular (e.g., arbitrarily selected) size (e.g., a box, a pallet, etc.), and may be static. The objects may not be integrated into the environment, may not be bigger than a particular (e.g., arbitrarily selected) size (e.g., a ball on the floor or on a stair), and may be static. The structures may be integrated into the environment (e.g., the walls, stairs, the ceiling, etc.) and may be static. The entities may be dynamic (e.g., capable of self-movement). For example, the entities may be adult humans, children humans, other robots (e.g., other legged robots), animals, non-robotic machines (e.g., forklifts), etc. within the environment of a robot. In some cases, a static obstacle, object, structure, etc. may be capable of movement based on an outside force (e.g., a force applied by an entity to the static obstacle, object, structure, etc.).

One or more collections (e.g., sets, subsets, groupings, etc.) of the features may be associated with (e.g., may correspond to, may indicate the presence of, may represent, may include, may identify) an obstacle, object, entity, structure, etc. For example, a first grouping of the features may be associated with a first obstacle in an environment, a second grouping of the features may be associated with a second obstacle in the environment, a third grouping of the features may be associated with an entity in the environment, etc. In some cases, a system of a robot can group (e.g., combine) particular features and identify one or more obstacles, objects, entities, and/or structures based on the grouped features. Further, the system can group and track particular features over a particular time period to track a corresponding obstacle, object, entity, and/or structure. In some cases, a single feature may correspond to an obstacle, object, entity, structure, etc. It will be understood that while a single feature may be referenced, a feature may include a plurality of features.

In some cases, the system may identify the output based on the identified feature. For example, the system may identify the output based on identifying an obstacle. In some cases, the system may identify the output to communicate to an entity corresponding to the feature. For example, the system may identify an output to communicate to a human based on identifying the human.

In some cases, to identify the output, a system may identify a parameter (e.g., a status) of an entity, object, obstacle, or structure within the environment of a robot. The parameter of the entity, object, obstacle, or structure may include a location, a communication status, a moving status, a distracted status, etc. For example, the system may identify whether an entity is present within the environment, is moving within the environment, is communicating with another entity, is distracted, etc. using sensor data and may provide an output. In some cases, the output may identify the parameter of the entity, object, obstacle, or structure.

In some cases, to identify the output, a system may identify a parameter of the robot. For example, the system may identify an operational status, a charge state status, a battery depletion status, a functional status, location, position, network connection status, etc. of a component of the robot (e.g., a leg, an arm, a battery, a sensor, a motor, etc.) and may provide an output (e.g., to an entity). In some cases, the output may indicate the status of the component (e.g., that a battery of the robot is depleted). In a particular example, the system may identify a battery voltage of a battery of the robot and the output may indicate the battery voltage of the battery.

In some cases, the output may be indicative of an alert (e.g., communications, notifications, warnings (e.g., indicative of a danger or risk), cautions, signals, etc.). For example, an output light may simply warn any humans in the immediate environment of the presence of the robot, and may additionally indicate a direction of travel. In another example, the output light may be indicative of an alert identified based on obtained sensor data. In some cases, the output may be indicative of a level of danger or risk (e.g., high danger, low danger, no danger, high risk, low risk, no risk, etc.). For example, the output may be indicative of a level of danger or risk associated with an environment of the robot. A system may communicate the alert (e.g., to an entity) based on causing the light to be output. For example, the alert may be a low battery alert and the output light may be indicative of the low battery alert to a human in an environment of the robot.

In one example, the output may be indicative of a potential event (e.g., a hazard, an incident, etc.) or a potential movement of the robot. In some cases, the output may be provided in real time. The output may be indicative of a danger zone (e.g., a zone that the robot is working within, a zone representing a reach of an appendage of the robot, a footprint (a minimum footprint) of the robot, an occupancy grid, a minimum separation distance (along a direction of planned displacement), etc.). In some cases, the output may be indicative of a likelihood (e.g., a probability) of occurrence of the potential event or potential movement (e.g., a probability of occupancy), an effect (e.g., a distribution) of the potential event or potential movement, etc. within the particular zone. For example, the output may be indicative of a predicted likelihood (e.g., 30%, 40%, etc.) of an occurrence of an event (e.g., a fall, a trip, etc.) by a robot within a particular zone when performing an action (e.g., performing a jump, climbing a set of stairs, reaching for a lever, running, etc.) and/or may be indicative of a predicted effect (e.g., a fall region, sprawl region, etc. impacted by the event) of the occurrence of the event. The system may determine (e.g., predict) the likelihood of the occurrence of the event or the movement, the zone(s) associated with the event or the movement, and/or the effect of the occurrence of the event or the movement based on an environmental condition (e.g., an environment including a slippery ground surface, an environment including less than a threshold number of features, etc.), a status and/or condition of the robot (e.g., an error status, a network connectivity status, a condition of a leg of the robot), objects, structures, obstacles, or entities within the environment, a status of the objects, structures, obstacles, or entities within the environment (e.g., whether an entity is looking at the robot), an action to be performed by the robot and/or other robots within the environment (e.g., running, climbing, etc.), etc.

In some cases, the output may not be indicative of an alert (e.g., an output light may be a periodic or a non-periodic light). An output light may be a colored light (e.g., to change a color of the robot, a ground surface of the environment, etc.). For example, the body of the robot and/or a ground surface (encompassing support surfaces for the robot, including flooring, stairs, etc.) of the environment may be a particular color (e.g., white, brown, etc.) and a system can cause one or more light sources of the robot to output colored light to change the particular color (e.g., from white to neon yellow). Further, the output light may include a spotlight such that the output light is focused on a particular portion of the environment (e.g., on an obstacle). In some cases, the light may be periodically or aperiodically output. For example, the light may be periodically output every ten seconds, thirty seconds, minute, etc. by one or more light sources.

In some cases, the system may identify the alert based on the data associated with the robot and determine an output indicative of the alert. For example, the system may identify a low battery status based on sensor data and identify a low battery alert indicative of the low battery status. In some cases, the system may identify a particular alert based on the sensor data indicating an entity is within the environment. For example, the system may detect a human within an environment based on the sensor data and may identify a particular alert to notify the human (e.g., of the presence of the robot, of a status of the robot, of an intention of the robot, of the robot's recognition of the human in the vicinity, of a status of another entity, obstacle, object, or obstacle, etc.). In some cases, the system may utilize the sensor data to detect the entity and identify an alert to communicate to the entity using output light. Based on the identified alert, the system can identify an output indicative of the alert.

Based on the identified alert, the system can determine light to output indicative of the alert and based on one or more lighting parameters (e.g., light variables, light emission variables, lighting controls, light factors, light properties, light qualities, etc.) using one or more light sources of the robot. For example, for a low battery alert, the system can determine light to output that is indicative of the low battery alert. In some cases, each alert may be associated with different light to be output and/or a different manner of outputting light. Further, each alert may be associated with different lighting parameters (e.g., frequency, pattern, color, brightness, intensity, illuminance, luminance, luminous flux (“lux”), etc.). In some cases, the system may modify the light that is output and/or how the light is output for a particular alert (e.g., based on the sensor data). For example, different output light may be indicative of the same alert based on an adjustment by the system. Further, the system can instruct a light source to output first light indicative of an alert based on first sensor data and can instruct the light source (or a different light source) to output second light indicative of the alert based on second sensor data. For example, certain types of communication (e.g., certain manners of communicating an alert) are suitable for interactions with an adult human and may not be suitable for a child human.

Therefore, the system may identify data associated with the robot determine particular alerts based on the data associated with the robot. For example, the system can identify a feature, classify the feature as a particular entity, and determine a particular alert for the particular entity. For example, the system may utilize one or more detection systems to identify and classify (e.g., detect) a feature. Further, based on identifying and classifying the particular feature as a particular entity, the system can instruct a light source of the robot to output light indicative of the alert.

In some cases, the robot may include one or more audio sources (e.g., speakers, buzzers, audio resonators, etc.) that can output audio indicative of an alert. For example, the robot may include a buzzer that can output a buzzing sound indicative of a particular alert. Further, the structural body parts of the robot (e.g., robot chassis) serve as an audio resonator such that the system can instruct resonation of the body of the robot. Resonation of the body of the robot may cause audio to be output (e.g., audio indicative of an alert), without the need for a separate speaker, and may efficiently generate greater audio volume than a smaller speaker attached to the robot.

In traditional systems, while a robot may include one or more light sources and may provide an alert to an entity, the traditional systems may be configured for direct viewing and thus be limited in the intensity of light output by the light sources. For example, the traditional systems may be limited to utilizing light sources that output light with a low intensity (e.g., less than 80 lumens) and/or may not output light with a high intensity (e.g., higher than 80 lumens). The traditional systems may be limited in such a manner to avoid impairing an entity within the environment. For example, if a human is exposed to light with a high intensity (e.g., higher than 80 lumens), the human may be temporarily blinded (e.g., flash blinded) or permanently even cause permanent eye damage in some cases. Instead, in order to avoid impairing the entity, the traditional systems may be limited in the intensity of light output by the light sources. Therefore, as the traditional systems may be limited in the intensity of light output by the light sources, an entity (e.g., a human) that is not in direct line of sight of the robot or is a particular distance from the robot (e.g., 50 meters, 100 meters, etc.) may not be capable of seeing the light output by the light sources. Further, an entity with impaired vision may not be capable of seeing the light output by the light sources.

In some cases, as the robot may include light sources that output light with low intensity, the light sources may not be capable of outputting light on a surface of the environment of the robot. For example, the output of light on a surface of the environment of the robot may utilize high intensity light and such systems that include such light sources may not be capable of such an output (e.g., projection) of light on a surface. As such systems may not cause the light sources of the robot to output light on a surface, the light may not be noticed by a human and/or the human may not be capable of differentiating different patterns of light. Therefore, it may be advantageous to include the system, as described below, that utilizes variable intensity lights to project light on a surface.

Further, systems that include light sources that are not capable of outputting light on a surface of the environment, the traditional systems may not be capable of outputting light, via the light sources, at the legs of a legged robot to output dynamic shadows within the environment. For example, low intensity light may not be sufficient to cast a shadow based on the legs of the robot. Therefore, it may be advantageous to include the system, as described below, that utilizes variable intensity lights to project light at the legs of a legged robot and to output dynamic shadows within the environment.

In some cases, an environment may include multiple features. For example, the environment may include one or more features corresponding to humans at a plurality of locations within the environment. For example, a first human may be located around a corner relative to the robot, a second human may be located directly in front of the robot, a third human may be located directly behind the robot, a fourth robot may be located at the top of a set of stairs while the robot may be located at the bottom of the set of stairs. In some examples described herein, the system can intelligently adapt light alert output based on differently detected scenarios, positions of the robot relative to environmental features and/or sensed humans in the environment. For example, it may be more effective to instruct the light sources to output light with a higher intensity for humans located around a corner of the robot as compared to humans located in front of the robot. The ability to adapt the manner or intensity of output light for different navigational scenarios, and/or for different detected entities, objects, obstacles, or structures associated with each of the multiple features.

In examples described herein, the robot can also adapt the output light with different intensity based on a status of the robot. If a robot were to output light with a high intensity, regardless of a status of the robot, changes in robot position, location, pose, tilt, orientation, etc., such as a tilted position (e.g., when climbing a box, climbing a stair, engaging with a human, etc.), may cause the human to be flash blinded.

In some cases, the light output by the light sources may interfere with a perception system of the robot, particularly because the indirect nature of the light sources described herein permits higher intensity, projecting lights. For example, the perception system of the robot may include one or more sensors that periodically or aperiodically obtain sensor data while the light sources output light. As the sensors may obtain sensor data that is adjusted based on the light output by the light sources (e.g., sensor data that is adjusted, modified, overexposed, etc.), the sensor data may not be accurate (e.g., the sensor data may not accurately represent the environment). For example, the sensors may obtain first sensor data if the light sources are not outputting light and second sensor data if the light sources are outputting light. The first and second sensor data being different sensor data that may result in different actions for the robot. For example, the first sensor data not indicating an obstacle (e.g., due to overexposure resulting from the light output by the light sources), could cause a robot to continue navigation and, based on the second sensor data indicating the obstacle, cause a robot to stop navigation. In some cases, a portion of the sensors of the robot may be exposed to the light output by the light sources and a portion of the sensors of the robot may not be exposed to the light output by the light sources and/or may be exposed to light output by different light sources. In examples described herein, output of the light sources can be coordinated with sensor operation and or manipulation of sensor data for operation of the perception system, in order to avoid or compensate for interference of the output light with sensor data for the perception system. Further, the output of the light sources and/or the audio sources can be coordinated with sensor operation and/or manipulation of sensor data such that a system can determine a baseline level of audio and/or light associated with the environment (e.g., an environmental baseline). For example, the system can determine a baseline level of audio and/or light associated with the environment that excludes audio and/or light output by the audio sources and/or the light sources. Based on the baseline level of audio and/or light associated with the environment, the system can determine how to and/or can adjust audio and/or light output by the audio sources and/or the light sources. For example, the system can determine how to adjust light output by the light sources to account for baseline light in the environment (e.g., such that the light output is identifiable).

Use of structural robot body part(s) can advantageously produce a high volume, particularly in lower frequency ranges, and avoid a separate speaker for that purpose. However, such a speaker system may not adequately address higher frequency ranges that may be useful for piercing noisy environments (e.g., above 85 decibels) and/or noise protection devices. Accordingly, in addition to an oscillator configured to resonate the robot body part(s), a small buzzer can be supplied for piercing noisy environments and/or car protectors, and/or for generating an alarm in an emergency situation. The robot body part(s) can be used for normal communication alerts, such as simply acknowledging the presence of a human, without harming the hearing of humans in the environment. Further, the system can determine which audio source to utilize for audio output based on environment data (e.g., indicating whether an environment is noisy).

In some cases, a user may attempt to manually define light and/or audio to be output by a robot to perform based on obtained data. However, such a process may be inefficient and error prone as the user may be unable to identify particular light and/or audio based on particular data (e.g., light indicating a battery status, audio indicating the robot has turned over, light indicating a route of the robot, audio indicating that the robot is powering down, etc.) within a particular time period (e.g., while the robot is on a programmed or user-directed path of motion).

The methods and apparatus described herein enable a system to instruct one or more components (e.g., audio sources and/or light sources) of a robot to provide the output (e.g., light, audio, etc.). The system can obtain data associated with the robot and cause the one or more components to provide the output based on the data associated with the robot. For example, the data associated with the robot can indicate parameters of the robot, parameters of the environment, parameters of an entity, an object, a structure, or obstacle in the environment, etc. Further, the system can identify an alert (e.g., based on the data associated with the robot) and the output may be indicative of the alert (e.g., light output by a light source of the robot may be indicative of an alert).

As components (e.g., mobile robots) proliferate, the demand for more accurate and effective alerts from a robot has increased. Specifically, the demand for a robot to be able to effectively and accurately communicate (e.g., the presence and/or an intent of the robot) to and/or with an entity (e.g., a human) in the environment of the robot via the alerts has increased. For example, the demand for a robot to communicate a route of the robot, an action of the robot, etc. has increased.

In another example, the demand for components of a robot to provide high intensity outputs (e.g., high intensity light, high intensity audio, etc.) has increased. Specifically, the demand for components of a robot to customize output based on data associated with the robot has increased. For example, a high intensity output may be beneficial in a particular environment (e.g., a noisy environment) and a low intensity output may be beneficial in another environment (e.g., an environment with a human in close proximity to the robot).

The present disclosure provides systems and methods that enable an increase in the accuracy, effectiveness, and reliability of the alerts communicated by a robot. Further, the present disclosure provides systems and methods that enable an increase in the effectiveness of outputs provided by the robot by customizing the outputs according to data associated with the robot.

Further, the present disclosure provides systems and methods that enable a reduction in the time and user interactions, relative to traditional systems and methods, to generate, obtain, or identify outputs indicative of alerts to be output by components of the robot. These advantages are provided by the embodiments discussed herein, and specifically by implementation of a process that customizes the output based on the data associated with the robot.

As described herein, the process of instructing the provision of an output of a component of the robot may include obtaining data associated with the robot. As discussed above, a system may identify an output (e.g., light to be output) and parameter based on data associated with the robot. For example, the system can identify light to be output based on sensor data, route data, environmental association data, environmental data, parameters of a particular system of the robot, etc. For example, the system may obtain sensor data from one or more sensors of the robots (e.g., based on traversal of the site by the robot). In some cases, the system may generate route data (e.g., based at least in part on the sensor data). In certain implementations, the route data is obtained from a separate system and merged with the sensor data.

The data associated with the robot may indicate one or more parameters of the robot (e.g., a status of a component of the robot), one or more parameters of an object, obstacle, structure, or entity within an environment of the robot (e.g., a status of a human in the environment), or one or more parameters of the environment. For example, the system may obtain the data associated with the robot and identify a location status, a moving status (e.g., moving or not moving), a working status (e.g., working or not working), a health status (e.g., a battery depletion status), a classification (e.g., a classification of a feature as corresponding to an entity, an obstacle, an object, or a structure), a route, a connectivity status (e.g., a connection status for a particular network), etc. In some cases, the parameters of the environment may include a status of the environment (e.g., a crowded environment status, a shaded environment status, a noisy environment status, a blocked environment status, etc.). For example, the system may identify that the environment or a portion of the environment is crowded, is noisy, lacks sufficient natural light (e.g., is shaded), is too bright for visibility of normal light output, is unauthorized for traffic, is unauthorized for robots, etc. In some cases, the system may receive data associated with the robot indicating one or more inputs. For example, a computing device may provide an input indicating an action (e.g., a physical action to perform, an audio or light output of the robot, etc.) for the robot.

The system can utilize the data associated with the robot to determine an alert for the robot. For example, the system can utilize the data associated with the robot to determine an alert associated with the one or more parameters of the robot, an object, an obstacle, a structure, an entity, or the environment. In some cases, the alert may be indicative of the data associated with the robot. For example, the alert may indicate a status of a component of the robot (e.g., a battery status alert, a sensor status alert, etc.), a status of an entity in the environment of the robot (e.g., a human alert), status of the environment (e.g., a crowded environment alert), etc. In another example, the system may use the data associated with the robot to determine a human is within the environment of the robot and may utilize other data (e.g., mapping a particular alert to a human) to determine the alert. Specifically, the system may identify a human within the environment and utilize mapping data to identify an output of the robot that is mapped to the human (e.g., an audio output including a welcome message, a light output including a light show, etc.).

Based on determining the alert, the system can identify an output that is indicative of the alert. For example, the system can identify a light output and/or an audio output that is indicative of the alert. In some cases, the system can identify a particular output based on the alert. For example, for a battery health status alert, the system may identify a light output and, for a welcome message alert, the system may identify an audio output. Therefore, the system can identify an output that is indicative of the alert.

As discussed above, the system can determine how to provide the output. For example, the system can identify output parameters for the output. In the example of a light output, the system can identify lighting parameters (e.g., a frequency, a pattern, a color, a brightness, an intensity, an illuminance, a luminance, a luminous flux, etc.). In the example of an audio output, the system can identify audio parameters (e.g., audio variables, audio emission variables, audio controls, audio factors, audio properties, audio qualities, etc. For example, the audio parameters may include a volume, a pattern, a frequency, a power level, a voltage level, a bandwidth, a delay, a key, a filter, a channel, etc.).

Based on determining how to provide the output, the system can instruct a source of the robot to provide the output. For example, the system can instruct output of light indicative of the alert using one or more light sources of the robot. In some cases, the system can instruct output of the light indicative of the alert on a surface of the environment of the robot. For example, the system can instruct output of the light indicative of the alert on a ground surface, a wall, a ceiling, a surface of a structure, object, entity, or obstacle in the environment (e.g., a stair), etc.

In some cases, the robot may include a plurality of sources. For example, the robot may include a plurality of audio sources, a plurality of light sources, etc. Further, all or a portion of the audio sources and/or the light sources may include a plurality of components. For example, a light source may include one light emitting diode or a plurality of light emitting diodes. In some cases, the plurality of sources having a plurality of types of sources. For example, the plurality of sources may include light sources having different colors, light sources having different intensities, audio sources having different maximum volumes, audio sources having different frequencies, etc. By utilizing a plurality of sources having a plurality of types of sources, the system can determine a dynamic output. For example, the system can utilize a first particular type of source (e.g., a low volume audio source) based on first data associated with the robot (e.g., first sensor data) and a second particular type of source (e.g., a high volume audio source) based on second data associated with the robot (e.g., second sensor data).

The plurality of sources may be distributed across the robot such that the sources can provide particular output (e.g., patterned and projected output). For example, a bottom of a body of the robot may include an array of light sources (e.g., an array of five light emitting diodes) configured to project light downwardly, and the system may determine how to cause the array of light sources to provide light such that a particular patterned light is output by the array of light sources. In some cases, the plurality of sources may include a display and the system may determine how to cause a plurality of components of the display to provide such that a particular output is provided via the display.

The light provided by the one or more light sources of the robot may be high intensity light (e.g., above 80 lumens, above 100 lumens, etc.). To avoid impairing an entity (e.g., a human, an animal, etc.) within the environment of the robot, the one or more light sources may be provided with an orientation, angular range of projection and position to project light downwards. For example, a body of the robot may include four sides, a bottom, and a top, where the bottom of the body of the robot is closer to the ground surface of the environment as compared to the top of the body of the robot, where “ground” is meant to encompass any supporting surface for the robot (e.g., outdoor ground, grass, indoor floors, stairs, etc.). In some cases, the one or more light sources may be recessed within the bottom of the body of the robot. The bottom of the robot may be facing the ground surface of the environment (e.g., during navigation of the environment by the robot). For example, the bottom of the robot may be facing the ground surface of the environment during a particular operation of the robot (e.g., during start up) and facing away from the ground surface of the environment during another operation of the robot (e.g., after the body of the robot is flipped). In some cases, the bottom of the robot may change as the body of the robot is maneuvered. For example, the body of the robot may flip so that a portion of the body of the robot facing the ground surface of the environment may change and the bottom of the body of the robot may also change.

In some cases, the one or more light sources may be located on a side of the robot (e.g., on a portion of the side closer to the ground surface of the environment), on a top of the robot, on a leg of the robot, on an arm of the robot, etc. The one or more light sources may be recessed or covered with a cover (e.g., a partial cover) such that light output by the one or more light sources has a limited angular range of projection and is directed to and output on the ground, at least when the robot is in a standard orientation with the bottom roughly parallel to the ground. For example, the cover may block high intensity light from being output at an entity within an environment (e.g., at the eyes of a human within the environment). In a specific example, the cover may be made of a reflective material such that light is reflected and output on to the ground surface. In some cases, the one or more light sources may be located on one or more of the bottom of the body of the robot, one or more sides of the body, the top of the body, an arm, a leg, etc.

Further, to avoid impairing an entity within the environment of the robot, the system may adjust how light is provided by the one or more light sources. The system may adjust how light is provided by the one or more light sources based on data associated with the robot. Specifically, the system may adjust how light is provided by the one or more light sources based on data associated with the robot indicating a status of the robot and/or a component of the robot. For example, the system may obtain data associated with the robot from one or more sensors of the robot indicating a pose, orientation, location, tilt, position, etc. of the body of the robot.

Based on the data associated with the robot, the system can adjust how the light is provided by the one or more light sources. For example, the system can use the data associated with the robot to determine if a portion of the robot associated with the one or more light sources (e.g., a bottom of a body of the robot) is adjusted relative to a particular pose, orientation, location, tilt, position, etc. of the body of the robot. In some cases, the system can define a threshold (a threshold value, a threshold level, etc.) associated with the robot (e.g., a pose, orientation, location, tilt, position, etc. of the body of the robot). For example, the system can define a threshold tilt of the body of the robot as level or slightly tilted to the back. Based on comparing the data associated with the robot to the threshold pose, orientation, location, tilt, position, etc. of the body of the robot, the system can determine if the one or more light sources may output light that could impair an entity in the environment. For example, the system can determine whether a light source of the one or more light sources may output light into the environment (e.g., at a human) instead of or in addition to outputting light onto the ground surface of the environment based on the data associated with the robot. Based on determining that a light source may output light into the environment, the system may adjust the lighting parameters of the light source to avoid potentially impairing an entity. For example, the system may dim or otherwise reduce an intensity, a brightness, etc. of the light output by the light source when the orientation of the robot risks shining lights from the bottom of the robot into a human's eyes, such as when climbing stairs or other obstacle, when the robot is rolled onto its side or back due to a fall, etc.

At a subsequent time period, the system may determine that the light source may not output light into the environment based on additional data associated with the robot (e.g., indicating that the body of the robot is not tilted). Based on determining that the light source may not output light into the environment, the system may readjust the lighting parameters of the light source (e.g., increase the intensity, brightness, etc. of the light output by the light source).

As discussed above, in some cases, the system may adjust the lighting parameters of the one or more light sources based on parameters (e.g., a frequency) of a perception system of the robot. The perception system of the robot may include one or more sensors of the robot (e.g., image sensors, lidar sensors, ladar sensors, radar sensors, etc.). The parameters of the perception system may include a frequency (e.g., a data capture rate, a data capture time period) of the one or more sensors. For example, the parameters of the perception system may include a frame rate, a shutter speed, etc. for image sensors. Other types of sensors may also be affected by the output of the light sources. The system may determine the parameters of the perception system and, based on the parameters of the perception system, may determine how to adjust the lighting parameters of the one or more light sources. For example, the system may determine that the parameters of the perception system indicate that the perception system is capturing data every quarter second. Based on determining that the parameters of the perception system indicate that the perception system is capturing data every quarter second, the system can adjust the lighting parameters of the one or more light sources such that the one or more light sources are not outputting light when the perception system is capturing data and/or are outputting comparatively less light as compared to when the perception system is not capturing data. By adjusting the lighting parameters of the one or more light sources according to the parameters of the perception system, the system can improve the reliability and accuracy of the perception system in that the perception system may capture reliable and accurate data that the robot may use for navigation.

In some cases, the robot may be a legged robot (e.g., having two, four, etc. legs) and the system may cause the one or more light sources to output light at one or more legs of the robot. Because, in some examples, the one or more light sources can be directed downwardly, a relatively high intensity light can be output. One advantage of such higher intensity light is that the position and angular range of the light sources can be selected to cause dynamic shadows to be output onto a surface of the environment based on outputting light at the one or more legs of the robot. For example, light sources can be located on the bottom of the robot inside the legs. The angular range of projecting light sources is such that they illuminate the inside of the legs, and the legs thus cast shadows on the ground adjacent directly illuminated ground both below the robot and adjacent the robot. As the legs move, the shadows they cast also move, which tends to be noticed by any humans in the environment. Because the shadows extend beyond the robot itself, the dynamic shadows may be noticed by humans in the environment before the robot comes into direct view.

In some cases, the robot may be a wheeled robot (e.g., having two, four, etc. wheels) and the system may cause the one or more light sources to output light at one or more wheels of the robot (e.g., to indicate that the wheels are moving and/or to indicate to an entity to avoid the wheels). For example, the robot may include wheels attached to one or more legs of the robot, wheels attached to a base of the robot, a torso attached to the base of the robot, etc. In another example, the robot may include one or more wheels and one or more arms attached to a base of the robot (and/or the torso of the robot). In another example, the robot may include a base, one or more arms coupled to a top of the base (e.g., facing away from a ground surface of the environment), one or more wheels coupled to a bottom of the base (e.g., facing toward a ground surface of the environment), and one or more light sources positioned on the bottom of the base. The one or more light sources may be positioned and may project light downwardly (e.g., on the ground surface). The one or more light sources may illuminate the bottom of the base, one or more sides of the base (e.g., a bottom portion of the one or more sides which may be closer to the ground surface as compared to a top portion of the one or more sides), the one or more wheels, one or more wheel wells of the one or more wheels, etc. In another example, the robot may include a body, two or more wheels coupled to the body, and one or more light sources positioned on the body. The one or more light sources may project light on a ground surface of an environment of the robot. In another example, the robot may include a body, four wheels coupled to the body, and one or more light sources located on one or more of a bottom portion of the body or a side of the body. The bottom portion of the body may be closer in proximity to a ground surface of an environment of the robot as compared to a top portion of the body when the robot is in a stable position (e.g., when all or a portion of the four wheels are in contact with the ground surface). Any light sources located on the top portion of the body may be at least partially shielded to prevent upward projection of light in the stable position.

In some cases, a system may obtain data associated with an environment about a robot (e.g., a legged robot, a wheeled robot, a partially stationary robot, etc.). The system may determine one or more lighting parameters of light for emission based on the data associated with the robot and may instruct emission of light according to the one or more lighting parameters using one or more light sources of the robot. Audio provided by the robot may be provided via one or more audio sources of the robot. For example, the robot may include one or more audio sources located on, within, adjacent to, etc. the robot. The one or more audio sources may include a buzzer, a speaker, an audio resonator, etc. In some cases, all, or a portion of the one or more audio sources may output audio with different audio parameters. For example, a first audio source (e.g., a buzzer) of the one or more audio sources may output audio with a first volume range or maximum volume and a second audio source (e.g., an audio resonator) of the one or more audio sources may output audio with a second volume range or maximum volume.

In some cases, the robot may include a transducer. The system may cause the transducer to resonate at a particular frequency based on audio to be output. The transducer may be affixed to the body of the robot. For example, the body of the robot may include one or more cavities and the transducer may cause resonation within the body cavities. The transducer may directly vibrate structural body parts, such as body panels or the robot chassis. Further, the transducer may cause the body of the robot to output the audio based on resonating cavities or body parts of the robot.

The system may select a particular audio source for a particular output based on environmental data (e.g., indicating whether the environment is noisy). For example, the system may identify audio data associated with an environment and may select the resonator to output audio if the audio data indicates an environmental audio level below 85 decibels and may select a buzzer to output the audio if the audio data indicates an environmental audio level above or equal to 85 decibels. Further, the system may select a particular audio source based on a criticality of the output. For example, the system may select the resonator to output audio if the output is non-critical (e.g., labeled as non-critical) and may select a buzzer to output the audio if the output is critical (e.g., labeled as critical).

In some cases, the system may adjust the audio parameters of the one or more audio sources based on parameters (e.g., a frequency) of a particular system (e.g., a microphone system) of the robot. The particular system of the robot may include one or more sensors of the robot (e.g., audio sensors, etc.) to obtain audio data. The parameters of the particular system may include a frequency (e.g., an audio capture rate) of the one or more sensors. The system may determine the parameters of the particular system and, based on the parameters of the particular system, may determine how to adjust the audio parameters of the one or more audio sources. For example, the system may determine that the parameters of the particular system indicate that the particular system is capturing audio data every quarter second. In some cases, the system may obtain data from the particular system indicating that the particular system is capturing, will capture, or has captured audio data. Based on determining that the parameters of the particular system indicating how audio data is captured, the system can adjust the audio parameters of the one or more audio sources such that the one or more audio sources are not providing audio when the particular system is capturing data and/or are providing comparatively less audio as compared to when the particular system is not capturing audio data so as to avoid interfering with the particular system.

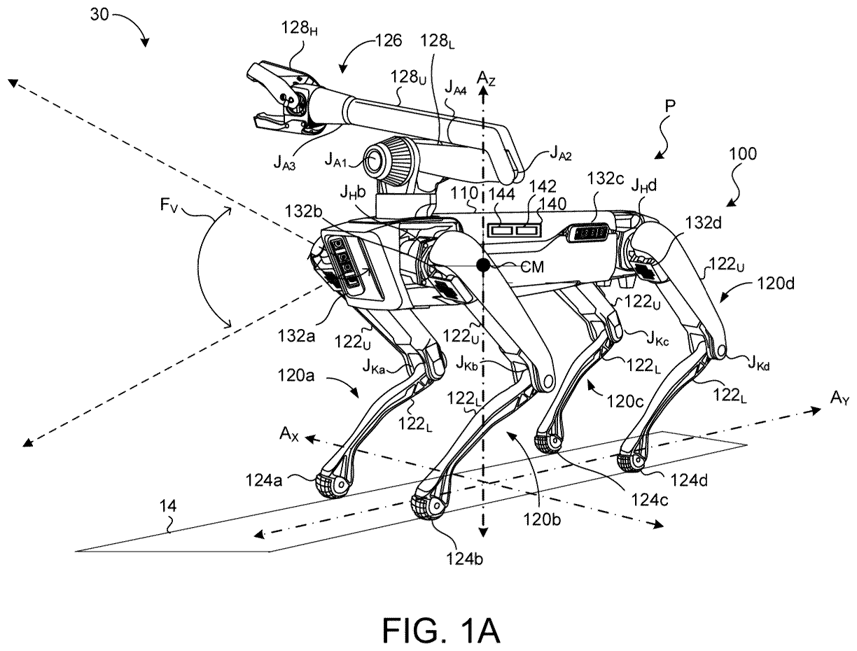

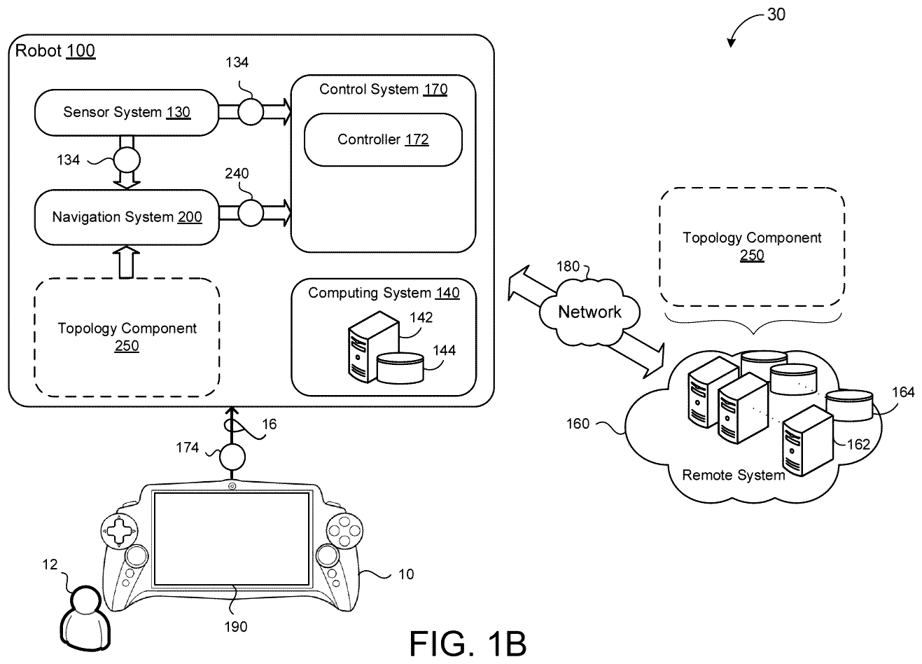

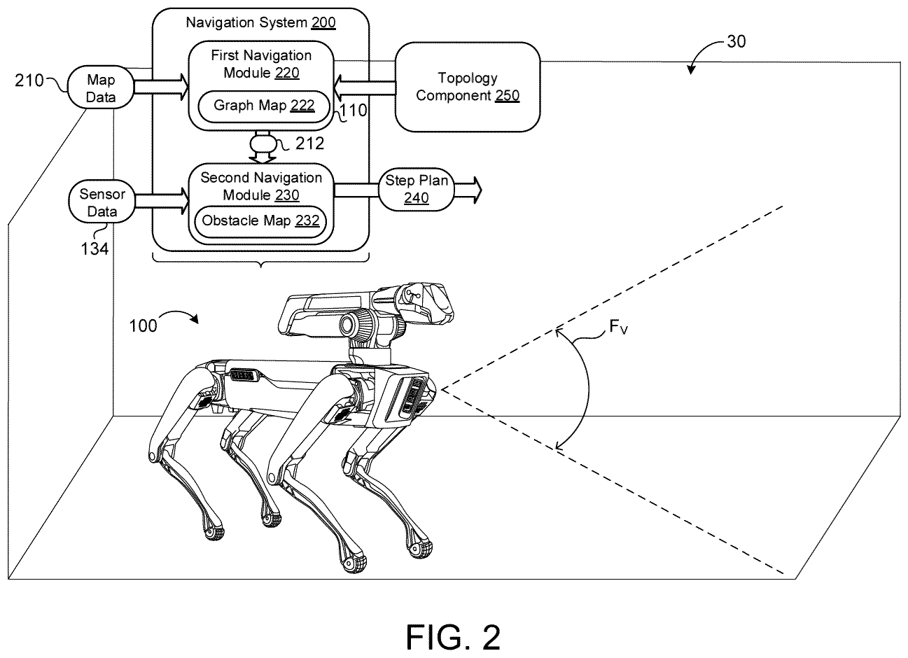

Referring to FIG. 1A, in some implementations, a robot 100 includes a body 110 with one or more locomotion-based structures such as a front right leg 120a, a front left leg 120b, a rear right leg 120c, and a rear left leg 120d coupled to the body 110 that enable the robot 100 to move within an environment 30 that surrounds the robot 100. In some examples, all or a portion of the legs are an articulable structure such that one or more joints J permit members of the leg to move. For instance, in the illustrated embodiment, all or a portion of the legs include a hip joint J_{H} coupling an upper member 122_{U} of the leg to the body 110 and a knee joint J_{K} coupling the upper member 1220 of the leg to a lower member 122_{L} of the leg. Although FIG. 1A depicts a quadruped robot with a front right leg 120a, a front left leg 120b, a rear right leg 120c, and a rear left leg 120d, the robot 100 may include any number of legs or locomotive based structures (e.g., a biped or humanoid robot with two legs, or other arrangements of one or more legs) that provide a means to traverse the terrain within the environment 30.

In order to traverse the terrain, all or a portion of the legs may have a respective distal end (e.g., the front right leg 120a may have a first distal end 124a, a front left leg 120b may have a second distal end 124b, a rear right leg 120c may have a third distal end 124c, and a rear left leg 120d may have a fourth distal end 124d) that contacts a surface of the terrain (e.g., a traction surface). In other words, the distal end of the leg is the end of the leg used by the robot 100 to pivot, plant, or generally provide traction during movement of the robot 100. For example, the distal end of a leg corresponds to a foot of the robot 100. In some examples, though not shown, the distal end of the leg includes an ankle joint such that the distal end is articulable with respect to the lower member of the leg.

In the examples shown, the robot 100 includes an arm 126 that functions as a robotic manipulator. The arm 126 may be configured to move about multiple degrees of freedom in order to engage elements of the environment 30 (e.g., objects within the environment 30). In some examples, the arm 126 includes one or more members, where the members are coupled by joints J such that the arm 126 may pivot or rotate about the joint(s) J. For instance, with more than one member, the arm 126 may be configured to extend or to retract. To illustrate an example, FIG. 1A depicts the arm 126 with three members corresponding to a lower member 128_{L}, an upper member 128_{U}, and a hand member 128_{H} (also referred to as an end-effector). Here, the lower member 128_{L} may rotate or pivot about a first arm joint J_{A1} located adjacent to the body 110 (e.g., where the arm 126 connects to the body 110 of the robot 100). The lower member 128_{L}, is coupled to the upper member 128_{U} at a second arm joint J_{A2} and the upper member 128_{U} is coupled to the hand member 128_{H} at a third arm joint J_{A3}. In some examples, such as FIG. 1A, the hand member 128_{H} is a mechanical gripper (e.g., end effector) that includes a moveable jaw and a fixed jaw configured to perform different types of grasping of elements within the environment 30. In the example shown, the hand member 128_{H} includes a fixed first jaw and a moveable second jaw that grasps objects by clamping the object between the jaws. The moveable jaw is configured to move relative to the fixed jaw to move between an open position for the gripper and a closed position for the gripper (e.g., closed around an object). In some implementations, the arm 126 additionally includes a fourth joint J_{A4}. The fourth joint J_{A4} may be located near the coupling of the lower member 128_{L}, to the upper member 128_{U} and function to allow the upper member 128_{U} to twist or rotate relative to the lower member 128_{L}. In other words, the fourth joint J_{A4} may function as a twist joint similarly to the third joint J_{A3} or wrist joint of the arm 126 adjacent the hand member 128_{H}. For instance, as a twist joint, one member coupled at the joint J may move or rotate relative to another member coupled at the joint J (e.g., a first member coupled at the twist joint is fixed while the second member coupled at the twist joint rotates). In some implementations, the arm 126 connects to the robot 100 at a socket on the body 110 of the robot 100. In some configurations, the socket is configured as a connector such that the arm 126 attaches or detaches from the robot 100 depending on whether the arm 126 is desired for particular operations.

The robot 100 has a vertical gravitational axis (e.g., shown as a Z-direction axis A_{Z}) along a direction of gravity, and a center of mass CM, which is a position that corresponds to an average position of all parts of the robot 100 where the parts are weighted according to their masses (e.g., a point where the weighted relative position of the distributed mass of the robot 100 sums to zero). The robot 100 further has a pose P based on the CM relative to the vertical gravitational axis A_{Z} (e.g., the fixed reference frame with respect to gravity) to define a particular attitude or stance assumed by the robot 100. The attitude of the robot 100 can be defined by an orientation or an angular position of the robot 100 in space. Movement by the front right leg 120a, the front left leg 120b, the rear right leg 120c, and/or the rear left leg 120d relative to the body 110 may alter the pose P of the robot 100 (e.g., the combination of the position of the CM of the robot and the attitude or orientation of the robot 100). Here, a height generally refers to a distance along the z-direction (e.g., along a z-direction axis A_{Z}). The sagittal plane of the robot 100 corresponds to the Y-Z plane extending in directions of a y-direction axis A_{Y} and the z-direction axis A_{Z}. In other words, the sagittal plane bisects the robot 100 into a left and a right side. Generally perpendicular to the sagittal plane, a ground plane (also referred to as a transverse plane) spans the X-Y plane by extending in directions of the x-direction axis A_{X} and the y-direction axis A_{Y}. The ground plane refers to a ground surface 14 where distal ends of the front right leg 120a, the front left leg 120b, the rear right leg 120c, and/or the rear left leg 120d of the robot 100 may generate traction to help the robot 100 move within the environment 30. Another anatomical plane of the robot 100 is the frontal plane that extends across the body 110 of the robot 100 (e.g., from a right side of the robot 100 with the front right leg 120a to a left side of the robot 100 with the front left leg 120b). The frontal plane spans the X-Z plane by extending in directions of the x-direction axis A_{X} and the z-direction axis A_{Z}.

In order to maneuver within the environment 30 or to perform tasks using the arm 126, the robot 100 includes a sensor system with one or more sensors. For example, FIG. 1A illustrates a first sensor 132a mounted at a head of the robot 100 (near a front portion of the robot 100 adjacent the front right leg 120a and the front left leg 120b), a second sensor 132b mounted near the hip J_{H}b of the front left leg 120b of the robot 100, a third sensor 132c mounted on a side of the body 110 of the robot 100, and a fourth sensor 132d mounted near the hip J_{H}d of the rear left leg 120d of the robot 100. In some cases, the sensor system may include a fifth sensor mounted at or near the hand member 128_{H} of the arm 126 of the robot 100. The sensors may include vision/image sensors, inertial sensors (e.g., an inertial measurement unit (IMU)), force sensors, and/or kinematic sensors. For example, the sensors may include one or more of a camera (e.g., a stereo camera), a time-of-flight (TOF) sensor, a scanning light-detection and ranging (lidar) sensor, or a scanning laser-detection and ranging (ladar) sensor. In some examples, the sensor has corresponding field(s) of view F_{V} defining a sensing range or region corresponding to the sensor. For instance, FIG. 1A depicts a field of a view F_{V} for the first sensor 132a of the robot 100. Each sensor may be pivotable, pannable, tiltable, and/or rotatable such that the sensor, for example, changes the field of view F_{V} about one or more axes (e.g., an x-axis, a y-axis, or a z-axis in relation to a ground plane). In some examples, multiple sensors may be clustered together (e.g., similar to the first sensor 132a) to stitch a larger field of view F_{V} than any single sensor. With multiple sensors placed about the robot 100, the sensor system may have a 360 degree view or a nearly 360 degree view of the surroundings of the robot 100 about vertical and/or horizontal axes.

When surveying a field of view F_{V} with a sensor, the sensor system generates sensor data (e.g., image data) corresponding to the field of view F_{V}. The sensor system may generate the sensor data with a sensor mounted on or near the body 110 of the robot 100 (e.g., the first sensor 132a, the third sensor 132c, etc.). The sensor system may additionally and/or alternatively generate the sensor data with a sensor mounted at or near the hand member 128_{H} of the arm 126. The one or more sensors capture the sensor data that defines the three-dimensional point cloud for the area within the environment 30 of the robot 100. In some examples, the sensor data is image data that corresponds to a three-dimensional volumetric point cloud generated by a three-dimensional volumetric image sensor. Additionally or alternatively, when the robot 100 is maneuvering within the environment 30, the sensor system gathers pose data for the robot 100 that includes inertial measurement data (e.g., measured by an IMU). In some examples, the pose data includes kinematic data and/or orientation data about the robot 100, for instance, kinematic data and/or orientation data about joints J or other portions of a leg or arm 126 of the robot 100. With the sensor data, various systems of the robot 100 may use the sensor data to define a current state of the robot 100 (e.g., of the kinematics of the robot 100) and/or a current state of the environment 30 of the robot 100. In other words, the sensor system may communicate the sensor data from one or more sensors to any other system of the robot 100 in order to assist the functionality of that system.

In some implementations, the sensor system includes sensor(s) coupled to a joint J. Moreover, these sensors may couple to a motor M that operates a joint J of the robot 100. Here, these sensors may generate joint dynamics in the form of joint-based sensor data. Joint dynamics collected as joint-based sensor data may include joint angles (e.g., an upper member 122u relative to a lower member 122_{L}, or hand member 126H relative to another member 128 of the arm 126 or robot 100), joint speed, joint angular velocity, joint angular acceleration, and/or forces experienced at a joint J (also referred to as joint forces). Joint-based sensor data generated by one or more sensors may be raw sensor data, data that is further processed to form different types of joint dynamics, or some combination of both. For instance, a sensor measures joint position (or a position of member(s) coupled at a joint J) and systems of the robot 100 perform further processing to derive velocity and/or acceleration from the positional data. In other examples, a sensor is configured to measure velocity and/or acceleration directly.

With reference to FIG. 1B, as the sensor system 130 gathers sensor data 134, a computing system 140 stores, processes, and/or to communicates the sensor data 134 to various systems of the robot 100 (e.g., the control system 170, a navigation system 200, a topology component 250, and/or remote controller 10). In order to perform computing tasks related to the sensor data 134, the computing system 140 of the robot 100 includes data processing hardware 142 and memory hardware 144. The data processing hardware 142 is configured to execute instructions stored in the memory hardware 144 to perform computing tasks related to activities (e.g., movement and/or movement based activities) for the robot 100. Generally speaking, the computing system 140 refers to one or more locations of data processing hardware 142 and/or memory hardware 144.

In some examples, the computing system 140 is a local system located on the robot 100. When located on the robot 100, the computing system 140 may be centralized (e.g., in a single location/area on the robot 100, for example, the body 110 of the robot 100), decentralized (e.g., located at various locations about the robot 100), or a hybrid combination of both (e.g., including a majority of centralized hardware and a minority of decentralized hardware). To illustrate some differences, a decentralized computing system may allow processing to occur at an activity location (e.g., at motor that moves a joint of a leg) while a centralized computing system may allow for a central processing hub that communicates to systems located at various positions on the robot 100 (e.g., communicate to the motor that moves the joint of the leg).

Additionally or alternatively, the computing system 140 includes computing resources that are located remote from the robot 100. For instance, the computing system 140 communicates via a network 180 with a remote system 160 (e.g., a remote server or a cloud-based environment). Much like the computing system 140, the remote system 160 includes remote computing resources such as remote data processing hardware 162 and remote memory hardware 164. Here, sensor data 134 or other processed data (e.g., data processing locally by the computing system 140) may be stored in the remote system 160 and may be accessible to the computing system 140. In additional examples, the computing system 140 is configured to utilize the remote data processing hardware 162 and/or the remote memory hardware 164 as extensions of the data processing hardware 142 and/or the memory hardware 144 such that resources of the computing system 140 reside on resources of the remote system 160. In some examples, the topology component 250 is executed on the data processing hardware 142 local to the robot, while in other examples, the topology component 250 is executed on the remote data processing hardware 162 that is remote from the robot 100.

In some implementations, as shown in FIG. 1B, the robot 100 includes a control system 170. The control system 170 may be configured to communicate with systems of the robot 100, such as the sensor system 130, the navigation system 200, and/or the topology component 250. The control system 170 may perform operations and other functions using hardware such as the computing system 140. The control system 170 includes a controller 172 (e.g., at least one controller) that is configured to control the robot 100. For example, the controller 172 controls movement of the robot 100 to traverse the environment 30 based on input or feedback from the systems of the robot 100 (e.g., the sensor system 130 and/or the control system 170). In additional examples, the controller 172 controls movement between poses and/or behaviors of the robot 100. The controller 172 may be responsible for controlling movement of the arm 126 of the robot 100 in order for the arm 126 to perform various tasks using the hand member 128_{H}. For instance, the controller 172 controls the hand member 128_{H} (e.g., a gripper) to manipulate an object or element in the environment 30. For example, the controller 172 actuates the movable jaw in a direction towards the fixed jaw to close the gripper. In other examples, the controller 172 actuates the movable jaw in a direction away from the fixed jaw to close the gripper.

The controller 172 of the control system 170 may control the robot 100 by controlling movement about one or more joints J of the robot 100. In some configurations, the controller 172 is software or firmware with programming logic that controls at least one joint J or a motor M which operates, or is coupled to, a joint J. A software application (a software resource) may refer to computer software that causes a computing device to perform a task. In some examples, a software application may be referred to as an “application,” an “app,” or a “program.” For instance, the controller 172 controls an amount of force that is applied to a joint J (e.g., torque at a joint J). As the controller 172 may be a programmable controller, the number of joints J that the controller 172 controls is scalable and/or customizable for a particular control purpose. The controller 172 may control a single joint J (e.g., control a torque at a single joint J), multiple joints J, or actuation of one or more members (e.g., actuation of the hand member 128_{H}) of the robot 100. By controlling one or more joints J, actuators or motors M, the controller 172 may coordinate movement for all different parts of the robot 100 (e.g., the body 110, one or more of the front right leg 120a, the front left leg 120b, the rear right leg 120c, and/or the rear left leg 120d, the arm 126). For example, to perform a behavior with some movements, the controller 172 may be configured to control movement of multiple parts of the robot 100 such as, for example, two legs, four legs, or two legs combined with the arm 126. In some examples, the controller 172 is configured as an object-based controller that is set up to perform a particular behavior or set of behaviors for interacting with an interactable object.

With continued reference to FIG. 1B, an operator 12 (also referred to herein as a user or a client) may interact with the robot 100 via the remote controller 10 that communicates with the robot 100 to perform actions. For example, the operator 12 transmits commands 174 to the robot 100 (executed via the control system 170) via a wireless communication network 16. Additionally, the robot 100 may communicate with the remote controller 10 to display an image on a user interface 190 of the remote controller 10. For example, the user interface 190 may be configured to display the image that corresponds to three-dimensional field of view F_{V} of the one or more sensors. The image displayed on the user interface 190 of the remote controller 10 is a two-dimensional image that corresponds to the three-dimensional point cloud of sensor data 134 (e.g., field of view F_{V}) for the area within the environment 30 of the robot 100. That is, the Image displayed on the user interface 190 may be a two-dimensional image representation that corresponds to the three-dimensional field of view F_{V} of the one or more sensors.

Referring now to FIG. 2, the robot 100 (e.g., the data processing hardware 142) executes the navigation system 200 for enabling the robot 100 to navigate the environment 30.

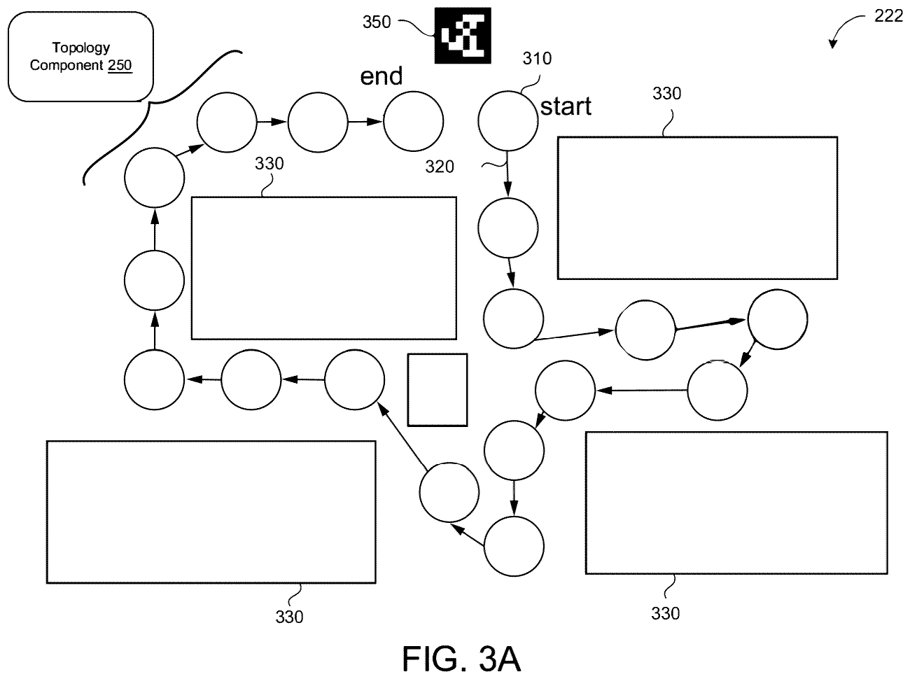

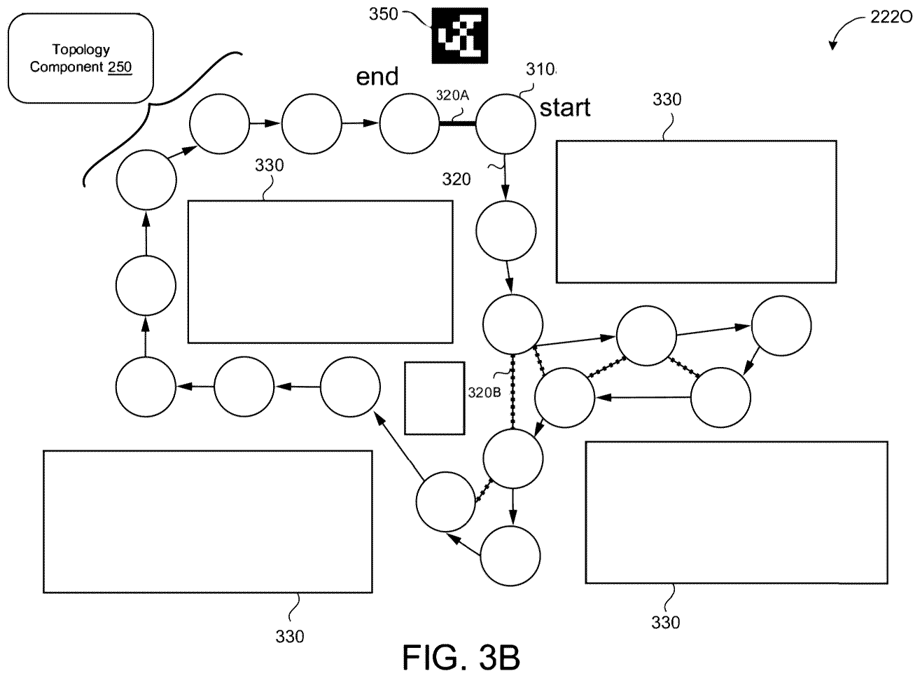

In the example of FIG. 2, the navigation system 200 includes a first navigation module 220 that receives map data 210 (e.g., navigation data representative of locations of static obstacles in the environment 30). In some cases, the map data 210 includes a graph map 222. In other cases, the first navigation module 220 generates the graph map 222 (e.g., a topological map of the environment 30). The first navigation module 220 can obtain (e.g., from a remote system, remote controller, topology component, etc.) and/or generate a series of route waypoints (as shown in FIGS. 3A and 3B) on the graph map 222 for a navigation route 212 that plots a path around large and/or static obstacles from a start location (e.g., the current location of the robot 100) to a destination. Route edges may connect corresponding pairs of adjacent route waypoints. In some examples, the route edges record geometric transforms between route waypoints based on odometry data (e.g., odometry data from motion sensors or image sensors to determine a change in the robot's position over time). The route waypoints and the route edges may be representative of the navigation route 212 for the robot 100 to follow from a start location to a destination location.

As discussed in more detail below, in some examples, the first navigation module 220 receives the map data 210, the graph map 222, and/or an optimized graph map from the topology component 250. The topology component 250, in some examples, is part of the navigation system 200 and executed locally at or remote from the robot 100.

In some implementations, the first navigation module 220 produces the navigation route 212 over a greater than 10-meter scale (e.g., the navigation route 212 may include distances greater than 10 meters from the robot 100). The navigation system 200 also includes a second navigation module 230 that can receive the navigation route 212 and the sensor data 134 (e.g., image data). The second navigation module 230, using the sensor data 134, can generate an obstacle map 232. The obstacle map 232 may be a robot-centered map that maps obstacles (static and/or dynamic obstacles) in the vicinity (e.g., within a threshold distance) of the robot 100 based on the sensor data 134. For example, while the graph map 222 may include information relating to the locations of walls of a hallway, the obstacle map 232 (populated by the sensor data 134 as the robot 100 traverses the environment 30) may include information regarding a stack of boxes placed in the hallway not indicated by the map data 210.

The second navigation module 230 can generate a step plan 240 (e.g., using an A* search algorithm) that plots all or a portion of the individual steps (or other movements) of the robot 100 to navigate from the current location of the robot 100 to the next route waypoint along the navigation route 212. Using the step plan 240, the robot 100 can maneuver through the environment 30. The second navigation module 230 may obtain a path for the robot 100 to the next route waypoint using an obstacle grid map based on the sensor data 134. In some examples, the second navigation module 230 operates on a range correlated with the operational range of the sensor(s) (e.g., four meters) that is generally less than the scale of the first navigation module 220.

Referring now to FIG. 3A, in some examples, the topology component 250 obtains the graph map 222 of an environment 30. For example, the topology component 250 receives the graph map 222 from the navigation system 200 (e.g., the first navigation module 220) or generates the graph map 222 from map data 210 and/or sensor data 134. The graph map 222 includes a series of route waypoints 310 and a series of route edges 320. Each route edge in the series of route edges 320 topologically connects a corresponding pair of adjacent route waypoints in the series of route waypoints 310. Each route edge represents a traversable route for the robot 100 through an environment of a robot. The map may also include information representing one or more obstacles 330 that mark boundaries where the robot may be unable to traverse (e.g., walls and static objects). In some cases, the graph map 222 may not include information regarding the spatial relationship between route waypoints. The robot may record the series of route waypoints 310 and the series of route edges 320 using odometry data captured by the robot as the robot navigates the environment. The robot may record sensor data at all or a portion of the route waypoints such that all or a portion of the route waypoints are associated with a respective set of sensor data captured by the robot (e.g., a point cloud). In some implementations, the graph map 222 includes information related to one or more fiducial markers 350. The one or more fiducial markers 350 may correspond to an object that is placed within the field of sensing of the robot that the robot may use as a fixed point of reference. The one or more fiducial markers 350 may be any object that the robot 100 is capable of readily recognizing, such as a fixed or stationary object of the environment or an object with a recognizable pattern. For example, a fiducial marker may include a bar code, QR-code, or other pattern, symbol, and/or shape for the robot to recognize.

In some cases, the robot may navigate along valid route edges and may not navigate along between route waypoints that are not linked via a valid route edge. Therefore, some route waypoints may be located (e.g., metrically, geographically, physically, etc.) within a threshold distance (e.g., five meters, three meters, etc.) without the graph map 222 reflecting a route edge between the route waypoints. In the example of FIG. 3A, a first route waypoint and a second route waypoint are within a threshold distance (e.g., a threshold distance in physical space or reality), Euclidean space, Cartesian space, and/or metric space, but the robot, when navigating from the first route waypoint to the second route waypoint, may navigate the entire series of route edges 320 due to the lack of a route edge directly connecting the first and second route waypoints. Therefore, the robot may determine, based on the graph map 222, that there is no direct traversable path between the first and second route waypoints. The topological map 222 may represent the route waypoints 310 in global (e.g., absolute positions) and/or local positions where positions of the route waypoints are represented in relation to one or more other route waypoints. The route waypoints may be assigned Cartesian or metric coordinates, such as 3D coordinates (x, y, z translation) or 6D coordinates (x, y, z translation and rotation).

Referring now to FIG. 3B, in some implementations, the topology component 250 determines, using the topological map 222 and sensor data captured by the robot, one or more candidate alternate edges 320A, 320B. Each of the one or more candidate alternate edges 320A, 320B can connect a corresponding pair of the series of route waypoints 310 that may not be connected by one of the series of route edges 320n. As is discussed in more detail below, for all or a portion of the respective candidate alternate edges 320A, 320B, the topology component 250 can determine, using the sensor data captured by the robot, whether the robot can traverse the respective candidate alternate edge 320A, 320B without colliding with an obstacle 330. Based on the topology component 250 determining that the robot 100 can traverse the respective candidate alternate edge 320A, 320B without colliding with an obstacle 330, the topology component 250 can confirm the respective candidate edge 320A and/or 320B as a respective alternate edge. In some examples, after confirming and/or adding the alternate edges to the topological map 222, the topology component 250 updates, using nonlinear optimization (e.g., finding the minimum of a nonlinear cost function), the topological map 222 using information gleaned from the confirmed alternate edges. For example, the topology component 250 may add and refine the confirmed alternate edges to the topological map 222 and use the additional information provided by the alternate edges to optimize, as discussed in more detail below, the embedding of the map in space (e.g., Euclidean space and/or metric space). Embedding the map in space may include assigning coordinates (e.g., 6D coordinates) to one or more route waypoints. For example, embedding the map in space may include assigning coordinates (x1, y1, z1) in meters with rotations (r1, r2, r3) in radians. In some cases, all or a portion of the route waypoints may be assigned as set of coordinates. Optimizing the embedding may include finding the coordinates for one or more route waypoints so that the series of route waypoints 310 of the topological map 222 are globally consistent. In some examples, the topology component 250 optimizes the topology map 222 in real-time (e.g., as the robot collects the sensor data). In other examples, the topology component 250 optimizes the topological map 222 after the robot collects all or a portion of the sensor data.

In this example, the optimized topological map 2220 includes several alternate edges 320A, 320B. One or more of the alternate edges 320A, 320B, such as the alternate edge 320A may be the result of a “large” loop closure (e.g., by using one or more fiducial markers 350), while other alternate edges 320A, 320B, such as the alternate edge 320B may be the result of a “small” loop closure (e.g., by using odometry data). In some examples, the topology component 250 uses the sensor data to align visual features (e.g., a fiducial marker 350) captured in the data as a reference to determine candidate loop closures. It is understood that the topology component 250 may extract features from any sensor data (e.g., non-visual features) to align. For example, the sensor data may include radar data, acoustic data, etc. For example, the topology processor may use any sensor data that includes features (e.g., with a uniqueness value exceeding or matching a threshold uniqueness value).

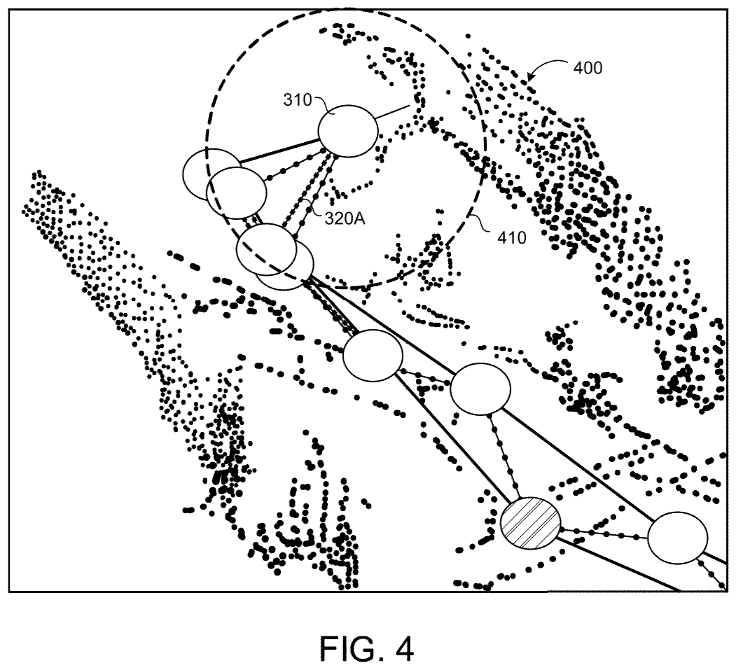

Referring now to FIG. 4, in some implementations, for one or more route waypoints 310, a topology component determines, using a topological map, a local embedding 400 (e.g., an embedding of a waypoint relative to another waypoint). For example, the topology component may represent positions or coordinates of the one or more route waypoints 310 relative to one or more other route waypoints 310 rather than representing positions of the route waypoints 310 globally. The local embedding 400 may include a function that transforms the set of route waypoints 310 into one or more arbitrary locations in a metric space. The local embedding 400 may compensate for not knowing the “true” or global embedding (e.g., due to error in the route edges from odometry error). In some examples, the topology component determines the local embedding 400 using a fiducial marker. For at least one of the one or more route waypoints 310, the topology component can determine whether a total path length between the route waypoint and another route waypoint is less than a first threshold distance 410. In some examples, the topology component can determine whether a distance in the local embedding 400 is less than a second threshold distance, which may be the same or different than the first threshold distance 410. Based on the topology component determining that the total path length between the route waypoint and the other route waypoint is less than the first threshold distance 410 and/or the distance in the local embedding 400 is less than the second threshold distance, the topology component may generate a candidate alternate edge 320A between the route waypoint and the other route waypoint.

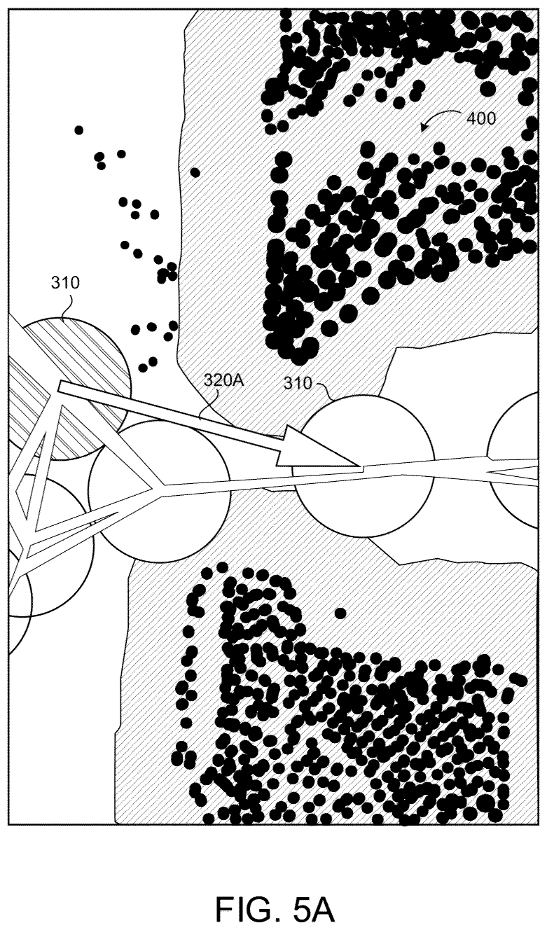

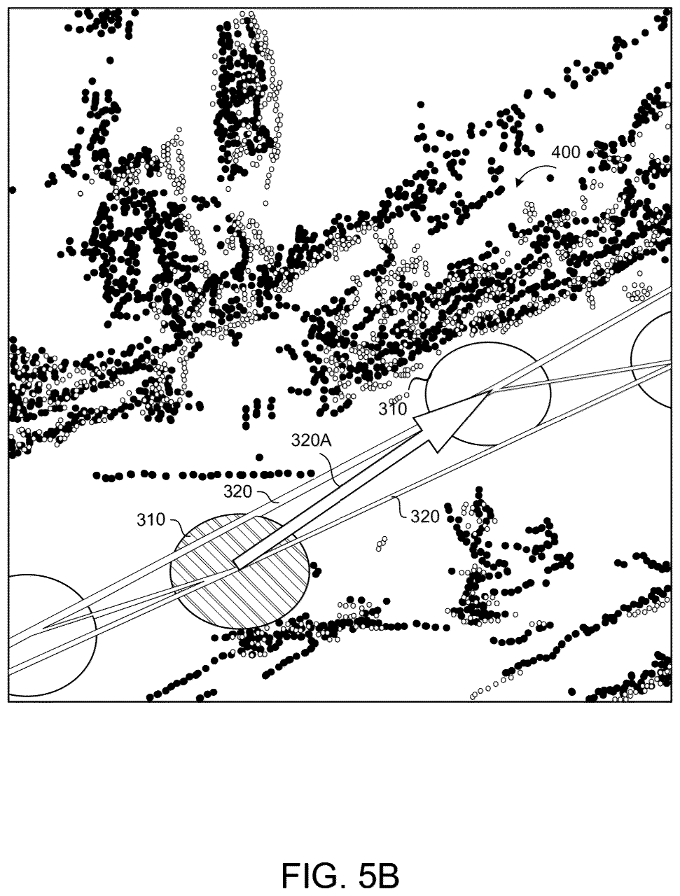

Referring now to FIG. 5A, in some examples, the topology component uses and/or applies a path collision checking algorithm (e.g., path collision checking technique). For example, the topology component may use and/or apply the path collision checking algorithm by performing a circle sweep of the candidate alternate edge 320A in the local embedding 400 using a sweep line algorithm, to determine whether a robot can traverse the respective candidate alternate edge 320A without colliding with an obstacle. In some examples, the sensor data associated with all or a portion of the route waypoints 310 includes a signed distance field. The topology component, using the signed distance field, may use a circle sweep algorithm or any other path collision checking algorithm, along with the local embedding 400 and the candidate alternate edge 320A. If, based on the signed distance field and local embedding 400, the candidate alternate edge 320A experiences a collision (e.g., with an obstacle), the topology component may reject the candidate alternate edge 320A.

Referring now to FIG. 5B, in some examples, the topology component uses/applies a sensor data alignment algorithm (e.g., an iterative closest point (ICP) algorithm, a feature-matching algorithm, a normal distribution transform algorithm, a dense image alignment algorithm, a primitive alignment algorithm, etc.) to determine whether the robot 100 can traverse the respective candidate alternate edge 320A without colliding with an obstacle. For example, the topology component may use the sensor data alignment algorithm with two respective sets of sensor data (e.g., point clouds) captured by the robot at the two respective route waypoints 310 using the local embedding 400 as the seed for the algorithm. The topology component may use the result of the sensor data alignment algorithm as a new edge transformation for the candidate alternate edge 320A. If the topology component determines the sensor data alignment algorithm fails, the topology component may reject the candidate alternate edge 320A (e.g., not confirm the candidate alternate edge 320A as an alternate edge).

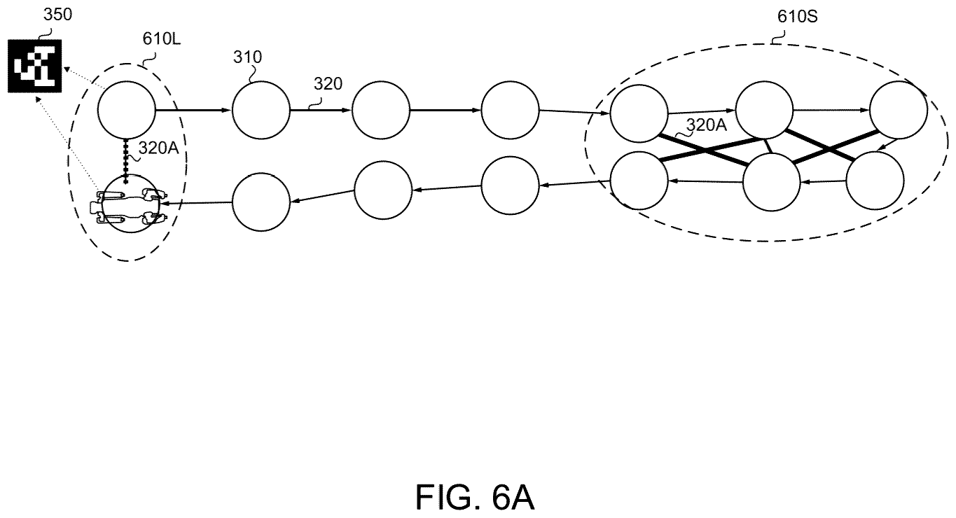

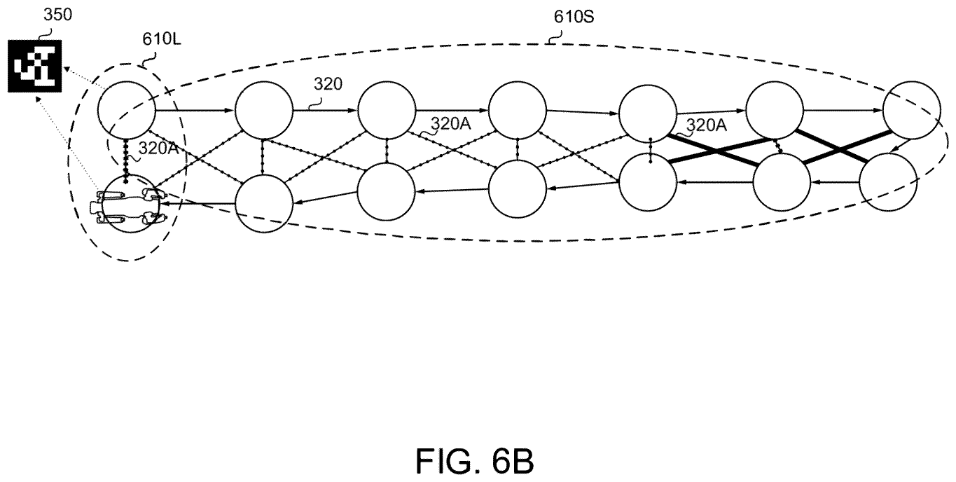

Referring now to FIG. 6A, in some implementations, the topology component determines one or more candidate alternate edges 320A using “large” loop closures 610L. For example, the topology component uses a fiducial marker 350 for an embedding to close large loops (e.g., loops that include a chain of multiple route waypoints 310 connected by corresponding route edges 320) by aligning or correlating the fiducial marker 350 from the sensor data of all or a portion of the respective route waypoints 310. To determine the remaining candidate alternate edges 320A, the topology component may use “small” loop closure 610S using odometry data to determine candidate alternate edges 320A for local portions of a topological map. As illustrated in FIG. 6B, in some examples, the topology component iteratively determines the candidate alternate edges 320A by performing multiple small loop closures 610S, as each loop closure may add additional information when a new confirmed alternate edge 320A is added.

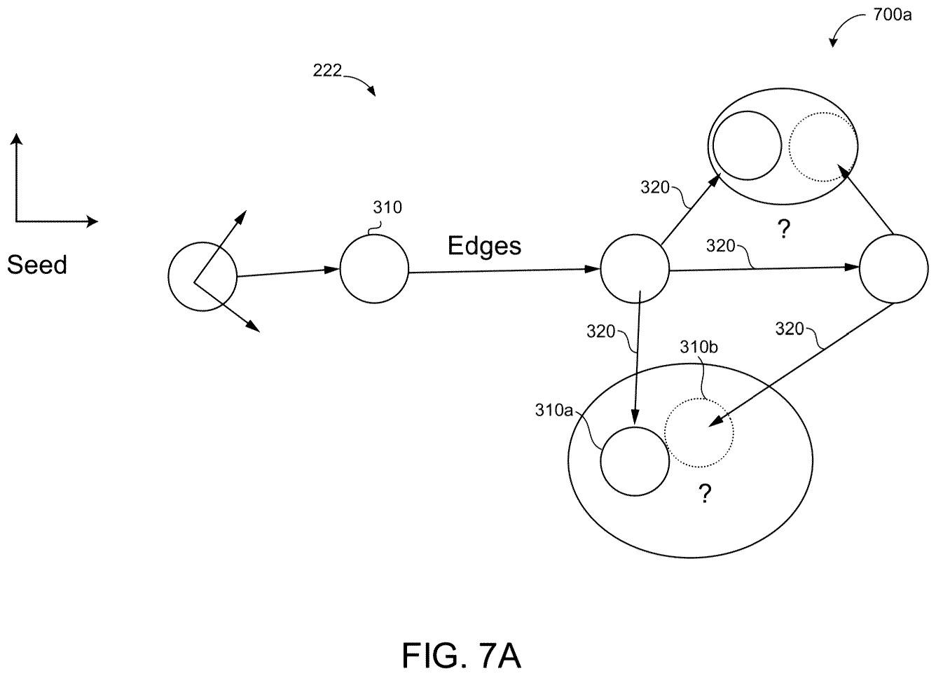

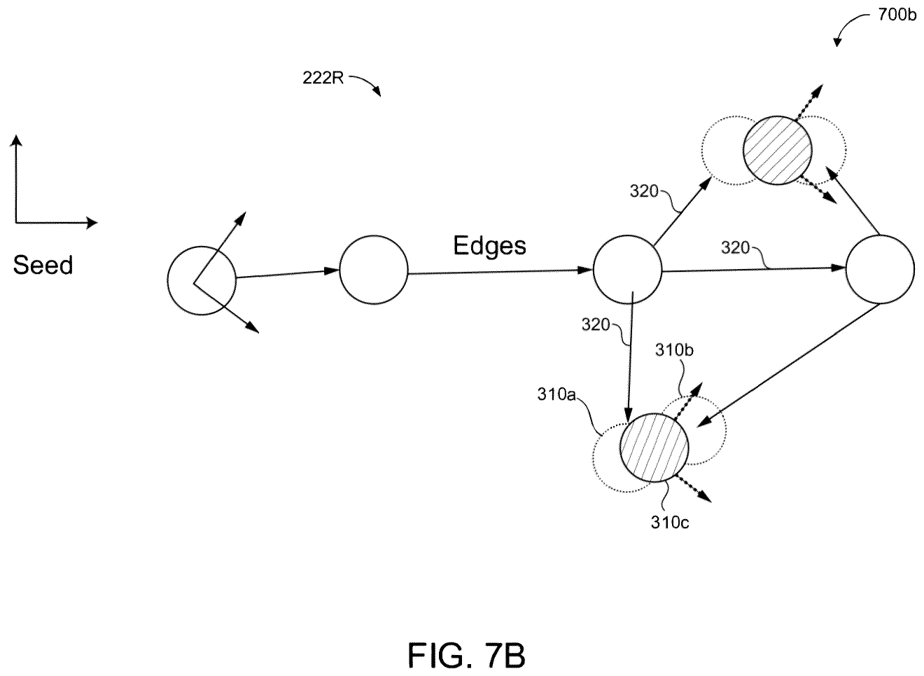

Referring now to FIGS. 7A and 7B, a topological map 222 (e.g., topological maps used by autonomous and semi-autonomous robots) may not be metrically consistent. A topological map 222 may be metrically consistent if, for any pair of route waypoints 310, a robot can follow a path of route edges 320 from the first route waypoint 310 of the pair to the second route waypoint 310 of the pair. For example, a topological map 222 may be metrically consistent if each route waypoint 310 of the topological map 222 is associated with a set of coordinates that is consistent with each path of routes edges 320 from another route waypoint 310 to the route waypoint 310. Additionally, for one or more paths in an embedding, the resulting position/orientation of the first route waypoint 310 with respect to the second route waypoint 310 (and vice versa) may be the same as the relative position/orientation of route waypoints of one or more other paths. When the topological map 222 is not metrically consistent, the embeddings may be misleading and/or inefficient to draw correctly. Metric consistency may be affected by processes that lead to odometry drift and localization error. For example, while individual route edges 320 may be accurate as compared to an accuracy threshold value, the accumulation of small errors over a large number of route edges 320 over time may not be accurate as compared to an accuracy threshold value.

A schematic view 700a of FIG. 7A illustrates an exemplary topological map 222 that is not metrically consistent because it includes inconsistent edges (e.g., due to odometry error) that results in multiple possible embeddings. While the route waypoints 310a, 310b may be metrically in the same location (or metrically within a particular threshold value of the same location), the topological map 222, due to odometry error from the different route edges 320, may include the route waypoints 310a, 310b at different locations which may cause the topological map 222 to be metrically inconsistent.

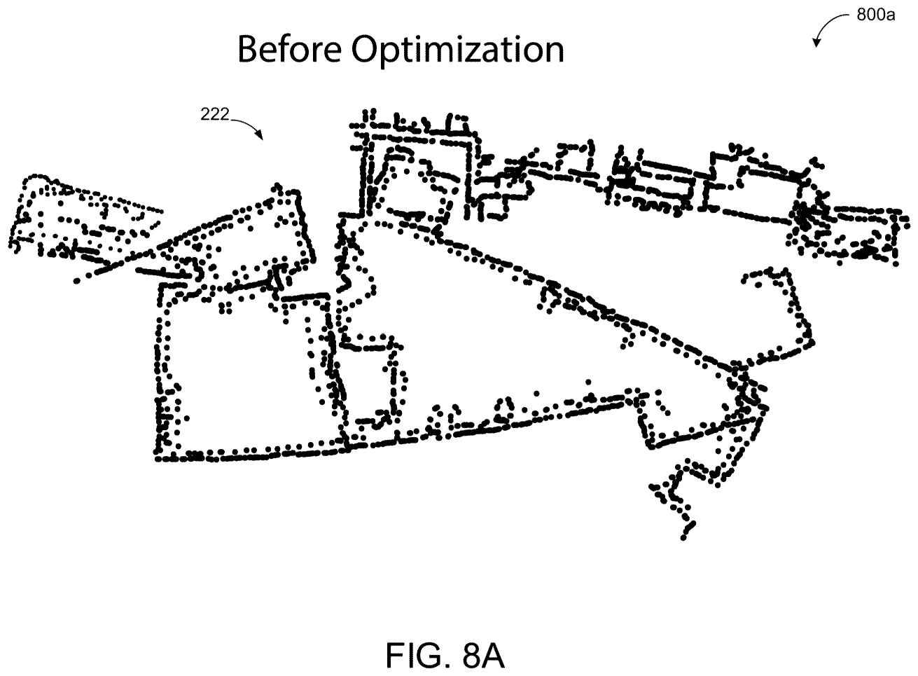

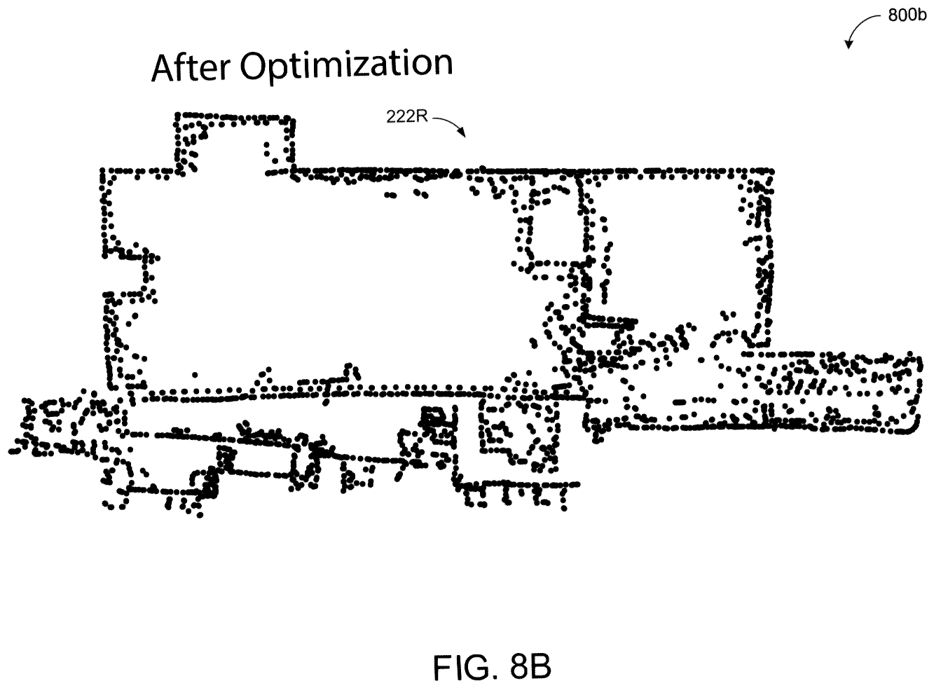

Referring now to FIG. 7B, in some implementations, a topology component refines the topological map 222 to obtain a refined topological map 222R that is metrically consistent. For example, a schematic view 700b includes a refined topological map 222R where the topological component has averaged together the contributions from all or a portion of the route edges 320 in the embedding. Averaging together the contributions from all or a portion of the route edges 320 may implicitly optimize the sum of squared error between the embeddings and the implied relative location of the route waypoints 310 from their respective neighboring route waypoints 310. The topology component may merge or average the metrically inconsistent route waypoints 310a, 310b into a single metrically consistent route waypoint 310c. In some implementations, the topology component determines an embedding (e.g., a Euclidean embedding) using sparse nonlinear optimization. For example, the topology component may identify a global metric embedding (e.g., an optimized global metric embedding) for all or a portion of the route waypoints 310 such that a particular set of coordinates are identified for each route waypoint using sparse nonlinear optimization. FIG. 8A includes a schematic view 800a of an exemplary topological map 222 prior to optimization. The topological map 222 is metrically inconsistent and may be difficult to understand for a human viewer. In contrast, FIG. 8B includes a schematic view 800b of a refined topological map 222R based on the topology component optimizing the topological map 222 of FIG. 8A. The refined topological map 222R may be metrically consistent (e.g., all or a portion of the paths may cross topologically in the embedding) and may appear more accurate to a human viewer.

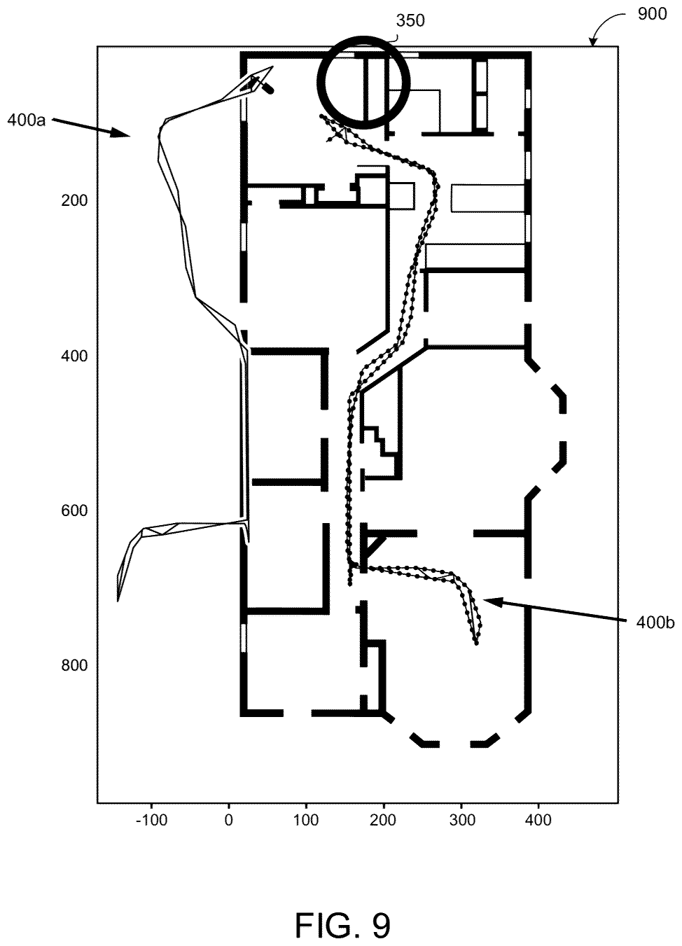

Referring now to FIG. 9, in some examples, the topology component updates the topological map 222 using all or a portion of confirmed candidate alternate edge by correlating one or more route waypoints with a specific metric location. In the example of FIG. 9, a user computing device has provided an “embedding” (e.g., an anchoring) of a metric location for the robot by correlating a fiducial marker 350 with a location on a blueprint 900. Without the provided embedding, the default embedding 400a may not align with the blueprint 900 (e.g., may not align with a metric or physical space). However, based on the provided embedding, the topology component may generate the optimized embedding 400b which aligns with the blueprint 900. The user may embed or anchor or “pin” route waypoints to the embedding by using one or more fiducial markers 350 (or other distinguishable portions of the environment). For example, the user may provide the topology component with data to tie one or more route waypoints to respective specific locations (e.g., metric locations, physical locations, and/or geographical locations) and optimize the remaining route waypoints and route edges. Therefore, the topology component may optimize the remaining route waypoints based on the embedding. The topology component may use costs connecting two route waypoints or embeddings or costs/constraints on individual route waypoints. For example, the topology component 250 may constrain a gravity vector for all or a portion of the route waypoint embeddings to point upward by adding a cost on the dot product between the gravity vector and the “up” vector.

Thus, implementations herein can include a topology component that, in some examples, performs both odometry loop closure (e.g., small loop closure) and fiducial loop closure (e.g., large loop closure) to generated candidate alternate edges. The topology component may verify or confirm all or a portion of the candidate alternate edges by, for example, performing collision checking using signed distance fields and refinement and rejection sampling using visual portions of the environment. The topology component may iteratively refine the topological map based up confirmed alternate edges and optimize the topological map using an embedding of the graph given the confirmed alternate edges (e.g., using sparse nonlinear optimization). By reconciling the topology of the environment, the robot is able to navigate around obstacles and obstructions more efficiently and is able to disambiguate localization between spaces that are supposed to be topologically connected automatically.

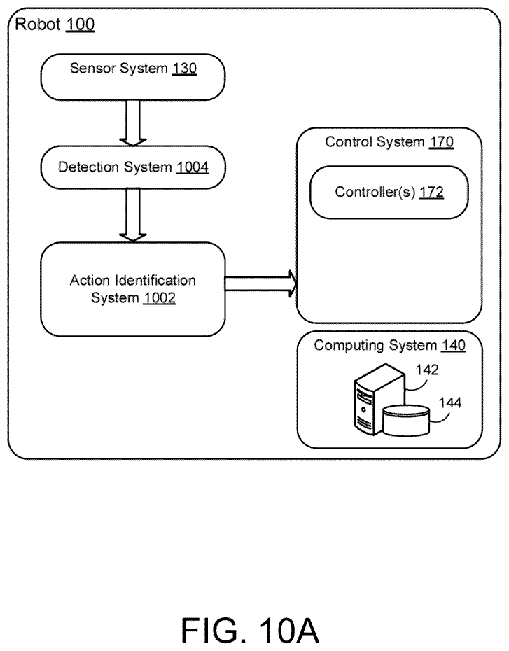

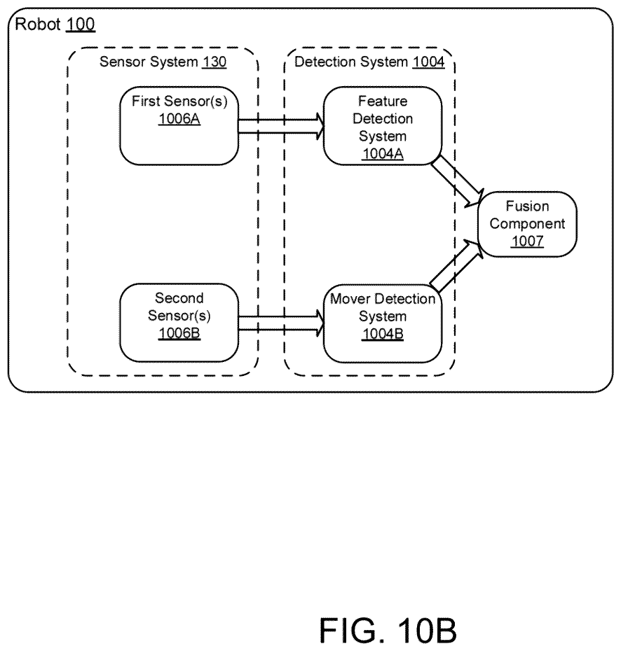

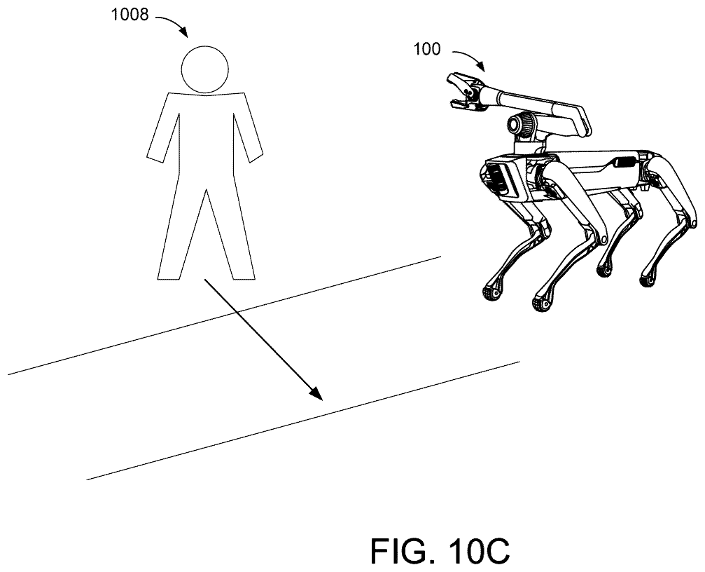

Referring now to FIG. 10A, as discussed above with reference to FIG. 1B, the robot 100 can include a sensor system 130, a detection system 1004, a computing system 140, a control system 170, and an action identification computing system 1002. The sensor system 130 can gather sensor data and the computing system 140 can store, process, and/or communicate the sensor data to various systems of the robot 100 (e.g., the control system 170). The computing system 140 includes data processing hardware 142 and memory hardware 144. The control system 170 includes the controller 172 (e.g., at least one controller).

In the example of FIG. 10A, the sensor system 130 is in communication with the detection system 1004. For example, the detection system 1004 may include a feature detection system and/or a mover detection system. In some cases, the sensor system 130 may include all or a portion of the detection system 1004.

The sensor system 130 may include a plurality of sensors (e.g., five sensors) distributed across the body, one or more legs, arm, etc. of the robot and may receive sensor data from each of the plurality of sensors. The sensor data may include lidar sensor data, image sensor data, ladar sensor data. In some cases, the sensor data may include three-dimensional point cloud data. The sensor system 130 (or a separate system) may use the three-dimensional point cloud data to detect and track features within a three-dimensional coordinate system. For example, the sensor system 130 may use the three-dimensional point cloud data to detect and track movers within the environment.

The sensor system 130 may provide the sensor data to the detection system 1004 to determine whether the sensor data is associated with a particular feature (e.g., representing or corresponding to an adult human, a child human, a robot, an animal, etc.). The detection system 1004 may be a feature detection system (e.g., an entity detection system) that implements one or more detection algorithms to detect particular features within an environment of the robot and/or a mover detection system that implements one or more detection algorithms to detect a mover within the environment.

In some cases, the detection system 1004 may include one or more machine learning models (e.g., a deep convolutional neural network) trained to provide an output indicating whether a particular input (e.g., particular sensor data) is associated with a particular feature (e.g., includes the particular feature). For example, the detection system 1004 may implement a real-time object detection algorithm (e.g., a You Only Look Once object detection algorithm) to generate the output. Therefore, the detection system 1004 may generate an output indicating whether the sensor data is associated with the particular feature.

The detection system 1004 may output a bounding box identifying one or more features in the sensor data. The detection system 1004 (or a separate system) may localize the detected feature into three-dimensional coordinates. Further, the detection system 1004 (or a separate system) may translate the detected feature from a two-dimensional coordinate system to a three-dimensional coordinate system. For example, the detection system 1004 may perform a depth segmentation to translate the output and generate a detection output. In another example, the detection system 1004 may project a highest disparity pixel within the bounding box of the detected feature into the three-dimensional coordinate system.

Further, the detection system 1004 may output a subset of point cloud data identifying a mover in the environment. For example, the detection system 1004 may provide a subset of point cloud data, in three-dimensional coordinates, that identifies a location of a mover in the environment.

In some cases, the machine learning model may be an instance segmentation-based machine learning model. In other cases, the detection system 1004 may provide the detected feature to an instance segmentation-based machine learning model and the instance segmentation-based machine learning model may perform the depth segmentation (e.g., may perform clustering and foreground segmentation).

In some cases, the detection system 1004 may perform wall plane subtraction and/or ground plane subtraction. For example, the detection system 1004 may project a model (e.g., a voxel-based model) of the environment into the bounding box of the detected feature and subtract depth points that correspond to a wall plane or a ground plane.

The sensor system 130 routes the sensor data and/or the detection output to the action identification computing system 1002. In some cases, the sensor system 130 (or a separate system) can include sensors having different sensor types (e.g., a lidar sensor and a camera) and/or different types of detection systems (e.g., a feature detection system and a mover detection system). The sensor system 130 can include a component to fuse the sensor data associated with each of the multiple sensors and detection systems to generate fused data and may provide the fused data to the action identification computing system 1002.

Turning to FIG. 10B, the robot includes the sensor system 130, the detection system 1004, and a fusion component 1007. The sensor system 130 includes one or more first sensors 1006A (e.g., one or more cameras) and one or more second sensors 1006B (e.g., one or more lidar sensors). The detection system 1004 includes a feature detection system 1004A and a mover detection system 1004B. The sensor system 130 and/or the detection system 1004 may be in communication with the fusion component 1007. In some cases, one or more of the sensor system 130 and/or the detection system 1004 may include the fusion component 1007.

The one or more first sensors 1006A may provide first sensor data (e.g., camera image data) to the feature detection system 1004A. The feature detection system 1004A may detect one or more features (e.g., identify and classify the one or more features as corresponding to a particular obstacle, object, entity, or structure) in the first sensor data (e.g., using a machine learning model). The one or more second sensors 1006B may provide second sensor data (e.g., lidar data, sonar data, radar data, ladar data, etc.) to the mover detection system 1004B. The mover detection system 1004B may detect one or more movers (e.g., identify and classify one or more features as a mover or non-mover) in the second sensor data (e.g., as a subset of point cloud data). The feature detection system 1004A may provide feature detection data (e.g., a portion of the first sensor data corresponding to the detected features) to the fusion component 1007 and the mover detection system 1004B may provide mover detection data (e.g., a portion of the second sensor data corresponding to the detected movers) to the fusion component 1007. The fusion component 1007 may fuse the feature detection data and the mover detection data to remove duplicative data from the mover detection data and/or the mover detection data and may generate fused data. In some cases, the fused data may correspond to a single data model (e.g., a single persistent data model). The fusion component 1007 may provide the fused data to the action identification computing system 1002 (as shown in FIG. 10A).

Returning to FIG. 10A, based on receiving the fused data from the fusion component 1007 and/or based on receiving unfused data from the detection system 1004, the action identification computing system 1002 may generate and/or implement one or more actions. For example, the fused data may identify a classification of a particular mover within an environment of the robot and the action identification computing system 1002 may identify a particular action associated with the particular classification. The action identification computing system 1002 may identify the particular action associated with the particular classification based on data linking the particular action to the particular classification. For example, the action identification computing system 1002 may include a data store (e.g., a cache) linking each of a plurality of classifications to a particular action.

The particular action may include one or more actions to be performed by the robot 100. The particular reaction may be considered a reaction to the classification produced by the detection system 1004. For example, the particular action may include an adjustment to the navigational behavior of the robot 100, a physical action (e.g., an interaction) to be implemented by the robot 100, an alert to be displayed by the robot 100, engaging specific systems for interacting with the mover (e.g., for recognizing human gestures or negotiating with the humans), and/or a user interface to be displayed by the robot 100. The particular action may also involve larger systems than the robot itself, such as calling for human assistance in robot management or communicating with other robots within a multi-robot system in response to recognition of particular types of movers from the fused data.

The action identification computing system 1002 may route the one or more actions to a particular system of the robot 100. For example, the action identification computing system 1002 may include the navigation system 200 (FIG. 1B). The action identification computing system 1002 may determine that the action includes an adjustment to the navigational behavior of the robot 100 and may route the action to the navigation system 200 to cause an adjustment to the navigational behavior of the robot 100. In some cases, the action identification computing system 1002 may include additional computing systems. For example, the action identification computing system 1002 may include one or more controllers of the robot 100.

In some cases, the action identification computing system 1002 may route the one or more actions to the control system 170. The control system 170 may implement the one or more actions using the controller 172 to control the robot 100. For example, the controller 172 may control movement of the robot 100 to traverse the environment 30 based on input or feedback from the systems of the robot 100 (e.g., the sensor system 130 and/or the control system 170). In another example, the controller 172 may control movement of an arm and/or leg of the robot 100 to cause the arm and/or leg to interact with a mover (e.g., wave to the mover).

In some cases, the action identification computing system 1002 (or another system of the robot 100) may route the one or more actions to a computing system separate from the robot 100 (e.g., located separately and distinctly from the robot 100). For example, the action identification computing system 1002 may route the one or more actions to a user computing device of a user (e.g., a remote controller of an operator, a user computing device of an entity within the environment, etc.), a computing system of another robot, a centralized computing system for coordinating multiple robots within a facility, a computing system of a non-robotic machine, etc. Based on routing the one or more actions to the other computing system, the action identification computing system 1002 may cause the other computing system to provide an alert, display a user interface, etc. For example, the action identification computing system 1002 may cause the other computing system to provide an alert indicating that the robot 100 is within a particular threshold distance of a particular mover. In some cases, the action identification computing system 1002 may cause the other computing system to display an image on a user interface indicating a field of view of one or more sensors of the robot. For example, the action identification computing system 1002 may cause the other computing system to display an image on a user interface indicating a presence of a particular mover within a field of view of one or more sensors of the robot 100.

Turning to FIG. 10C, the robot 100 is located within an environment that includes a mover 1008. In the example of FIG. 10C, the mover 1008 is a human (e.g., a human crossing the road). The robot 100 may identify the mover 1008 using the sensor system 130 and the detection system 1004. Further, the robot 100 may identify a particular action using the action identification computing system 1002 and may implement the action. The action may include reacting to the mover 1008. For example, the robot 100 may communicate with the mover 1008 (e.g., display a user interface, display an alert, implement a physical gesture, etc.), communicate with another robot (e.g., route electronic communications indicating the presence of the mover 1008, requesting assistance, requesting instructions, etc.), communicate with another computing device (e.g., communicate with an operator computing device to request assistance, request instructions, etc.), adjust or determine a navigational behavior of the robot 100 (e.g., to stop navigation, to pause navigation for a particular time period, to navigate around the mover 1008, etc.), etc.

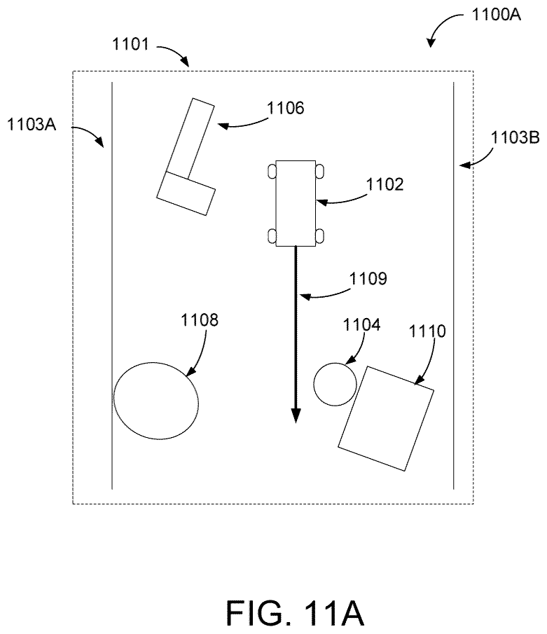

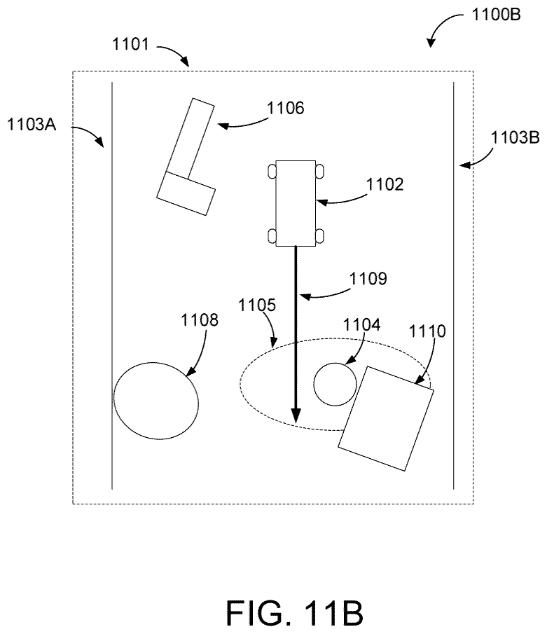

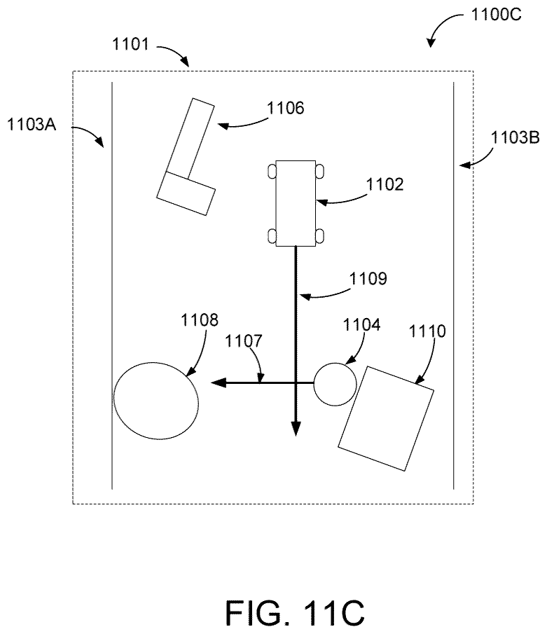

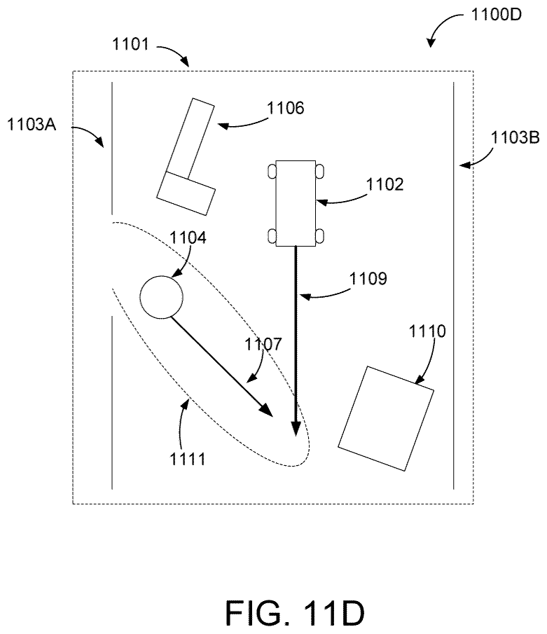

FIG. 11A depicts a schematic view 1100A of sensor data. The sensor data may include route data 1109 identifying a route of a legged robot 1102 like that of FIG. 1A within an environment 1101. The schematic view 1100A includes a virtual representation of the environment 1101 and features within the virtual representation of the environment 1101. The virtual representation includes a first feature 1104, a second feature 1106, a third feature 1108, a fourth feature 1110, a fifth feature 1103A, and a sixth feature 1103B. It will be understood that all or a portion of the first feature 1104, the second feature 1106, the third feature 1108, the fourth feature 1110, the fifth feature 1103A, and the sixth feature 1103B may include a collection (e.g., plurality) of features. For example, the first feature 1104 may include a collection of features that a system groups as the first feature 1104. In the example of FIG. 11A, the fifth feature 1103A and the sixth feature 1103B represent walls of the environment 1101 and the environment 1101 may be bounded by the fifth feature 1103A and the sixth feature 1103B. It will be understood that the virtual representation and the environment 1101 are illustrative only, and the virtual representation of the environment 1101 may include any features. Additionally, the features within the data may be considerably more detailed than the schematic illustration of FIG. 11A.

As discussed above, a topology component (e.g., a topology component of the robot 1102) can obtain sensor data from one or more sensors of a robot (e.g., the robot 1102 or a different robot). The one or more sensors can generate the sensor data as the robot 1102 traverses the site.

The topology component can generate the route data 1109, or refine pre-instructed route data 1109, based on the sensor data, generation of the sensor data, and/or traversal of the site by the robot 1102. The route data 1109 can include a plurality of route waypoints and a plurality of route edges as described with respect to FIGS. 3A-9. In the example of FIG. 11A, the route data 1109 includes a single route edge. It will be understood that the route data 1109 may include more, less, or different route waypoints and/or route edges. All or a portion of the plurality of route waypoints may be linked to a portion of sensor data.

As discussed above, the route data 1109 may represent a traversable route for the robot 1102 through the environment 1101. For example, the traversable route may identify a route for the robot 1102 such that the robot 1102 can traverse the route without interacting with (e.g., running into, being within a particular threshold distance of, etc.) an object, obstacle, entity, or structure corresponding to some or all of the example features discussed herein. In some cases, the traversable route may identify a route for the robot 1102 such that robot 1102 can traverse the route and interact with all or a portion of the example features discussed herein (e.g., by climbing a stair).

Prior to, during, or subsequent to traversal of the environment 1101 by the robot 1102, the robot 1102 may collect sensor data (e.g., additional sensor data) identifying features within the environment 1101. For example, the robot 1102 may collect sensor data identifying the first feature 1104, the second feature 1106, the third feature 1108, the fourth feature 1110, the fifth feature 1103A, and the sixth feature 1103B. The robot 1102 may route the sensor data to a detection system.

In some cases, the a detection system (e.g., a feature detection system and/or a mover detection system) may identify and classify each of the first feature 1104, the second feature 1106, the third feature 1108, the fourth feature 1110, the fifth feature 1103A, and the sixth feature 1103B The detection system may include a feature detection system to identify and classify all or a portion of the first feature 1104, the second feature 1106, the third feature 1108, the fourth feature 1110, the fifth feature 1103A, and the sixth feature 1103B as corresponding to particular objects, obstacles, entities, structures, etc. (e.g., humans, animals, robots, etc.) and/or a mover detection system to identify and classify all or a portion of the first feature 1104, the second feature 1106, the third feature 1108, the fourth feature 1110, the fifth feature 1103A, and the sixth feature 1103B as a mover. In some cases, the detection system may be a single detection system that receives sensor data and a set of identified features (e.g., sensor data having a single type of sensor data) and classifies the set of identified features (e.g., as a mover and/or as corresponding to a particular object, obstacle, entity, structure, etc.).

The mover detection system may identify and classify which of the first feature 1104, the second feature 1106, the third feature 1108, the fourth feature 1110, the fifth feature 1103A, and the sixth feature 1103B are movers (e.g., at least a portion of the corresponding feature is moved, has moved, and/or a manner in which the feature is predicted to move based on a prior movement within the environment 1101). For example, the mover detection system may obtain a set of identified features and classify all or a portion of the set of identified features as movers or non-movers.

Further, the feature detection system may identify and classify each of the first feature 1104, the second feature 1106, the third feature 1108, the fourth feature 1110, the fifth feature 1103A, and the sixth feature 1103B as corresponding to a specific object, obstacle, entity, structure, etc. (e.g., adult human, child human, robot, stair, wall, general obstacle, ramp, etc.). For example, the feature detection system may classify the first feature 1104 as a human, the second feature 1106 as a ramp, the third feature 1108 as a general obstacle, the fourth feature 1110 as a stair, the fifth feature 1103A as a first wall, and the sixth feature 1103B as a second wall.

In some cases (e.g., where the detection system includes a mover detection system and a feature detection system), the detection system may fuse the output of multiple sub-detection systems. In other cases, the detection system may include a single detection system and the output of the detection system may not be fused.

Based on the output of the detection system classifying each of the first feature 1104, the second feature 1106, the third feature 1108, the fourth feature 1110, the fifth feature 1103A, and the sixth feature 1103B, the robot 1102 can identify one or more actions for the robot 1102. In the example of FIG. 11A, based on the output of the detection system identifying and classifying each of the first feature 1104, the second feature 1106, the third feature 1108, the fourth feature 1110, the fifth feature 1103A, and the sixth feature 1103B (e.g., the output not classifying a particular feature as a human), the robot 1102 may determine that an action should not performed (e.g., that a navigational behavior of the robot 1102 should not be adjusted).

FIG. 11B depicts a schematic view 1100B of sensor data. The sensor data may include route data 1109 identifying a route of a legged robot 1102, like that of FIG. 1A, within an environment 1101, as discussed above. The schematic view 1100B includes a virtual representation of the environment 1101 and features within the environment 1101. The virtual representation includes a first feature 1104, a second feature 1106, a third feature 1108, a fourth feature 1110, a fifth feature 1103A, and a sixth feature 1103B. It will be understood that the virtual representation and the environment 1101 are illustrative only, and the virtual representation of the environment 1101 may include any features.

As discussed above, a topology component (e.g., a topology component of the robot 1102) can generate route data 1109 for traversal of the environment 1101 by the robot 1102. Prior to, during, or subsequent to traversal of the environment 1101 by the robot 1102, the robot 1102 may collect sensor data identifying features within the environment 1101. A detection system of the robot 1102 may identify and classify each of the first feature 1104, the second feature 1106, the third feature 1108, the fourth feature 1110, the fifth feature 1103A, and the sixth feature 1103B within the sensor data.

Based on the identification and classification of each of the first feature 1104, the second feature 1106, the third feature 1108, the fourth feature 1110, the fifth feature 1103A, and the sixth feature 1103B, the robot 1102 may identify a corresponding threshold distance (e.g., a caution zone) associated with each of the first feature 1104, the second feature 1106, the third feature 1108, the fourth feature 1110, the fifth feature 1103A, and the sixth feature 1103B. In some cases, the threshold distance may be a threshold distance may be a threshold distance from a particular feature (e.g., representing a corner of an object, an edge of a staircase, etc.), a threshold distance from an object, obstacle, entity, or structure (e.g., a center of an object, a perimeter or exterior of the object, etc.), or any other threshold distance. For example, the threshold distance may identify a particular threshold distance from an object, obstacle, entity, or structure corresponding to the particular feature.

The robot 1102 can identify, using the route data 1109 and/or location data associated with the robot 1102, whether the robot 1102 is within or is predicted to be within the particular threshold distance of the object, obstacle, entity, or structure corresponding to the particular feature. Based on identifying whether the robot 1102 is within or is predicted to be within the particular threshold distance, the robot 1102 can implement one or more particular actions associated with the feature. In some cases, the robot 1102 may identify the corresponding threshold distance for all or a portion of the first feature 1104, the second feature 1106, the third feature 1108, the fourth feature 1110, the fifth feature 1103A, and/or the sixth feature 1103B by parsing data within a data store that links one or more classifications of a feature to one or more threshold distances.

In the example of FIG. 11B, the classified first feature 1104 is associated in the computing system with a first threshold distance 1105. While the schematic view 1100B depicts a single threshold distance (e.g., the first threshold distance 1105), it will be understood that all or a portion of the features may be associated with one or more threshold distances. Further, it will be understood that the first threshold distance 1105 may be a different threshold distance than what is shown in FIG. 11B (e.g., may be smaller, larger, a different shape, etc.).

As discussed above, based on classifying each of the first feature 1104, the second feature 1106, the third feature 1108, the fourth feature 1110, the fifth feature 1103A, and the sixth feature 1103B, the robot 1102 can identify one or more actions for the robot 1102. In the example of FIG. 11B, based on identifying and classifying each of the second feature 1106, the third feature 1108, the fourth feature 1110, the fifth feature 1103A, and the sixth feature 1103B as non-movers and/or determining the robot 1102 is not located within or predicted to be located within a corresponding threshold distance of each object, obstacle, entity, or structure corresponding to the second feature 1106, the third feature 1108, the fourth feature 1110, the fifth feature 1103A, and the sixth feature 1103B, the robot 1102 may determine that an action should not be performed (e.g., that a navigational behavior of the robot 1102 should not be adjusted) with respect to the second feature 1106, the third feature 1108, the fourth feature 1110, the fifth feature 1103A, and the sixth feature 1103B. In another example, based on identifying and classifying the first feature 1104 as a mover and/or determining that the robot 1102 (e.g., a central location relative to the body of the robot 1102) is located within and/or predicted to be located within the first threshold distance 1105, the robot 1102 may identify an action associated with the first feature 1104 and cause implementation of the action.

In some cases, the robot 1102 may not cause implementation of the action based on determining that the first feature 1104 is not a mover. For example, the robot 1102 may determine that the first feature 1104 is not moving and/or is not predicted to move within the environment 1101 and may not implement the action.

FIG. 11C depicts a schematic view 1100C of sensor data. The sensor data may include route data 1109 identifying a route of a legged robot 1102, like that of FIG. 1A, within an environment 1101, as discussed above. The schematic view 1100C includes a virtual representation of the environment 1101 and features within the environment 1101. The virtual representation includes a first feature 1104, a second feature 1106, a third feature 1108, a fourth feature 1110, a fifth feature 1103A, and a sixth feature 1103B. It will be understood that the virtual representation and the environment 1101 are illustrative only, and the virtual representation of the environment 1101 may include any features.

As discussed above, a topology component (e.g., a topology component of the robot 1102) can generate route data 1109 for traversal of the environment 1101 by the robot 1102. Prior to, during, or subsequent to traversal of the environment 1101 by the robot 1102, the robot 1102 may collect sensor data identifying features within the environment 1101. A detection system of the robot 1102 may identify and classify each of the first feature 1104, the second feature 1106, the third feature 1108, the fourth feature 1110, the fifth feature 1103A, and the sixth feature 1103B within the sensor data.

As discussed above, the detection system may identify and classify all or a portion of the first feature 1104, the second feature 1106, the third feature 1108, the fourth feature 1110, the fifth feature 1103A, and the sixth feature 1103B as corresponding to different obstacles, objects, entities, structures, etc. For example, the detection system may identify and classify all or a portion of the first feature 1104, the second feature 1106, the third feature 1108, the fourth feature 1110, the fifth feature 1103A, and the sixth feature 1103B as representing different types of obstacles, objects, entities, structures, etc. Based on the identification and classification of each feature, the robot 1102 can identify one or more actions for the robot 1102. In the example of FIG. 11C, based on identifying and classifying each of the second feature 1106, the third feature 1108, the fourth feature 1110, the fifth feature 1103A, and the sixth feature 1103B, the robot 1102 may determine that an action should not performed (e.g., that a navigational behavior of the robot 1102 should not be adjusted) with respect to those features. Further, based on identifying that the first feature 1104 and classifying the first feature 1104 as representing a human, the robot 1102 can determine an action and cause performance of the action with respect to the first feature 1104 (e.g., as the robot 1102 approaches an object, obstacle, entity, or structure corresponding to the first feature 1104).

As discussed above, in some cases, the detection system may identify and classify whether each of the first feature 1104, the second feature 1106, the third feature 1108, the fourth feature 1110, the fifth feature 1103A, and the sixth feature 1103B is a mover (e.g., is moving within the environment 1101). The sensor data may include three-dimensional point cloud data and the detection system may use the three-dimensional point cloud data to determine whether each of the first feature 1104, the second feature 1106, the third feature 1108, the fourth feature 1110, the fifth feature 1103A, and the sixth feature 1103B is a mover.

In the example of FIG. 11C, the detection system may use the sensor data to identify and classify each of the second feature 1106, the third feature 1108, the fourth feature 1110, the fifth feature 1103A, and the sixth feature 1103B as not a mover and the first feature 1104 as a first mover. Based on the identification and classification of each feature as a mover or a non-mover, the robot 1102 can further identify the one or more actions for the robot 1102. In the example of FIG. 11C, based on identifying and classifying each of the second feature 1106, the third feature 1108, the fourth feature 1110, the fifth feature 1103A, and the sixth feature 1103B are not movers, the robot 1102 may determine that an action should not performed (e.g., that a navigational behavior of the robot 1102 should not be adjusted) with respect to those features. Further, based on identifying that the first feature 1104 and classifying the first feature 1104 as a mover, the robot 1102 can determine an action and cause performance of the action with respect to the first feature 1104 (e.g., as the robot 1102 approaches the first feature 1104).

FIG. 11D depicts a schematic view 1100D of sensor data. The sensor data may include route data 1109 identifying a route of a legged robot 1102, like that of FIG. 1A, within an environment 1101, as discussed above. The schematic view 1100D includes a virtual representation of the environment 1101 and features within the virtual representation of the environment 1101. The virtual representation includes a first feature 1104, a second feature 1106, a fourth feature 1110, a fifth feature 1103A, and a sixth feature 1103B. It will be understood that the virtual representation and the environment 1101 are illustrative only, and the virtual representation of the environment 1101 may include any features.

As discussed above, a topology component (e.g., a topology component of the robot 1102) can generate route data 1109 for traversal of the environment 1101 by the robot 1102. Prior to, during, or subsequent to traversal of the environment 1101 by the robot 1102, the robot 1102 may collect sensor data identifying features within the virtual representation of the environment 1101. A detection system of the robot 1102 may identify and classify each of the first feature 1104, the second feature 1106, the fourth feature 1110, the fifth feature 1103A, and the sixth feature 1103B within the sensor data.

As discussed above, the robot 1102 may use the sensor data to identify whether each of the first feature 1104, the second feature 1106, the fourth feature 1110, the fifth feature 1103A, and the sixth feature 1103B is a mover (e.g., is moving or is predicted to move within the environment 1101). In the example of FIG. 11D, the robot 1102 may use the sensor data to identify that each of the second feature 1106, the fourth feature 1110, the fifth feature 1103A, and the sixth feature 1103B is not a mover and that the first feature 1104 is a first mover. Based on identifying that the first feature 1104 is a mover, the robot 1102 may use the sensor to identify (e.g., predict) a route of an object, obstacle, entity, or structure corresponding to the first feature 1104 within the environment 1101. The robot 1102 can generate route data 1107 of the first feature 1104 based on identifying the route of the object, obstacle, entity, or structure corresponding to the first feature 1104. In some embodiments, the robot 1102 can receive the route data 1107 from the object, obstacle, entity, or structure corresponding to the first feature 1104 (e.g., via an electronic communication from the object, obstacle, entity, or structure corresponding to the first feature 1104 to the robot 1102).

As discussed above, the robot 1102 may classify all or a portion of the first feature 1104, the second feature 1106, the fourth feature 1110, the fifth feature 1103A, and the sixth feature 1103B. Further, the robot 1102 may identify a corresponding threshold distance associated with each of the first feature 1104, the second feature 1106, the fourth feature 1110, the fifth feature 1103A, and the sixth feature 1103B.

In the example of FIG. 11D, the first feature 1104 includes a first threshold distance 1111 corresponding to the route data 1107. For example, the first threshold distance 1111 may indicate a threshold distance from a route of the first feature 1104 identified by the route data 1107.

Based on the identification and classification of each feature as corresponding to a particular object, obstacle, entity, or structure, the identification and classification of each feature as a mover or non-mover, and the determination of a threshold distance for each feature, the robot 1102 can determine whether the robot 1102 is within and/or is predicted to be within the threshold distance of the object, obstacle, entity, or structure corresponding to each feature based on the route data of the robot 100 and the route data of the object, obstacle, entity, or structure. In the example of FIG. 11D, the robot 1102 may determine that, based on the robot route data 1109, the feature route data 1107, and the first threshold distance 1111, the robot 1102 is predicted to be within the first threshold distance 1111. The robot 1102 may identify one or more actions for the robot 1102 and cause performance of the one or more actions with respect to the first feature 1104 (e.g., as the robot 1102 approaches first threshold distance 1111 of the first feature 1104 or the robot 1102 is within the first threshold distance 1111 of the first feature 1104).

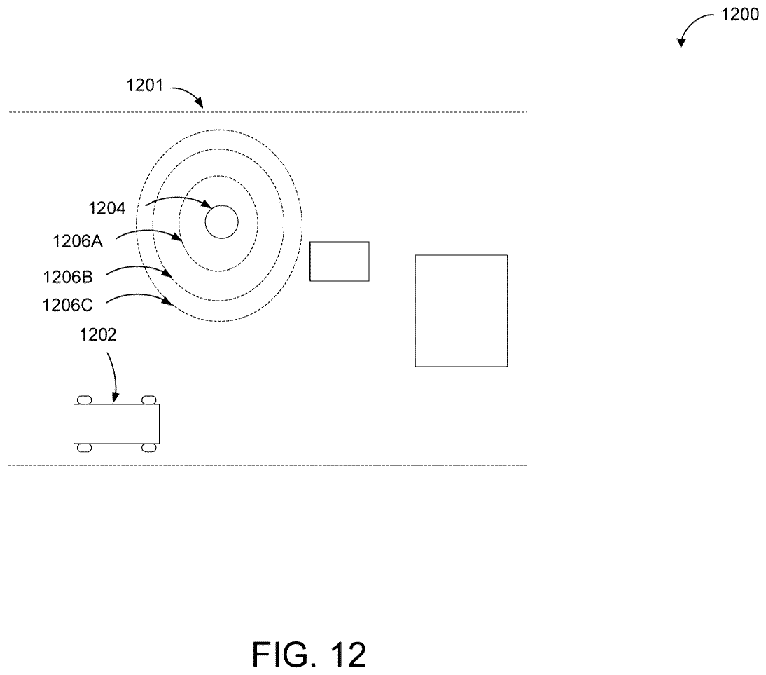

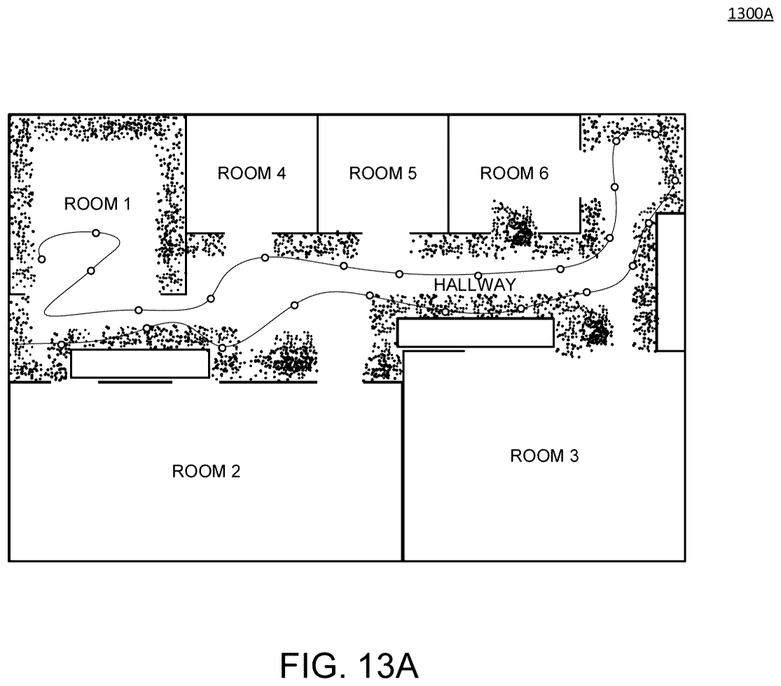

FIG. 12 depicts a schematic view 1200 of a virtual representation of an environment including a threshold distance map (e.g., an influence map) associated with a feature 1204 within a virtual representation of the environment 1201. The environment 1201 includes a legged robot 1202, like that of FIG. 1A, within the environment 1201. The schematic view 1200 includes a virtual representation of the environment 1201 and features within the virtual representation of the environment 1201. The virtual representation includes the feature 1204. It will be understood that the virtual representation and the environment 1201 are illustrative only, and the virtual representation of the environment 1201 may include any features.

As discussed above, the robot 1202 may obtain sensor data associated with the environment 1201. Based on obtaining the sensor data, the robot 1202 may identify one or more features representing objects, entities, structures, and/or obstacles within the environment 1201. For example, the robot 1202 can identify the feature 1204.

The robot 1202 may process the sensor data associated with the feature 1204 to classify the feature. For example, the robot 1202 may utilize a detection system to identify and classify the feature as a human. In some cases, a feature may be associated with a threshold distance map. Based on identifying and classifying the feature, the robot 1202 can identify one or more actions and a threshold distance map associated with the feature 1204 (e.g., an influence map). The threshold distance map may be associated with the particular classification. For example, a human classification may be associated with a particular threshold distance map. A threshold distance map associated with a human classification may have a greater number of threshold distances, larger threshold distances (e.g., larger diameters, larger areas, etc.), etc. as compared to a threshold distance map associated with a non-human classification such that the robot 1202 can avoid scaring humans (e.g., by performing particular actions such as stopping navigation, waving, alerting the human to a presence of the robot 1202, etc.). As other objects, obstacles, entities, or structures corresponding to features may not be scared by the robot, the threshold distance map associated with a non-human classification may have a lesser number of threshold distances, smaller threshold distances, etc. as compared to the threshold distance map associated with a human classification.

In some cases, a threshold distance map may be associated with a user-specific classification. For example, a specific user may have a greater fear of robots and may implement a greater number of threshold distances, larger threshold distances, etc. as compared to a threshold distance map associated with a human-generic classification.

The threshold distance map may indicate different actions that the robot 1202 is to perform based on the distance between the robot 1202 and the object, obstacle, entity, or structure corresponding to the feature 1204. For example, the threshold distance map may indicate a first action for the robot 1202 at a first distance from the object, obstacle, entity, or structure corresponding to the feature 1204 and a second action for the robot 1202 at a second distance from the object, obstacle, entity, or structure corresponding to the feature 1204.

The robot 1202 may identify the threshold distance map (e.g., based on input received via a user computing device). Further, the topology component may identify different portions (e.g., levels) of the threshold distance map and a particular action associated with all or a portion of the portions of the threshold distance map.

The action associated with a threshold of the threshold distance map may be an action to maintain a comfort, safety, and/or predictability of the robot 1202 For example, a first threshold distance of the threshold distance map (e.g., a furthest threshold distance from the object, obstacle, entity, or structure corresponding to the feature 1204) may be associated with a first action (e.g., displaying a colored light), a second threshold distance of the threshold distance map (e.g., a second furthest threshold distance from the object, obstacle, entity, or structure corresponding to the feature 1204) that is outside of a third threshold distance but within the first threshold distance may be associated with a second action (e.g., outputting an audible alert), and a third threshold distance of the threshold distance map (e.g., a closest threshold distance to the object, obstacle, entity, or structure corresponding to the feature 1204) that is within the first and second threshold distances may be associated with a third action (e.g., causing the robot 1202 to stop movement and/or navigation). Therefore, the severity (e.g., seriousness, effect, etc.) of the action may increase as the distance between the robot 1202 and the object, obstacle, entity, or structure corresponding to the feature 1204 decreases. For example, the number of systems affected by the action, the criticality of the systems affected by the action, the disruption to the operation of the robot 1202, etc. may increase as the distance between the robot 1202 and the object, obstacle, entity, or structure corresponding to the feature 1204 decreases.

In the example of FIG. 12, the feature 1204 is associated with a threshold distance map. The threshold distance map includes a first threshold 1206A, a second threshold 1206B, and a third threshold 1206C. All or a portion of the first threshold 1206A, the second threshold 1206B, and the third threshold 1206C may be associated with a corresponding action. For example, the first threshold 1206A may be associated with a first action, the second threshold 1206B may be associated with a second action, and the third threshold may be associated with a third action. In some cases, the robot 1202 may iteratively perform all or a portion of the first action, the second action, and the third action (e.g., different actions based on the threshold distance map) as the distance between the object, obstacle, entity, or structure corresponding to the feature 1204 and the robot 1202 changes (e.g., as the distance between the object, obstacle, entity, or structure corresponding to the feature 1204 and the robot 1202 crosses a threshold distance of the threshold distance map, the robot 1202 may perform a corresponding action). It will be understood that the threshold distance map may include more, less, or different portions and/or thresholds. It will be understood that more, less, or different features may be associated with threshold distance maps.

In some cases, the robot 1202 may be associated with a threshold distance. Further, the robot 1202 may be associated with a threshold distance map identifying a plurality of threshold distances of the robot 1202.

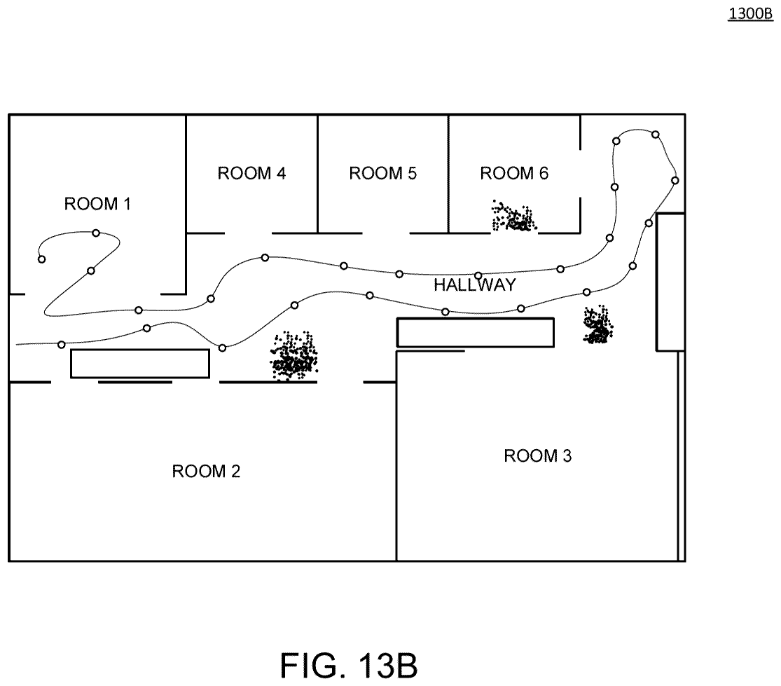

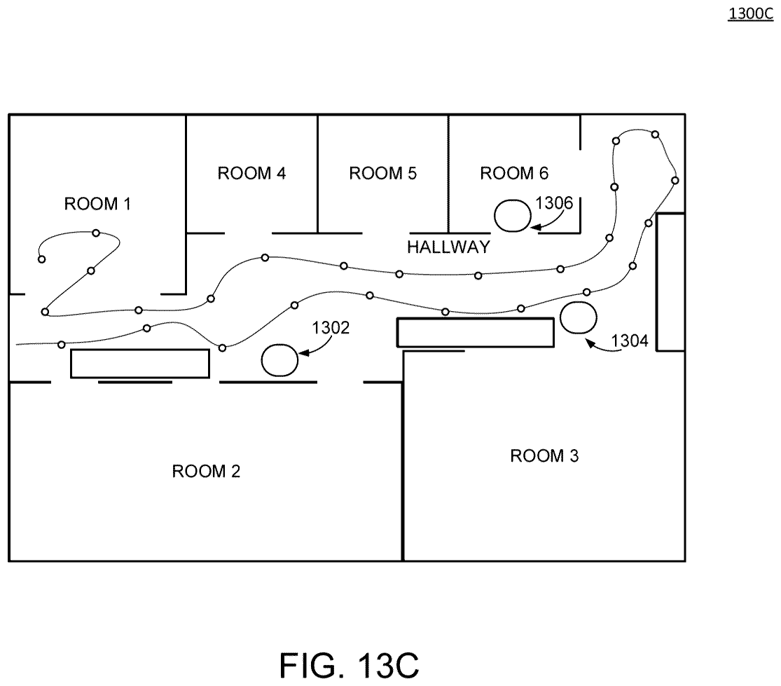

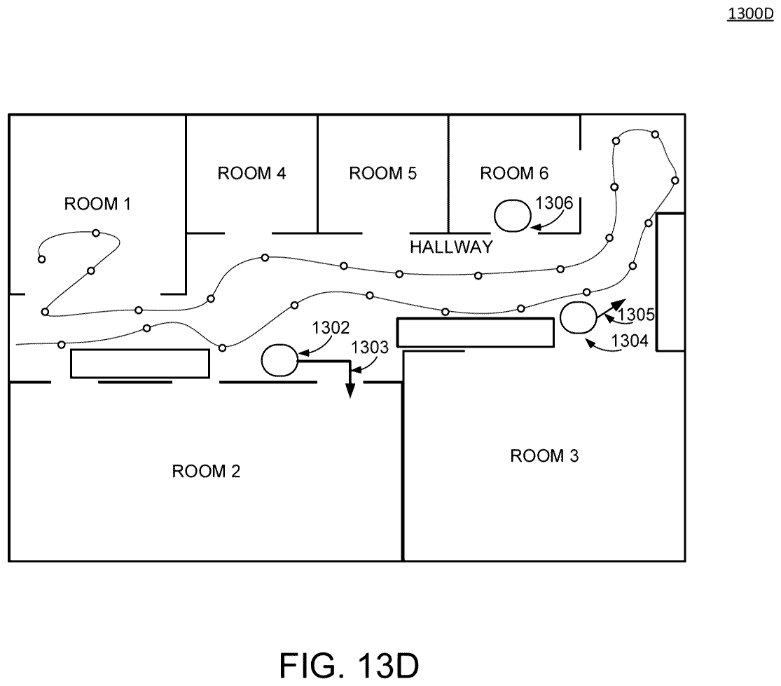

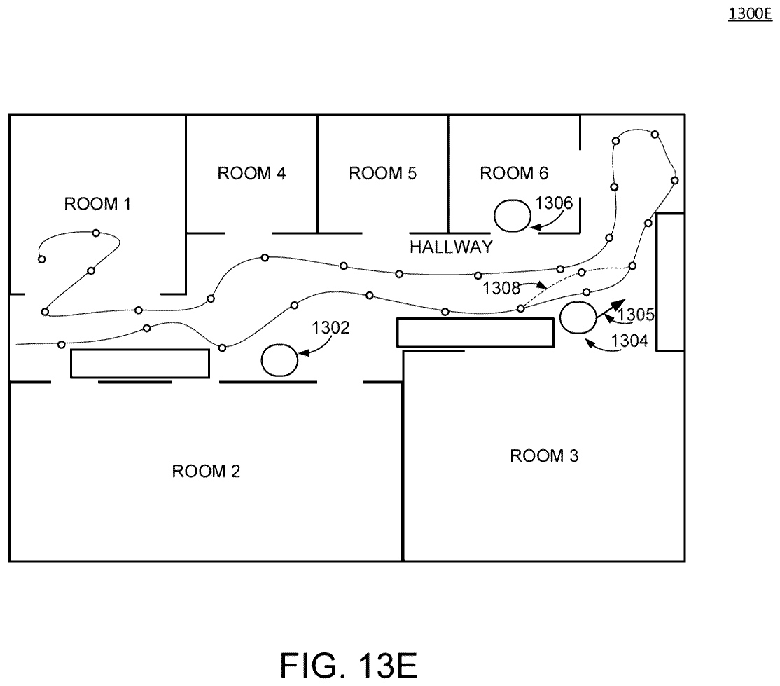

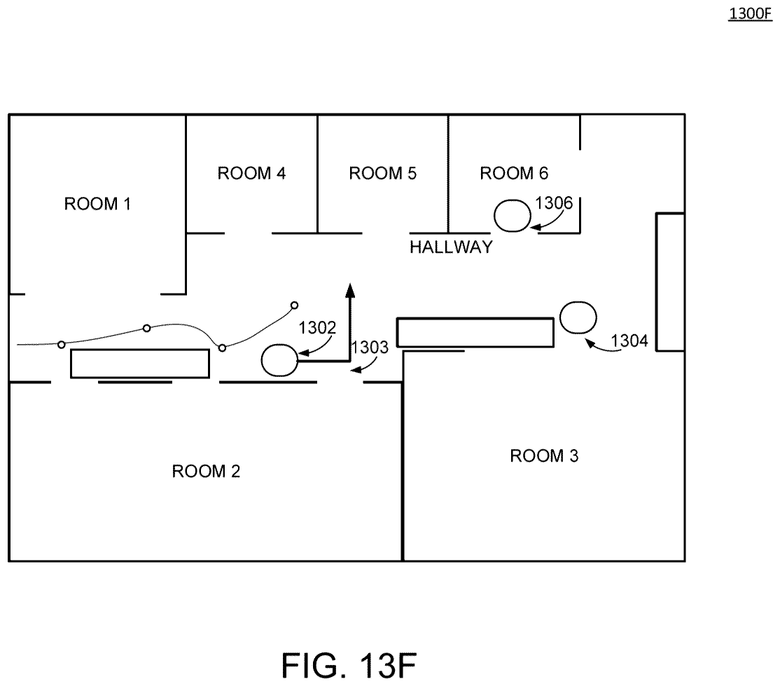

FIG. 13A depicts a schematic view 1300A identifying sensor data (e.g., route data and point cloud data) of a legged robot within an environment. The schematic view 1300A reflects route data (e.g., a virtual representation of the route data) relative to a site map of an environment. For example, the schematic view 1300A may reflect a route of the robot through an environment. The route data may include particular route waypoints and/or route edges.

The sensor data includes point cloud data associated with all or a portion of the route waypoints and/or the route edges. For example, each of the route edges and/or route waypoints may be associated with a portion of point cloud data. The point cloud data may include features associated with or corresponding to entities, obstacles, objects, structures, etc. within the environment.

FIG. 13B depicts a schematic view 1300B identifying sensor data (e.g., route data and point cloud data) of a legged robot within an environment. The schematic view 1300B reflects route data (e.g., a virtual representation of the route data) relative to a site map of an environment. The route data may include particular route waypoints and/or route edges.

The sensor data includes point cloud data associated with one or more features representing entities, obstacles, objects, structures, etc. within the environment. To identify the point cloud data associated with the one or more features, a system can segment the point cloud data (e.g., a single point cloud) into distinct subsets or clusters of point cloud data within the environment. For example, the system can cluster (e.g., point cluster) the point cloud data into a plurality of clusters of point cloud data.

In some cases, the system can filter out subsets of point cloud data that correspond to particular features (e.g., representing ground surface, walls, desks, chairs, etc.). For example, a user, an operator, etc. may provide data to the system identifying features to filter out of the subsets of point cloud data (e.g., features that are not of interest) and features to maintain (e.g., features that are of interest).

The system can monitor (e.g., track) all or a portion of the distinct subsets of point cloud data to identify a feature. For example, the system can determine a particular subset of point cloud data is associated with (e.g., identifies) a particular feature. The system can store data associating the particular subset of point cloud data with the particular feature and monitor the particular feature. The system can monitor a feature over a period of time by identifying a first subset of point cloud data obtained during a first time period that corresponds to the feature and a second subset of point cloud data obtained during a second time period that corresponds to the feature. Therefore, the system can track the feature over time.

FIG. 13C depicts a schematic view 1300C identifying sensor data (e.g., route data and point cloud data) of a legged robot within an environment. The schematic view 1300C reflects route data (e.g., a virtual representation of the route data) relative to a site map of an environment. The route data may include particular route waypoints and/or route edges.

The sensor data includes point cloud data associated with one or more features representing entities, obstacles, objects, structures, etc. within the environment. To identify the point cloud data associated with the one or more features, a system can segment the point cloud data (e.g., a single point cloud) into distinct subsets of point cloud data within the environment.

The system can monitor (e.g., track) all or a portion of the distinct subsets of point cloud data to identify a feature and classify the feature. The system can store data associating the particular subset of point cloud data with the particular feature and monitor the particular feature. Further, the system can implement a detection system to identify and classify a feature. For example, the detection system can identify and classify a feature as corresponding to a particular obstacle, object, entity, structure, etc. and/or as a mover or a non-mover.

To identify the feature, the system can identify feature characteristics of the feature. For example, the feature characteristics of the feature may include a size (e.g., a height, a weight, etc.), a shape, a pose, a position, etc. of the entities, obstacles, objects, structures, etc. corresponding to the feature.

In the example of FIG. 13C, the system identifies a first feature 1302 (e.g., associated with a first set of feature characteristics), a second feature 1304 (e.g., associated with a second set of feature characteristics), and a third feature 1306 (e.g., associated with a third set of feature characteristics).

FIG. 13D depicts a schematic view 1300D identifying sensor data (e.g., route data and point cloud data) of a legged robot within an environment. The schematic view 1300D reflects route data (e.g., a virtual representation of the route data) relative to a site map of an environment. The route data may include particular route waypoints and/or route edges.

The sensor data includes point cloud data associated with one or more features representing entities, obstacles, objects, structures, etc. within the environment. To identify the point cloud data associated with the one or more features, a system can segment the point cloud data (e.g., a single point cloud) into distinct subsets of point cloud data within the environment.

The system can monitor (e.g., track) all or a portion of the distinct subsets of point cloud data to identify and classify a feature. The system can store data associating the particular subset of point cloud data with the particular feature and monitor the particular feature. Further, the system can implement a detection system to identify and classify a feature. For example, the detection system can identify and classify a feature as corresponding to a particular obstacle, object, entity, structure, etc. and/or as a mover or a non-mover.

Further, the system can monitor a particular subset of point cloud data to determine a route associated with the corresponding feature. In some cases, the system can predict a route (e.g., a future route) associated with the corresponding feature based on the monitored subset of point cloud data.

Based on monitoring the particular subset of point cloud data, the system can identify route characteristics of the route of the feature. For example, the route characteristics of the route of the feature may include a motion (e.g., a speed, an acceleration, a determination of stationary or moving, etc.), a location, a direction, etc. of the feature. Further, the system can predict future route characteristics of the route of the feature (e.g., a predicted motion, location, direction, etc.) during a subsequent time period.

In the example of FIG. 13D, the system identifies and classifies the first feature 1302, the second feature 1304, and the third feature 1306. Further, the system identifies that the first feature 1302 is associated with a first route 1303 (e.g., is moving or is predicted to move according to the first route 1303), the second feature 1304 is associated with a second route 1305 (e.g., is moving or is predicted to move according to the second route 1305), and the third feature 1306 is stationary and is not associated with a route.

FIG. 13E depicts a schematic view 1300E identifying sensor data (e.g., route data and point cloud data) of a robot within an environment. The schematic view 1300E reflects route data (e.g., a virtual representation of the route data) relative to a site map of an environment. The route data may include particular route waypoints and/or route edges.

The sensor data includes point cloud data associated with one or more features representing entities, obstacles, objects, structures, etc. within the environment. To identify the point cloud data associated with the one or more features, a system can segment the point cloud data (e.g., a single point cloud) into distinct subsets of point cloud data within the environment.

The system can monitor (e.g., track) all or a portion of the distinct subsets of point cloud data to identify and classify a feature. The system can store data associating the particular subset of point cloud data with the particular feature and monitor the particular feature. Further, the system can implement a detection system to identify and classify a feature. For example, the detection system can identify and classify a feature as corresponding to a particular obstacle, object, entity, structure, etc. and/or as a mover or a non-mover.

The system can monitor a particular subset of point cloud data to determine a route associated with the corresponding feature. Further, the system can identify route characteristics of the route and/or feature characteristics of the feature based on monitoring the particular subset of point cloud data.

Based on identifying and classifying the feature, identifying the route of the feature, identifying the feature characteristics, and identifying the route characteristics, the system can identify one or more actions to implement based on determining that the robot is within a threshold distance or is predicted to be within a threshold distance of the object, obstacle, entity, or structure corresponding to the feature. The one or more actions may include adjusting a navigational behavior of the robot. For example, adjusting a navigational behavior of the robot may include restricting a speed or acceleration of the robot when the robot is within a threshold distance of the object, obstacle, entity, or structure corresponding to the feature, generating a synthetic feature corresponding to the feature and adding the synthetic feature to an obstacle map of the robot, generating a feature characteristic identifying a cost associated with being located within threshold distance of the feature (e.g., the robot can compare costs associated with multiple features and determine which threshold distance of which object, obstacle, entity, or structure to encroach based on the cost comparison), etc. The system may generate a synthetic feature that has a similar shape, size, etc. of the object, obstacle, entity, or structure corresponding to the feature. In some cases, the system may generate a synthetic feature that is bigger than the object, obstacle, entity, or structure corresponding to the feature to account for a threshold distance of the object, obstacle, entity, or structure corresponding to the feature and/or the robot.

In the example of FIG. 13E, the system identifies and classifies that the second feature 1304 corresponds to a particular obstacle, object, entity, structure, etc. (e.g., a human) and as a mover. In some cases, the system may identify and classify the second feature 1304 as corresponding to a particular obstacle, object, entity, structure, etc. and not whether the second feature 1304 is a mover. Further, the system identifies that the second feature 1304 is associated with the second route 1305 and the route of the robot is predicted to be within a threshold distance of the second route 1305.

Based on identifying and classifying the second feature 1304 (e.g., as a human) and determining that the route of the robot is predicted to be within a threshold distance of the second route 1305, the system implements an action to adjust the navigational behavior of the robot, the implementation of the action adjusting the route of the robot to include a modified route portion 1308. For example, the system may implement a specific action based on classifying the second feature 1304 as a human to avoid approaching within a particular distance of the human (based on data linking the distance to the second feature 1304) that is greater than a distance that the system would use to avoid approaching a ball, another robot, etc. represented by another feature (e.g., as the human may be scared, nervous, etc. in view of the robot and the other robot may not be scared, nervous, etc.). In some cases, the system may provide a human with a wider berth as compared to a non-human. Further, the system may provide a moving human with a wider berth as compared to a non-moving human. The system may generate the modified route portion 1308 based on generating a synthetic feature corresponding to the feature and adding the synthetic feature to the map such that the robot provides a comparatively wider berth (e.g., as compared to a safety buffer for navigating around a non-moving human, a ball, another robot, etc.) when navigating around the object, obstacle, entity, or structure corresponding to the second feature 1304. In some cases, the system may identify the action to implement based on a classification of the second feature 1304.

FIG. 13F depicts a schematic view 1300F identifying sensor data (e.g., route data and point cloud data) of a robot within an environment. The schematic view 1300F reflects route data (e.g., a virtual representation of the route data) relative to a site map of an environment. The route data may include particular route waypoints and/or route edges.

The sensor data includes point cloud data associated with one or more features representing entities, obstacles, objects, structures, etc. within the environment. To identify the point cloud data associated with the one or more features, a system can segment the point cloud data (e.g., a single point cloud) into distinct subsets of point cloud data within the environment.

The system can monitor (e.g., track) all or a portion of the distinct subsets of point cloud data to identify and classify a feature. The system can store data associating the particular subset of point cloud data with the particular feature and monitor the particular feature. Further, the system can implement a detection system to identify and classify a feature. For example, the detection system can identify and classify a feature as corresponding to a particular obstacle, object, entity, structure, etc. and/or as a mover or a non-mover.

The system can monitor a particular subset of point cloud data to determine a route associated with the corresponding feature. Further, the system can identify route characteristics of the route and/or feature characteristics of the feature based on monitoring the particular subset of point cloud data.

Based on identifying and classifying the feature, identifying the route of the object, obstacle, entity, or structure corresponding to the feature, identifying the feature characteristics, and identifying the route characteristics, the system can identify one or more actions to implement based on determining that the robot is within a threshold distance or is predicted to be within a threshold distance of the object, obstacle, entity, or structure corresponding to the feature. The one or more actions may include adjusting a navigational behavior of the robot. For example, adjusting a navigational behavior of the robot may include causing the robot to stop navigation (e.g., until (or a period time after) the robot is no longer located within a threshold distance of the object, obstacle, entity, or structure corresponding to the feature).

In the example of FIG. 13F, the system identifies and classifies that the first feature 1302 represents a particular obstacle, object, entity, structure, etc. (e.g., a human) and as a mover. In some cases, the system may identify and classify the first feature 1302 as corresponding to a particular obstacle, object, entity, structure, etc. and not whether the first feature 1302 is a mover. Further, the system identifies that the first feature 1302 is associated with the first route 1303 and the route of the robot is predicted to be within a threshold distance of the first route 1303.

Based on identifying and classifying the first feature 1302 (e.g., as a human) and determining that the route of the robot is predicted to be within a threshold distance of the first route 1303, the system implements an action to adjust the navigational behavior of the robot, the implementation of the action causing the robot to stop navigation and/or movement. The action may cause the robot stop navigation and/or movement until the system determines that the robot is not located within the threshold distance of the first route 1303. In some cases, the system may identify the action to implement based on a classification of the first feature 1302. For example, the system may implement a specific action based on classifying the first feature 1302 as a human to avoid approaching within a particular distance of the human. In some cases, the system may stop navigation based on determining that the robot cannot avoid approaching within a particular distance of the human. Further, the system may stop navigation based on classification of a feature as a moving human and may not stop navigation based on classification of a feature as a non-moving human (e.g., may not stop navigation, but may provide a wider berth as compared to features not classified as humans).

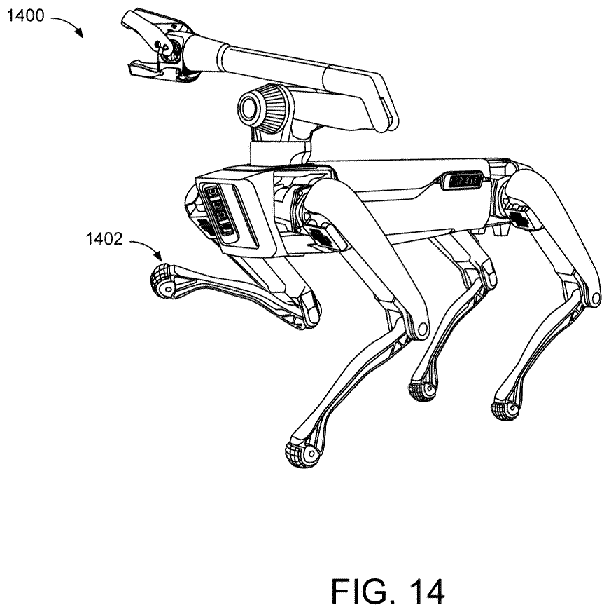

FIG. 14 depicts a legged robot 1400. The robot 1400 may include and/or may be similar to the robot 100 discussed above with reference to FIGS. 1A and 1B. The robot 1400 may include a body, one or more legs coupled to the body, and an arm coupled to the body. In the example of FIG. 14, the robot 1400 is a quadruped robot with four legs.

As discussed above, a system of the robot 1400 may identify a feature representing entities, obstacles, objects, structures, etc. within an environment (e.g., using fused data from feature detection sensors and mover detection sensors) and identify an action to implement based on identifying and classifying the feature. For example, the action may be to communicate with the object, obstacle, entity, or structure corresponding to the feature of the environment (e.g., by outputting an alert, causing display of a user interface, implementing a physical gesture, etc.) when the feature is classified as a mover that is capable of interpreting the communications (e.g., another robot, a smart vehicle, an animal, a human, etc.). In the example of FIG. 14, in response to a system, using the fused data, identifying and classifying a feature as corresponding to a particular object, obstacle, entity, or structure that is capable of interpreting robot reactions (e.g., an animal, and more specifically a human), the action includes a physical gesture of waving, shaking, contorting, etc. a distal end 1402 of a leg of the robot 1400. The action may include one or more actions based on identified human gestures (e.g., gestures produced by humans). For example, the action may include nodding a distal end 1402 of an arm of the robot 1400 (e.g., as an acknowledgement or recognition) to simulate a nodding of a human head which the robot 1400 may identify based on parsing image data. In some cases, the action may include physically interacting with the object, obstacle, entity, or structure corresponding to the feature (e.g., tapping an object). In other cases, the action may include contorting the end 1402 of the leg and/or the leg in a manner interpretable by the feature. For example, the action may include providing an alert by contorting the end 1402 of the leg and/or the leg to generate physical gestures and/or signs (e.g., signs interpretable using sign language, morse code, or any other language).

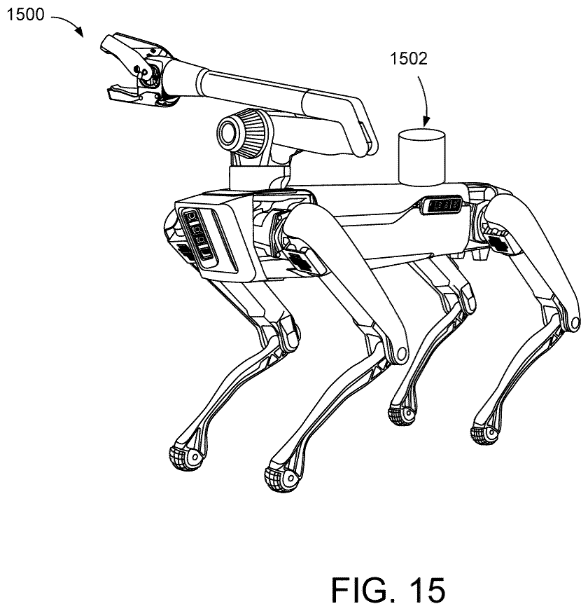

FIG. 15 depicts a legged robot 1500. The robot 1500 may include and/or may be similar to the robot 100 discussed above with reference to FIGS. 1A and 1B. The robot 1500 may include a body, one or more legs coupled to the body, an arm coupled to the body, and an interface 1502. The interface 1502 may include a display (e.g., a graphical user interface, a speaker, etc. In the example of FIG. 15, the robot 1500 is a quadruped robot with four legs.

As discussed above, a system of the robot 1500 may identify a feature representing entities, obstacles, objects, structures, etc. within an environment (e.g., using fused data from feature detection sensors and mover detection sensors) and identify an action to implement based on identifying the feature. For example, the action may be to communicate with the object, obstacle, entity, or structure corresponding to the feature of the environment (e.g., by outputting an alert, causing display of a user interface, implementing a physical gesture, etc.) when the feature is classified as a mover that is capable of interpreting the communications (e.g., another robot, a smart vehicle, an animal, a human, etc.). In the example of FIG. 15, in response to a system, using the fused data, identifying and classifying a feature as corresponding to a particular object, obstacle, entity, or structure that is capable of interpreting robot reactions (e.g., an animal, and more specifically a human), the action includes an alert to be output via the interface 1502. For example, the alert may include text data (e.g., text data including “Hello,” “Excuse Me,” “I am Navigating to Destination X,” “I am performing Task X,” etc.), image data (e.g., image data including a video providing background on the robot 1500, an image of an organization associated with the robot 1500, etc.), audio data (e.g., a horn sound, an alarm sound, etc.), etc. The system may identify the alert based on the identification and classification of the feature and the distance between the robot 1500 and the object, obstacle, entity, or structure corresponding to the feature. Based on identifying the alert, the system can cause display of the alert via the interface 1502.

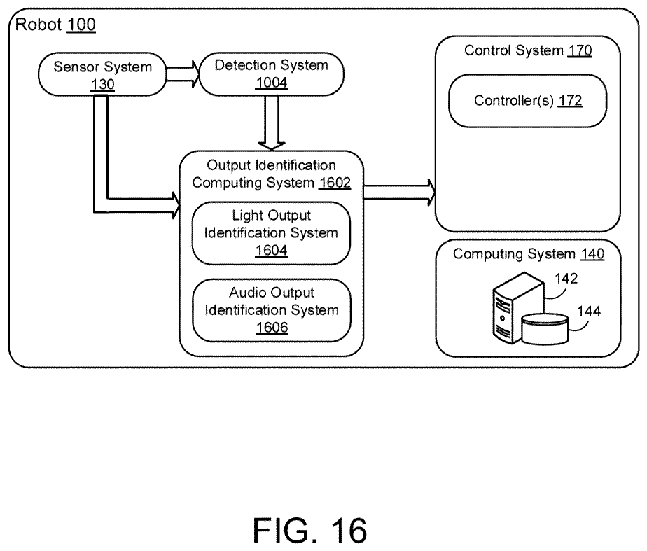

Referring now to FIG. 16, as discussed above with reference to FIG. 1B, the robot 100 can include a sensor system 130, a computing system 140, and a control system 170. The robot 100 can also include a detection system 1004 and an output identification computing system 1602. The sensor system 130 can gather sensor data, the computing system 140 can store, process, and/or communicate the sensor data to various systems of the robot 100 (e.g., the control system 170). The computing system 140 includes data processing hardware 142 and memory hardware 144. The control system 170 includes controller 172.

In the example of FIG. 16, the sensor system 130 is in communication with the detection system 1004. For example, the detection system 1004 may include a feature detection system and/or a mover detection system as described above with respect to FIGS. 1-15. In some cases, the sensor system 130 may include all or a portion of the detection system 1004.

As discussed above, the sensor system 130 may include a plurality of sensors. For example, the sensor system 130 may include a plurality of sensors distributed across the body, one or more legs, arm, etc. of the robot 100. The sensor system 130 may receive sensor data from each of the plurality of sensors. The sensors may include a plurality of types of sensors. For example, the sensors may include one or more of an image sensor, a lidar sensor, a ladar sensor, a radar sensor, pressure sensor, an accelerometer, a battery sensor (e.g., a voltage meter), a speed sensor, a position sensor, an orientation sensor, a pose sensor, a tilt sensor, a light sensor, an audio sensor, and/or any other component of the robot. In some cases, the sensor data may include three-dimensional point cloud data. The sensor system 130 (or a separate system) may use the sensor data to detect and track features within a three-dimensional coordinate system.

The sensor system 130 may provide the sensor data to the detection system 1004 to determine whether the sensor data is associated with a particular feature (e.g., representing or corresponding to an adult human, a child human, a robot, an animal, etc.). The detection system 1004 may be a feature detection system (e.g., an entity detection system) that implements one or more detection algorithms to detect particular features within an environment of the robot 100 and/or a mover detection system that implements one or more detection algorithms to detect a mover within the environment. The detection system 1004 may detect (e.g., identify and classify) features within the environment. As discussed above, in some cases, the detection system may fuse data associated with detection of a feature and deduplicate the fused data.

The sensor system 130 routes the sensor data to the output identification computing system 1602 and the detection system 1004 routes the detection output to the output identification computing system 1602. In some cases, the sensor system 130 may not route the sensor data to the output identification computing system 1602 and/or the detection system 1004 may not route the detection output to the output identification computing system 1602.

The output identification computing system 1602 may identify an output based on data associated with the robot 100. For example, the output identification computing system 1602 may identify an output based on the sensor data, the detection output, route data, environmental association data, environmental data, parameters of a particular system of the robot 100, etc. The output identification computing system 1602 may identify an alert based on the data associated with the robot 100.

In one example, the output identification computing system 1602 may identify a status of the robot 100 (e.g., a status of component of the robot 100), a status of the environment, and/or a status of an entity, obstacle, object, or structure within the environment. Based on identifying the status, the output identification computing system 1602 can identify an alert. The alert may be indicative of the data associated with the robot 100. For example, the alert may be a battery status alert indicative of sensor data from a battery sensor indicating a battery voltage level, a route alert indicative of sensor data from a lidar sensor, a ladar sensor, an image sensor, a radar sensor, etc. indicating features within environment, a zone alert (e.g., a zone around an obstacle) indicative of sensor data from a lidar sensor, a ladar sensor, an image sensor, a radar sensor, etc. indicating features within environment, a defective component alert (e.g., a defective sensor alert) indicative of sensor data from a sensor indicating a status of a component of the robot (e.g., the defective sensor itself), a level alert indicative of sensor data from a position sensor, an orientation sensor, a pose sensor, a tilt sensor, etc. indicating whether the robot (e.g., the body of the robot) is level, an environment alert indicative of sensor data from a light sensor, audio sensor, etc. indicating light, audio, etc. associated with the environment, a movement alert indicative of sensor data from a speed sensor, an accelerometer, etc. indicating a movement of the robot, a pressure alert indicative of sensor data from a pressure sensor indicating a pressure associated with the robot, a route alert indicative of route data, an environment alert indicative of environmental data, a component alert indicative of parameters of a system of the robot, etc.

In another example, the alert may not be indicative of the data associated with the robot 100 and/or the output identification computing system 1602 may not identify the alert based on the data associated with the robot 100. The output identification computing system 1602 may identify the alert based on the detection output. For example, the output identification computing system 1602 may identify an entity within the environment based on the detection output of the detection system 1004. The detection output of the detection system 1004 may indicate the presence of a particular entity within the environment. Further, the output identification computing system 1602 may identify an alert (e.g., a welcome message, a message alerting a human to the presence of the robot 100, a warning message, etc.) for the particular entity. Therefore, the output identification computing system 1602 can identify an alert for a particular entity. By identifying an alert for a particular entity, the output identification computing system 1602 can customize the alert based on the classification of features within the environment.

Based on the identified alert, the output identification computing system 1602 can identify an output indicative of the alert. For example, the output identification computing system 1602 can identify a light output, an audio output, a haptic output, etc. indicative of the alert. The output identification computing system 1602 may identify a particular type of output for a particular alert. For example, a particular alert (e.g., a welcome message) may correspond to a particular type of output (e.g., an audio output). The output identification computing system 1602 may identify the particular type of output associated with the particular alert based on data linking the particular type of output to the particular alert. For example, the output identification computing system 1602 may include a data store (e.g., a cache) linking each of a plurality of alerts to a particular type of output.

In some cases, the output identification computing system 1602 may identify a particular type of output for a particular alert based on the data associated with the robot 100. For example, the output identification computing system 1602 may utilize the data associated with the robot 100 to determine whether the environment is noisy, crowded, etc. such that a particular output may not be identified by an entity (e.g., a light output may not be identified in a crowded environment or a bright environment, an audio output may not be identified in a noisy environment, etc.). Therefore, the output identification computing system 1602 can identify a particular type of output for the particular alert that is suitable for the sensed environment.

To provide the output, the output identification computing system 1602 includes a light output identification system 1604 and an audio output identification system 1606. Each or a portion of the light output identification system 1604 and the audio output identification system 1606 may obtain an alert from the output identification computing system 1602 and may identify an output for the alert. In some cases, the output identification computing system 1602 may provide the alert to a particular system of the light output identification system 1604 and the audio output identification system 1606 based on determining a particular type of output associated with the alert. For example, the output identification computing system 1602 may determine that the alert is associated with a light output and may provide the alert to the light output identification system 1604.

The light output identification system 1604 may identify light to be output by one or more light sources of the robot 100 based on the alert. For example, the robot 100 may include a plurality of light sources (e.g., 5 light sources) distributed across the robot 100. Further, the light output identification system 1604 may identify one or more lighting parameters of the light to be output by one or more light sources of the robot 100 based on the alert. For example, the light output identification system 1604 may identify a brightness of the light to be output. Additionally, the light output identification system 1604 may identify one or more light sources of a plurality of light sources of the robot 100 to output the light. For example, the light output identification system 1604 may identify specific light sources of the robot 100 to output the light. The light output identification system 1604 may identify the particular light output, the particular lighting parameters, the particular light source(s), etc. associated with the particular alert based on data linking the particular light output, the particular lighting parameters, the particular light source(s), etc. to the particular alert. For example, the light output identification system 1604 may include a data store (e.g., a cache) linking each of a plurality of combinations of light outputs, lighting parameters, light source(s), etc. to a plurality of alerts.

The audio output identification system 1606 may identify audio to be provided by one or more audio sources of the robot 100 based on the alert. Further, the audio output identification system 1606 may identify one or more audio parameters of the audio to be provided by one or more audio sources of the robot 100 based on the alert. For example, the audio output identification system 1606 may identify a volume of the audio to be provided. Additionally, the audio output identification system 1606 may identify one or more audio sources of a plurality of audio sources of the robot 100 to provide the audio. For example, the audio output identification system 1606 may identify specific audio sources of the robot 100 to provide the audio. The audio output identification system 1606 may identify the particular audio output, the particular audio parameters, the particular audio source(s), etc. associated with the particular alert based on data linking the particular audio output, the particular audio parameters, the particular audio source(s), etc. to the particular alert. For example, the audio output identification system 1606 may include a data store (e.g., a cache) linking each of a plurality of combinations of audio outputs, audio parameters, audio source(s), etc. to a plurality of alerts.

The output identification computing system 1602 may route the output to the control system 170. The control system 170 may implement the output using the controller 172 to control the robot 100. For example, the controller 172 may control one or more sources (e.g., audio sources, light sources, etc.) of the robot 100 and may cause the one or more sources to provide the output.

In some cases, the output identification computing system 1602 (or another system of the robot 100) may route the output to a computing system separate from the robot 100 (e.g., located separately and distinctly from the robot 100). For example, the output identification computing system 1602 may route the output to a user computing device of a user (e.g., a remote controller of an operator, a user computing device of an entity within the environment, etc.), a computing system of another robot, a centralized computing system for coordinating multiple robots within a facility, a computing system of a non-robotic machine, a source (e.g., audio source, light source, etc.) not located on or within the robot 100, etc. Based on routing the one or more actions to the other computing system, the output identification computing system 1602 may cause the other computing system to provide the output. In some cases, the output identification computing system 1602 may cause the other computing system to provide additional output indicative of the output. For example, the output identification computing system 1602 may instruct output of light indicative of an alert on a surface of the environment using a light source of the robot 100 and may provide data indicative of the alert to the other computing system. In another example, the output identification computing system 1602 may cause the other computing system to display an image on a user interface indicating the output (e.g., a same image displayed on a surface using a light source of the robot 100).

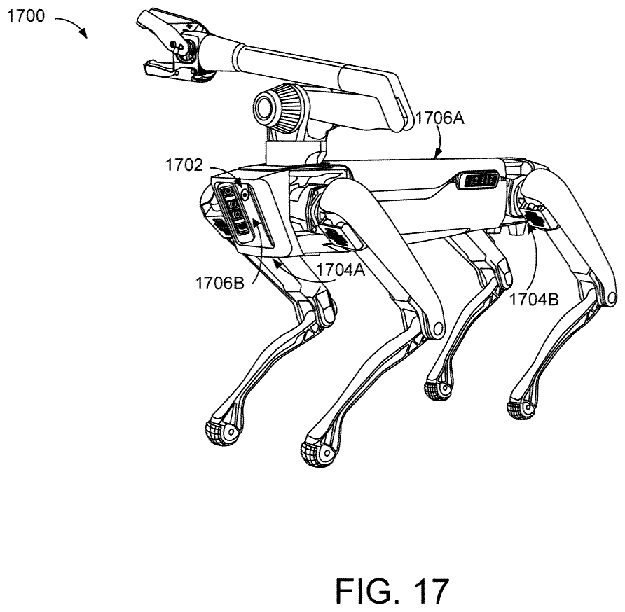

FIG. 17 depicts a legged robot 1700. The robot 1700 may include and/or may be similar to the robot 100 discussed above with reference to FIGS. 1A and 1B. The robot 1700 includes a body, one or more legs coupled to the body, an arm coupled to the body, and a plurality of output sources. The plurality of output sources includes a first light source 1702, a second light source 1704A, a third light source 1704B, a first audio source 1706A, and a second audio source 1706B. For example, the first light source 1702 may be a miniature LED and the second light source 1704A and the third light source 1704B may be ground effect LEDs. It will be understood that the robot 1700 may include more, less, or different output sources (including output sources located on different locations on the body of the robot 1700). In some cases, one or more of the first light source 1702, the second light source 1704A, or the third light source 1704B may include one or more light emitting diodes or image projection sources, the first audio source 1706A may be an audio resonator as discussed above, and the second audio source 1706B may be a buzzer, a speaker, etc. The first audio source 1706A may emit audio in a multi-directional manner or omni-directional manner. As shown in FIG. 17, the second audio source 1706B is located within a face of the robot 1700 such that audio output by the second audio source 1706B is output in a direction that the robot 1700 is facing. For example, the second audio source 1706B may be located behind a perforated panel on the face of the robot 1700. In some cases, the second audio source 1706B may be located elsewhere on the robot 1700 (e.g., on top of the robot). All or a portion of the first light source 1702, the second light source 1704A, or the third light source 1704B may be configured to project light on a surface of the environment of the robot 1700. In the example of FIG. 17, the robot 1700 is a quadruped robot with four legs.

As discussed above, a system of the robot 1700 may identify an output (e.g., based on sensor data, a detection output, etc.). In some cases, the system of the robot 1700 may identify an output indicative of an alert. For example, the output may be indicative of a battery health status alert. The output may enable a communication with an entity within an environment of the robot (e.g., a human within the environment). For example, the system may identify an output based on identifying and classifying a feature as a mover that is capable of interpreting the output as a communication (e.g., another robot, a smart vehicle, an animal, a human, etc.).

Based on identifying the output, the system of the robot 1700 may identify one or more of the plurality of output sources to provide the output. For example, the system of the robot 1700 may identify the first light source 1702 to provide the output. In some cases, the system of the robot 1700 may identify multiple sources (e.g., the first light source 1702 and the second light source 1704A) to provide the output. In some embodiments, the system of the robot 1700 may identify the particular source(s) to provide the output based on the data associated with the robot 1700. For example, the system of the robot 1700 may identify that the environment of the robot 1700 is acoustically noisy and may provide the output to a light source. In some cases, multiple outputs can be provided to simultaneously different types of output sources (e.g., an audio source and a light source). In some cases, the output is specific to the type of output source.

In the example of FIG. 17, in response to the system of the robot 1700 identifying an output, the system of the robot 1700 can cause one or more of the plurality of output sources to provide the output. For example, the system of the robot 1700 can cause one or more of the first audio source 1706A or the second audio source 1706B to output audio data (e.g., audio data including “Hello,” “Excuse Me,” “I am Navigating to Destination X,” “I am performing Task X,” a buzzing noise, etc.). In another example, the system of the robot 1700 can cause one or more of the first light source 1702, the second light source 1704A, or the third light source 1704B to output light (e.g., patterned light). For example, the one or more of the first light source 1702, the second light source 1704A, or the third light source 1704B may output light corresponding to a particular image.

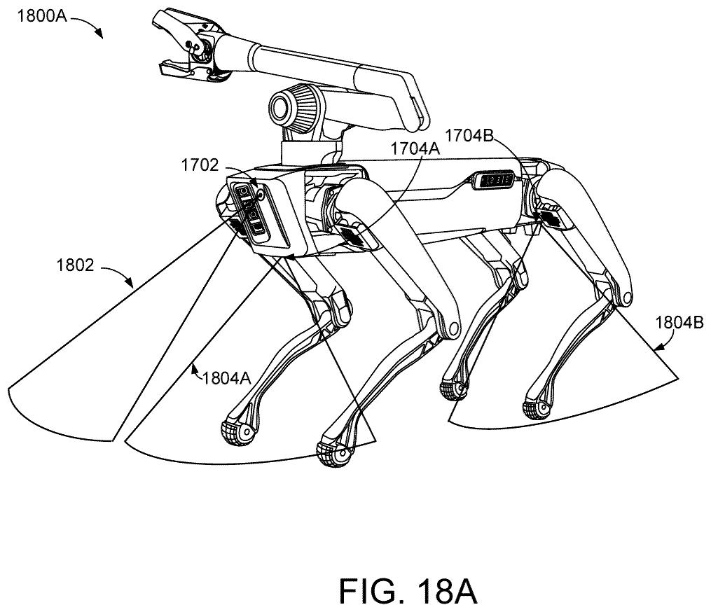

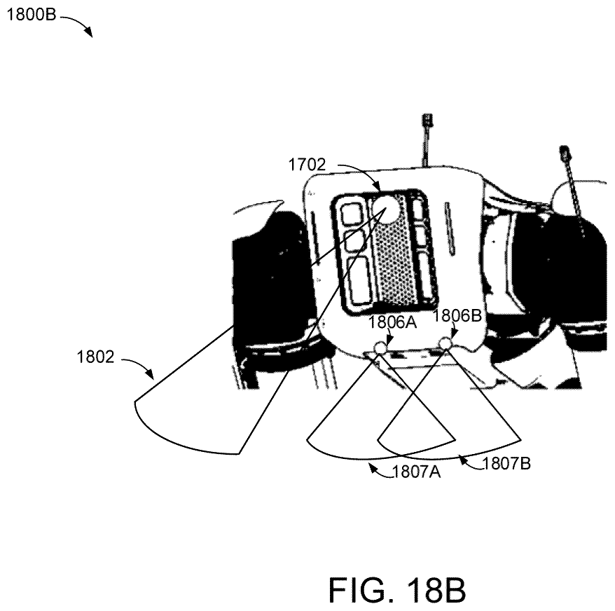

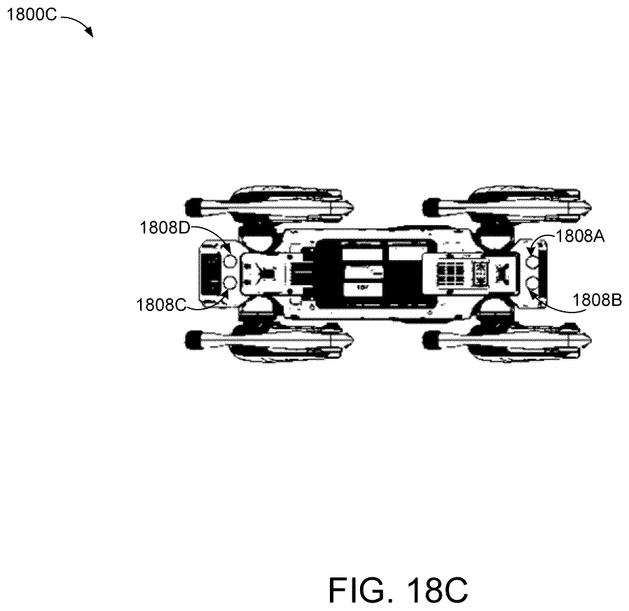

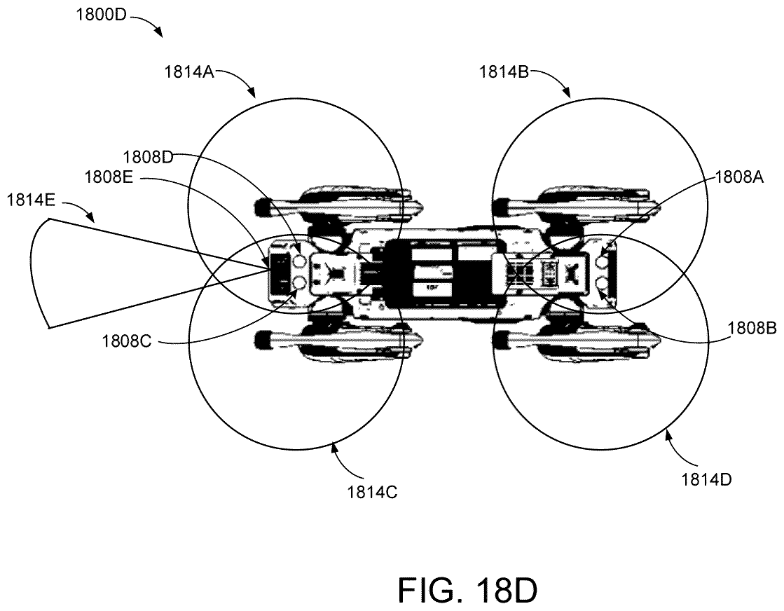

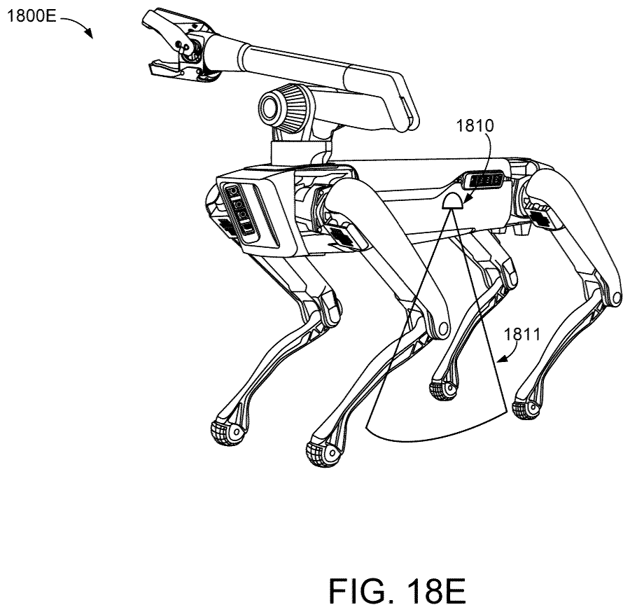

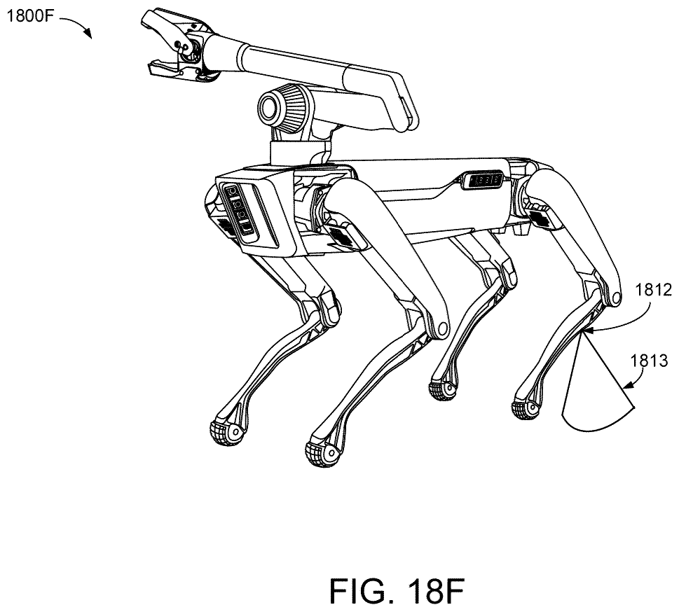

FIG. 18A depicts a legged robot 1800A. The robot 1800A may include and/or may be similar to the robot 1700 discussed above with reference to FIG. 17. The robot 1800A includes a body, one or more legs coupled to the body, an arm coupled to the body, and a plurality of light sources 1702, 1704A, and 1704B.

The plurality of light sources 1702, 1704A, and 1704B may each be associated with (e.g., have) one or more lighting parameters. The one or more lighting parameters may indicate how a particular light source of the plurality of light sources 1702, 1704A, and 1704B provides light. For example, the one or more lighting parameters may include a frequency, pattern, color, brightness, intensity, illuminance, luminance, luminous flux, an angle of the light, a dispersion of the light, a direction of the light (a light direction) (e.g., a direction, position, orientation, location, pose, etc. of the light source and/or a direction, position, orientation, location, pose, etc. of the light with respect to the robot), etc. In some cases, the range of angles of light projected from the light sources can be limited by hardware (e.g., by recessing the light sources, providing shields and/or focusing lenses).

In the example of FIG. 18A, the first light source 1702 outputs light 1802 with a first angular range and direction, the second light source 1704A outputs light 1804A with a second angular range and direction, and the third light source 1704B outputs light 1804B with a third angular range and direction. For example, light 1802 may have a full width at half maximum of 13 degrees and light 1804A and light 1804B may have a full width at half maximum of 50 degrees such that the light 1804A and 1804B have a wider field of view as compared to the light 1802. In another example, the light 1804A and the light 1804B may output a full width half maximum (FWHM) power between 60 and 90 degrees. All or a portion of the plurality of light sources 1702, 1704A, and 1704B may output light with angular ranges that do not overlap. For example, the light 1802 may not overlap with the light 1804A and the light 1804B. In some cases, one or more of the light 1802, 1804A, or 1804B may overlap (. Whether output light from different light sources overlaps may also depend on distance to the ground and thus on the stance of the robot 1800A. Based on the angular range and direction of the light 1804A and 1804B, the light may extend beyond a footprint of one or more legs of the robot.

All or a portion of the plurality of light sources 1702, 1704A, and 1704B may output light such that the light is directed onto a surface of the environment of the robot 1800A. For example, all or a portion of the plurality of light sources 1702, 1704A, and 1704B may output light such that the light is output on a ground surface based on a body of the robot 1800A being in a particular position, orientation, tilt, etc. (e.g., a walking orientation, a paused orientation, a standard orientation, etc.). In some cases, all or a portion of the plurality of light sources 1702, 1704A, and 1704B may be maneuverable such that a system can adjust one or both of their respective angular ranges and/or directions. For example, all or a portion of the plurality of light sources 1702, 1704A, and 1704B may be associate with a motor such that a system can adjust one or more of the output directions or angular ranges (e.g., with a lens system). As illustrated, the light projections on the ground may extend outside the robot's footprint. Further, the light output by all or a portion of the plurality of light sources 1702, 1704A, and 1704B can be brighter (e.g., greater than 150 lumens) than direct indicator lights on the side or top of the robot 1800A because they are directed downwardly and do not risk blinding any humans in the environment. For example, all or a portion of the plurality of light sources 1702, 1704A, and 1704B may output light greater than 80 lumens (e.g., 200 lumens, 600 lumens, etc.). All or a portion of the plurality of light sources 1702, 1704A, and 1704B may output light with a lux on a surface of the environment greater than 100 lux (e.g., 150 lux to 1000 lux.). For example, all or a portion of the plurality of light sources 1702, 1704A, and 1704B may have a concentrating lens to project light such that light greater than 800 lux is output on the surface. The lux at all or a portion of the plurality of light sources 1702, 1704A, and 1704B may be greater than 10,000,000 lux (e.g., 12,500,000 lux, 14,000,000 lux, etc.) due to concentration of the output at their small surface area, such that looking directly at all or a portion of the plurality of light sources 1702, 1704A, and 1704B may cause temporary flash blindness. The extension of projected light outside the robot footprint and the greater brightness afforded by indirect lighting increase visibility of the robot to observers and serve as a warning of the robot's presence.

FIG. 18B depicts a front portion of a legged robot 1800B. The robot 1800B may include and/or may be similar to the robot 1700 discussed above with reference to FIG. 17. The robot 1800B includes a body, one or more legs coupled to the body, an arm coupled to the body, and a plurality of output sources. The plurality of output sources includes a first light source 1702, a second light source 1806A, and a third light source 1806B. The first light source 1702 may be located on a side (e.g., a front side) of a body of the robot 1800B. The second light source 1806A and the third light source 1806B may be located on a bottom of the body of the robot 1800B. In some cases, the second light source 1806A and the third light source 1806B may be located on a side of the body of the robot 1800B.

The front portion of the robot 1800B may correspond to a portion of the robot 1800B oriented in a traversal direction of the robot 1800B. In some cases, the front portion of the robot 1800B may correspond to a head of the robot 1800B. In some cases, the front portion of the robot 1800B may correspond to the end of the robot with the greatest number of sensors. In some cases, the front portion of the robot 1800B may correspond to a portion of the robot such that the legs of the robot form angles with an opening directed to the front portion of the robot 1800B. For example, a knee joint of the robot 1800B may flex such that a lower portion of a leg of the robot 1800B approaches the front portion of the robot 1800B. In some embodiments, the front portion of the robot 1800B may be dynamic. For example, if the robot 1800B switches from walking forwards to walking backward, the front portion of the robot 1800B may change. In some embodiments, the front portion of the robot 1800B may be static.

The plurality of light sources 1702, 1806A, and 1806B may each be associated with (e.g., have) one or more lighting parameters as discussed above. The one or more lighting parameters may indicate how a particular light source of the plurality of light sources 1702, 1806A, and 1806B emits light.

In the example of FIG. 18B, the first light source 1702 emits light 1802 with a first angular range and direction, the second light source 1806A emits light 1807A with a second angular range and direction, and the third light source 1806B outputs light 1807B with a third angular range and direction. In some cases, the emitted light 1802 may not overlap with the emitted light 1807A or the light 1807B. In other cases, the emitted light 1807A and the emitted light 1807B may overlap.

FIG. 18C depicts a bottom plan view of a legged robot 1800C. The robot 1800C may include and/or may be similar to the robot 1700 discussed above with reference to FIG. 17. The robot 1800C includes a body, one or more legs coupled to the body, an arm coupled to the body, and a plurality of light sources. The plurality of light sources includes a first light source 1808A, a second light source 1808B, a third light source 1808C, and a fourth light source 1808D. All or a portion of the plurality of light sources 1808A, 1808B, 1808C, and 1808D may be located on a bottom of the body of the robot 1800C. Further, all or a portion of the plurality of light sources 1808A, 1808B, 1808C, and 1808D may output light towards and/or on a surface of the environment, particularly a ground surface.

In some cases, all or a portion of the plurality of light sources 1808A, 1808B, 1808C, and 1808D may be recessed within the body of the robot 1800C. In some cases, all or a portion of the plurality of light sources 1808A, 1808B, 1808C, and 1808D may be encased within a shield (e.g., compartment, cover, box, etc.) located on (e.g., affixed to, attached to, etc.) the bottom of the body of the robot 1800C. Recessing and/or shielding can limit the light output by the light sources to a downward direction, or towards the ground (supporting surface) when the robot is in a stable position (able to maintain a pose or locomotion with its legs).

FIG. 18D depicts a bottom plan view of a legged robot 1800D. The robot 1800D may include and/or may be similar to the robot 1700 discussed above with reference to FIG. 17. The robot 1800D includes a body, one or more legs coupled to the body, an arm coupled to the body, and a plurality of light sources. The plurality of light sources includes a first light source 1808A, a second light source 1808B, a third light source 1808C, a fourth light source 1808D, and a fifth light source 1808E. All or a portion of the light sources 1808A, 1808B, 1808C, and 1808D may be located on a bottom of the body of the robot 1800D and the light source 1808E may be located on a front portion of the body. Each of the light sources 1808A, 1808B, 1808C, and 1808D may be oriented or angled outwardly (e.g., angled at a 45 degree angle with respect to a bottom surface of the body of the robot) in order to project light onto the ground outside the body of the robot and make the robot more noticeable. In some cases, each of the plurality of light sources 1808A, 1808B, 1808C, 1808D, and 1808E may be different types of light sources. For example, the light sources 1808A, 1808B, 1808C, and 1808D may be ground effect LEDs and the light source 1808E may be a miniature LED. In one example, the ground effects LEDs may have between 40 and 800 lumens (e.g., 130 lumens) and a lux on a surface of the environment between 100 and 600 lux (e.g., 600 lux.) and the miniature LEDs may have over 80 lumens and a lux on a surface of the environment between 14 and 155 lux (e.g., 23 lux.). Further, all or a portion of the plurality of light sources 1808A, 1808B, 1808C, 1808D, and 1808E may output light towards and/or on a surface of the environment. In the example, the light source 1808A outputs light 1814A having a first angular range, the light source 1808B outputs light 1814B having a second angular range, the light source 1808C outputs light 1814C having a third angular range, the light source 1808D outputs light 1814D having a fourth angular range, and the light source 1808E outputs light 1814E having a fifth angular range. It will be understood that one or more of the light 1814A, the light 1814B, the light 1814C, the light 1814D, and/or 1814E may overlap (e.g., have overlapping ranges).

FIG. 18E depicts a legged robot 1800E. The robot 1800E may include and/or may be similar to the robot 1700 discussed above with reference to FIG. 17. The robot 1800E includes a body, one or more legs coupled to the body, an arm coupled to the body, and a light source 1810. The light source 1810 may be located on (e.g., affixed to, attached to, etc.) a side of a body of the robot 1800E.

To output light on a surface of the environment, the light source 1810 is at least partially covered (e.g., obstructed, blocked, directed, etc.) by a cover. For example, the light source 1810 may be at least partially covered with a shield to prevent direct outward or upward light emission that could blind humans in the environment. In some cases, the light source 1810 may be at least partially covered by a reflective shield such that light provided by the light source 1810 is reflected towards a surface of the environment.

In the example of FIG. 18E, the light source 1810 outputs light 1811 with an angular range and direction. The angular range and direction may be based on the light source 1810 being at least partially covered by the cover. For example, the angular range may be based on the size, angle, etc. of the cover.

In some cases, a system of the robot 1800E may maneuver the cover. The system may be provided with a motor to dynamically adjust the cover to adjust the angular range of the light 1811. In some cases, the system can dynamically adjust the cover based on data associated with the robot 1800E. For example, the system may determine that a body of the robot 1800E is tilted (relative to a first position) and may adjust the cover to account for the tilt in the body of the robot 1800E and to avoid impairing a human within the environment. Thus, in one embodiment, the system can maintain a gravitationally downward direction for the output light even if the body of the robot 1800E is tilted upward or downward, such as for traversing stairs. In another embodiment, if the detection system 1004 (FIG. 16) does not detect an intervening human, the system can direct light to a wall to serve as an alert for entities elsewhere in the environment.

FIG. 18F depicts a legged robot 1800F. The robot 1800F may include and/or may be similar to the robot 1700 discussed above with reference to FIG. 17. The robot 1800F includes a body, one or more legs coupled to the body, an arm coupled to the body, and a light source 1812. The light source 1812 may be located on (e.g., affixed to, attached to, etc.) a leg of the robot 1800F. For example, the light source 1812 may be located on a leg of the robot 1800F such that the light source is directed downwardly in most or all leg positions in stance poses or during traversal. However, at least a portion of the light source 1812 may not face the ground surface of the environment of the robot 1800F in some leg positions (e.g., when the leg segment is vertical or extended rearwardly).

In the example of FIG. 18F, the light source 1812 is located on a lower portion of a leg of the robot 1800F. Specifically, the light source 1812 is located below a knee of the leg of the robot 1800F. It will be understood that the light source 1812 may be located at different locations on a leg of the robot 1800F. For example, the light source 1812 may be located on a foot of the robot 1800F, above a knee of the leg of the robot 1800F, etc. Further, one or more lights sources may be located on all or a portion of the legs of the robot 1800F.

To output light on a surface of the environment, the light source 1812 may be at least partially shielded (e.g., obstructed, blocked, directed, etc.) by a cover. In some cases, the light source 1812 may not be at least partially covered by a cover. Further, the light source 1812 may be recessed within the leg such that light provided by the light source 1812 is directed to a surface of the environment.

In the example of FIG. 18F, the light source 1812 outputs light 1813 with an angular range and direction relative to the leg segment on which it is mounted. The direction may be based on a location of the light source 1810. For example, the light source 1810 may output light 1813 with the angular range based on being located within a particular proximity (e.g., 6 inches, 12 inches, etc.) of the ground surface of the environment.

In some cases, a system of the robot 1800F may control the light source 1812 such that as the leg maneuvers (e.g., based on the robot 1800F walking), the light source 1812 does not impair a human. For example, the system may turn off the light source 1812 or adjust the lighting parameters of the light source 1812 (e.g., adjust a brightness) when the corresponding leg is either directed or sensed to be vertical or extended rearwardly such that the light faces above the horizon and risks blinding humans in the environment.

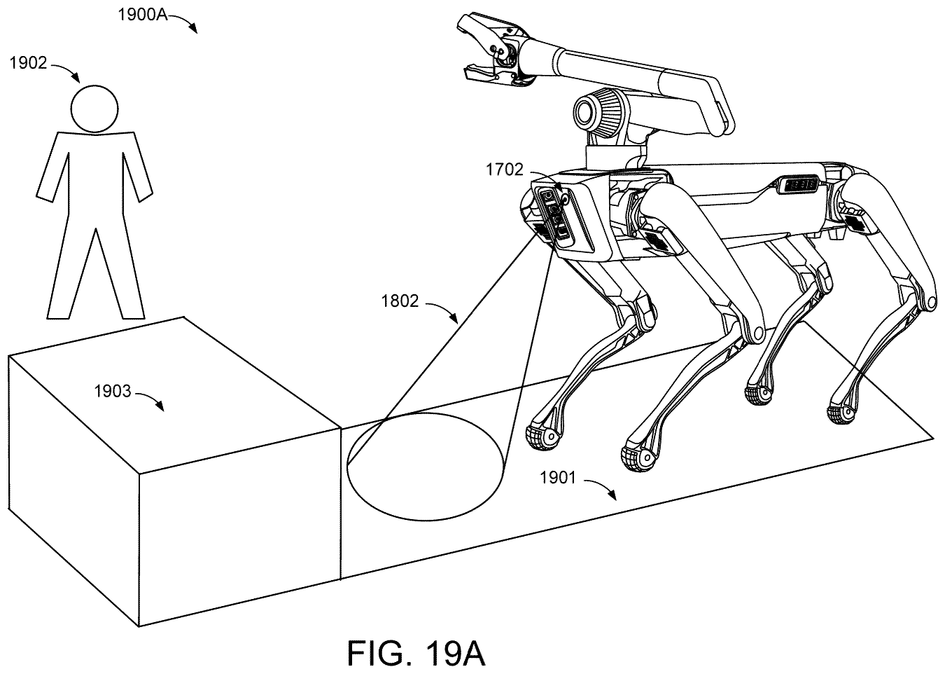

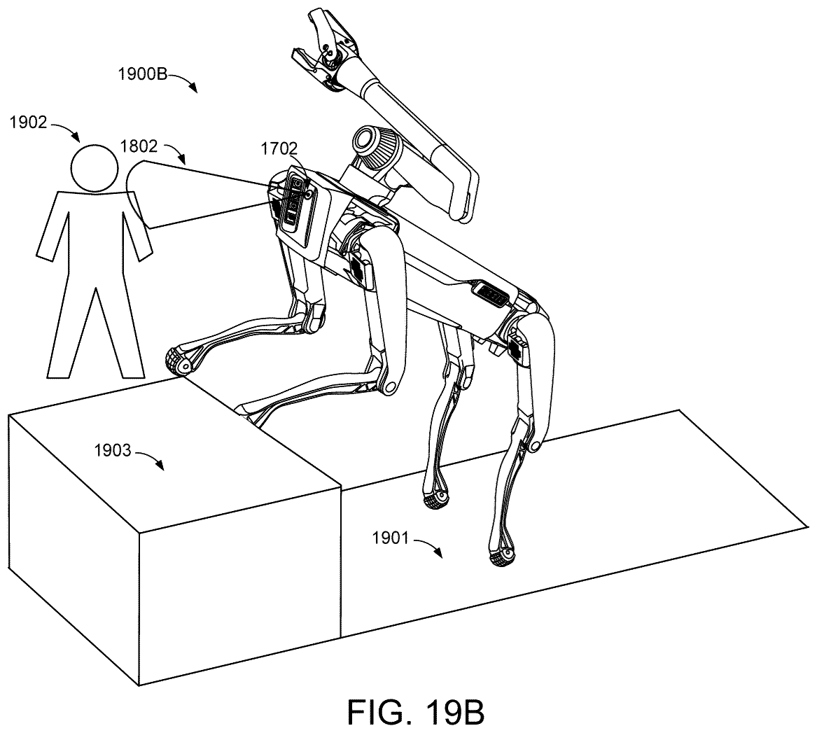

FIG. 19A depicts a robot operating within an environment 1900A. The robot is located within an environment that includes an entity 1902. In the example of FIG. 19A, the entity 1902 is a human. The robot may detect the entity 1902 using the sensor system 130 and the detection system 1004. In some cases, the entity 1902 may not be directly within a line of sight of the robot. Instead, the entity 1902 may be obstructed by an obstacle, a structure, an object, etc.

The robot may include a light source 1702. The light source 1702 may output light 1802. The light source 1702 may output light 1802 on the ground. For example, the light 1802 may be patterned to form an image that identifies an alert (e.g., an arrow indicating a direction or route of the robot). In another example, the light 1802 may be used to illuminate the feet of the robot as the robot maneuvers through the environment 1900A (e.g., an unpatterned spotlight).

In the example of FIG. 19A, the environment 1900A further includes a surface 1901 and an elevated surface 1903. For example, the elevated surface 1903 may be a stair (e.g., of a set of stairs), a box, a pallet, etc. In another example, the surface 1901 may be a first stair of a set of stairs and the elevated surface 1903 may be a second stair of the set of stairs.

Based on data associated with the robot, a system of the robot may determine how to adjust the light 1802 to avoid impairing the entity 1902. The data associated with the robot may relate to an orientation of the robot, the detection of the entity 1902, or both. The system may determine that the parameters of the robot (e.g., the pose, the orientation, location, position, tilt, etc.) are below or equal to a threshold and/or are within a threshold range such that the system does not adjust the light 1802. For example, the system may determine that the body of the robot has not been tilted such that the light 1802 is not being directed to the entity 1902. In another example, the determination may not rely on any detection, and rather base the determination solely on the orientation of the robot, without regard for whether any entity 1902 has been detected. In either case, the system may not adjust the light 1802.

FIG. 19B depicts the robot of FIG. 19A operating within an environment 1900B. The robot may be executing an action to climb on the elevated surface 1903 and/or may determine that an action to climb on the elevated surface 1903 is being executed and/or is to be executed.

Based on detecting the entity 1902 and/or determining a modification of the parameters of the robot (e.g., based on determining that the robot is executing or is planning to climb on the elevated surface 1903), a system of the robot may determine how to adjust the light 1802 to avoid impairing potential entities within the environment (e.g., the entity 1902). The system may determine that climbing of the elevated surface 1903 may direct the light 1802 away from the surface 1901. Further, the system may determine that climbing of the elevated surface 1903 may direct the light 1802 to the entity 1902 (e.g., such that the entity 1902 may be impaired). To determine that the climbing of the elevated surface 1903 may direct the light 1802 away from the surface 1901 and/or toward the entity 1902, the system may determine that the parameters (e.g., the determined parameters or the projected parameters) of the robot (e.g., the pose, the orientation, location, position, tilt, etc.) are equal to or above a threshold and/or are outside of a threshold range such that the light 1802 may be directed to the entity 1902. For example, the system may determine that the body of the robot has been tilted such that the light 1802 is directed away from the surface 1901 and/or toward the entity 1902. Therefore, the system may adjust the light 1802.

The decision to adjust the light 1802 need not be based on detection of the entity 1902. Rather, the system may adjust the light 1802 to avoid blinding any entities in the environment, whether or not such entities are detected. For example, a non-level orientation (e.g., tilt, roll or yaw beyond a threshold level) is detected, such when the robot is overturned from a fall, when climbing stairs or when descending stairs, the system may adjust the light 1802 because of the risk of blinding entities in the environment without regard for actual detection of such entities. The entities may be difficult to detect in such situations due to abnormal orientation of sensors and/or blind spots due to the terrain being negotiated. For example, the system may not detect an entity located at the top of a staircase that the robot is climbing.

Whether based on detection of the entity 1902, detection of the orientation of the robot or both, to adjust the light 1802, the system may adjust one or more lighting parameters of the light source 1702. For example, the system may adjust a brightness or intensity of the light 1802. In some cases, the system may turn off the light source 1702 such that no light is provided by the light source 1702. In another example, the system may adjust a direction of the light source 1702, such as by tilting the head of the robot or just the light source 1702 to face more downwardly to avoid blinding any entities in the environment.

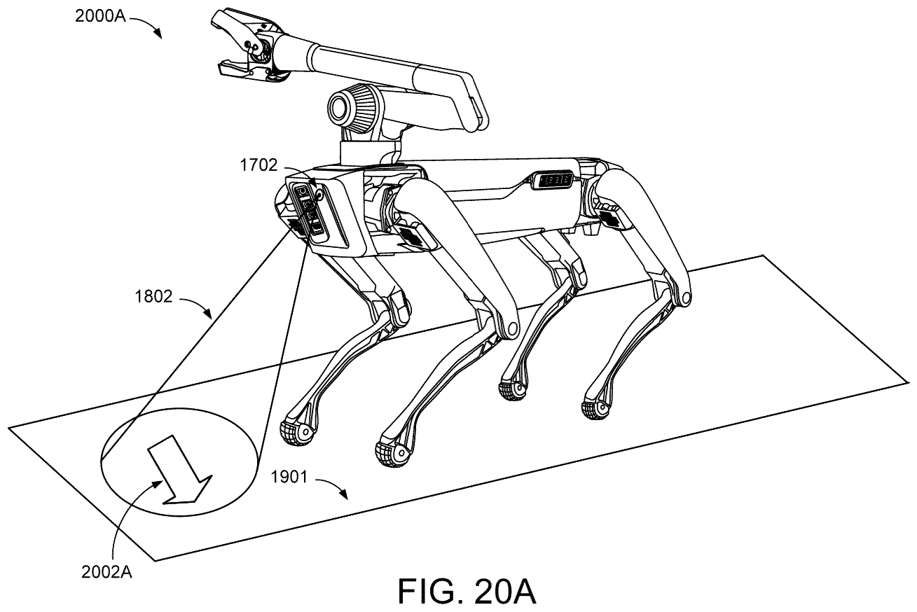

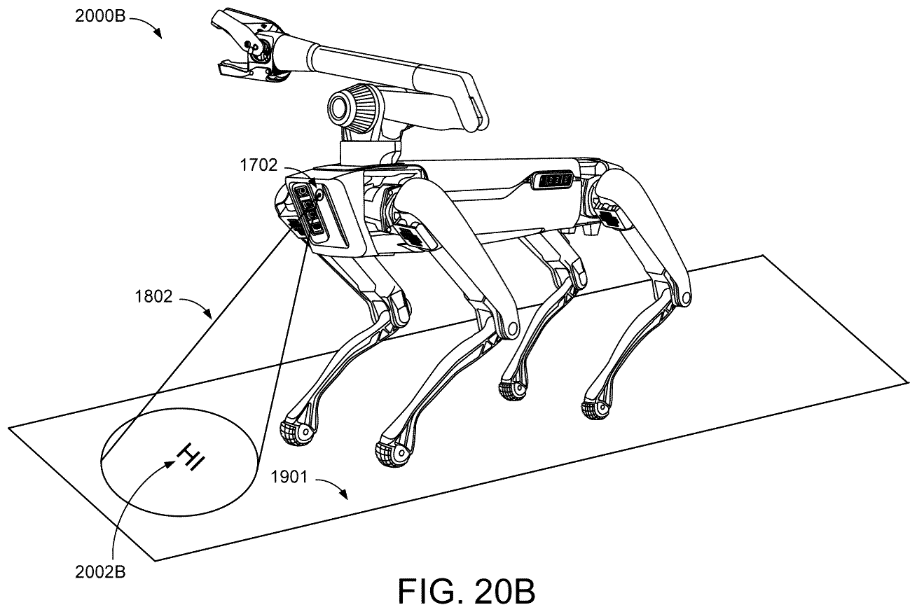

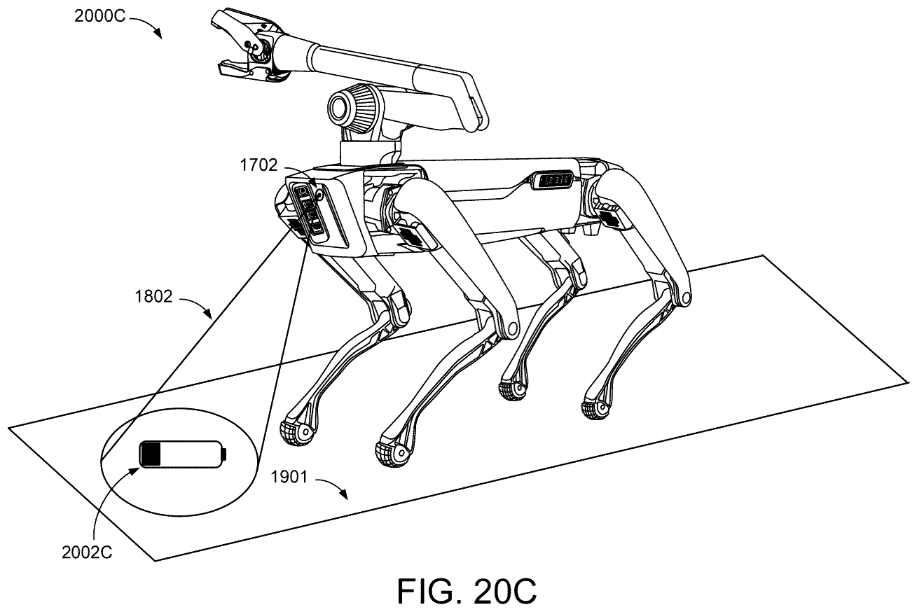

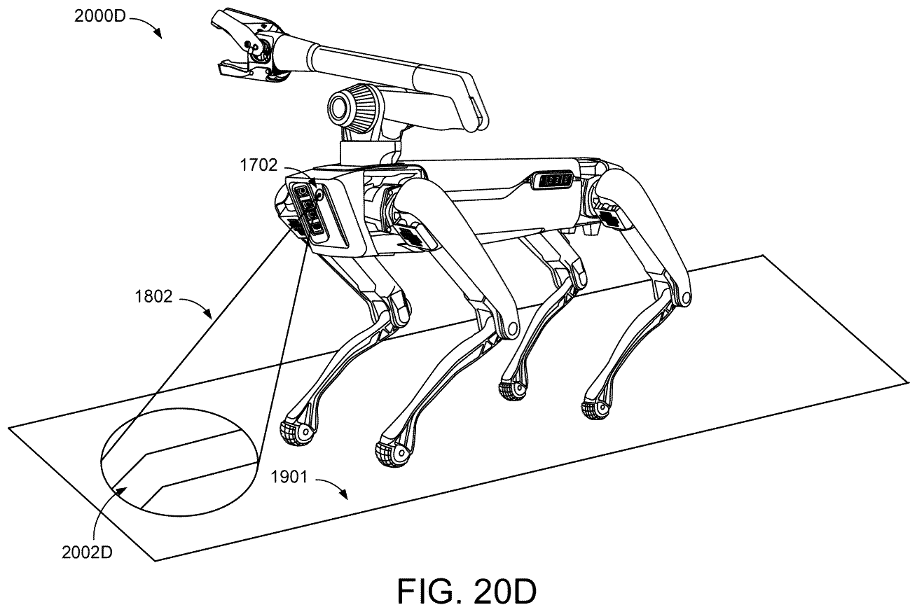

FIG. 20A depicts a legged robot 2000A. The robot 2000A may include and/or may be similar to the robot 1700 discussed above with reference to FIG. 17. The robot 2000A includes a body, one or more legs coupled to the body, an arm coupled to the body, and a light source 1702. The light source 1702 may be located on (e.g., affixed to, attached to, etc.) a front portion of the robot 2000A. For example, the light source 1702 may be located on a head of the robot 2000A. The light source 1702 may include a plurality of light sources (e.g., an array of light sources).

The light source 1702 of the robot 2000A may be oriented downwards such that the light source 1702 emits light 1802 on a surface 1901 of the environment. For example, the surface 1901 may be a ground surface supporting the robot 2000A, such as a stair, a floor, a platform, a pallet, a box, etc. In the illustrated embodiment, the light source 1702 is a projector capable of projecting an image onto a surface, and electronics capable of altering the image to be projected.

Based on obtained data associated with the robot, a system of the robot 2000A may identify an alert. For example, based on the data associated with the robot, the system may generate route data for the robot 2000A and may identify an alert indicating a route of the robot 2000A. In another example, based on the data associated with the robot, the system may identify an entity, obstacle, object, or structure in the environment and may identify an alert indicative of the location of the entity, obstacle, object, or structure.

In the example of FIG. 20A, the system identifies a directional alert. The directional alert may be indicative of a location of an entity, obstacle, object, or structure in the environment, a route of the robot 2000A, etc. The system may instruct the light source 1702 to emit the light 1802 such that the light 1802 is indicative of the alert. Based on the instructions, the light may cause a pattern 2002A to be emitted or projected on the surface 1901. In the example of FIG. 20A, the pattern 2002A includes a symbol, particularly an arrow, corresponding to the directional alert (e.g., pointing to an object of interest in the environment). To project the pattern 2002A, the light source 1702 may include a plurality of light sources that are activated in a temporal and/or visual pattern to output the pattern 2002A. For example, the light source 1702 may include a plurality of light sources that output light having different colors (e.g., multi-colored lights, color-specific lights, etc.) and the system may activate the plurality of light sources to output the pattern 2002A.

FIG. 20B depicts a legged robot 2000B similar or identical to the robot 200A discussed above with reference to FIG. 20A. In the example of FIG. 20B, the system identifies a message to an entity. Specifically, in the example of FIG. 20B, the message is “Hi.” However, the message can be a different message such as “Hi, I am operating here,” “Please keep a safe distance,” “Robot at work,” “I am completing job XYZ,” etc. In some cases, the message may be provided by a user via a user computing device. In some cases, the message may be automatically generated by the robot based on detection of a particular type of entity (e.g., a human). For example, the system may identify a message that a particular entity can understand (e.g., a child human may understand different messages as compared to an adult human).

The system may instruct the light source 1702 to emit the light 1802 such that the light 1802 is indicative of the alert. Based on the instructions, the light may cause a pattern 2002B to be emitted or projected on the surface 1901. In the example of FIG. 20B, the pattern 2002B includes symbols, particularly a textual representation of the message. To project the pattern 2002B, the light source 1702 may include a plurality of light sources that are activated in a temporal and/or visual pattern to output the pattern 2002B.

FIG. 20C depicts a legged robot 2000C similar or identical to the robot 2000A discussed above with reference to FIG. 20A. In the example of FIG. 20C, the system identifies a status of the robot 2000C. To identify the status, the system may obtain data associated with the robot from one or more components (e.g., sensors, motors, actuators, navigation, or mapping systems, etc.) of the robot 2000C. For example, the system may obtain sensor data from an image sensor, a lidar sensor, a ladar sensor, a radar sensor, pressure sensor, an accelerometer, a battery sensor (e.g., a voltage meter), a speed sensor, a position sensor, an orientation sensor, a pose sensor, a tilt sensor, a light sensor, an audio sensor, and/or any other component of the robot. Based on the data associated with the robot, the system can identify a status of the robot 2000C.

In the example of FIG. 20C, the system identifies a status of a battery of the robot 2000C. Specifically, in the example of FIG. 20C, the system identifies a battery health status of the battery. The battery health status may indicate an amount of battery drain (e.g., an amount of battery charge left in the battery), a battery life, a battery health, etc.

The system may instruct the light source 1702 to emit the light 1802 such that the light 1802 is indicative of the alert. Based on the instructions, the light may cause a pattern 2002C to be emitted or projected onto the surface 1901. In the example of FIG. 20C, the pattern 2002C includes a symbol, particularly an image of the component (the battery) and a representation of the status of the component (e.g., an amount of battery charge left in the battery). To project the pattern 2002C, the light source 1702 may include a plurality of light sources that are activated in a temporal and/or visual pattern to output the pattern 2002C.

FIG. 20D depicts a legged robot 2000D similar or identical to the robot 2000A discussed above with reference to FIG. 20A. In the example of FIG. 20D, the system identifies a route of the robot 2000D. As discussed above, to identify the route, the system can generate a route edge that plots steps between one or more route waypoints. The robot 2000D may be maneuvering or may be planning to maneuver through the environment according to the route.

In the example of FIG. 20D, the system identifies a route of the robot 2000D. Specifically, in the example of FIG. 20D, the system identifies a section of the route that the robot 2000D is projected to follow. The route may indicate one or more next steps of the robot 2000D.

The system may instruct the light source 1702 to emit the light 1802 such that the light 1802 is indicative of the alert. Based on the instructions, the light may cause a pattern 2002D to be emitted or projected onto the surface 1901. To output the pattern 2002D, the light source 1702 may include a plurality of light sources that are activated in a temporal and/or visual pattern to output the pattern 2002D. In the example of FIG. 20D, the pattern 2002D includes a symbol, particularly a representation of the route (e.g., a representation of a route edge, a route waypoint, etc.). Therefore, the system may use the pattern 2002D to communicate a route of the robot 2000D to a human within the environment such that the human can more accurately and reliably understand the movement of the robot 2000D.

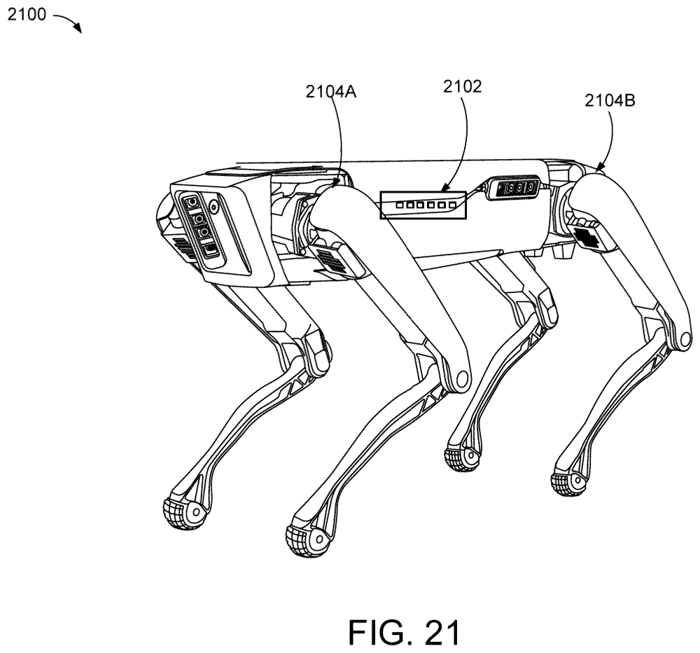

FIG. 21 depicts a side view of a legged robot 2100. The robot 2100 may include and/or may be similar to the robot 1700 discussed above with reference to FIG. 17. The robot 2100 includes a body, one or more legs coupled to the body, an arm coupled to the body, and a plurality of light sources. The plurality of light sources includes a first array of light sources 2102, a first light source 2104A, and a second light source 2104B.

The first array of light sources 2102 may include multiple light sources located on a body of the robot 2100, particularly on a top or side of the body. In the example of FIG. 21, the first array of light sources 2102 may include a row of light sources located on a side of the robot between a front leg of the robot 2100 and a rear leg of the robot 2100. For example, the first array of light sources 2102 may include multiple light sources located in a horizontal manner between the front leg and the rear leg. A system may control the first array of light sources 2102 to provide light indicative of an alert. Further, the system may control the first array of light sources 2102 in a temporal or visual pattern to provide light indicative of an alert. For example, the system may activate a first light source of the first array of light sources 2102 to indicate a first battery health status (e.g., low battery) and activate a first, second, and third light source of the first array of light sources 2102 to indicate a second battery health status (e.g., fully charged battery). In another example, the system may activate the first array of light sources 2102 at a first frequency (e.g., every 0.5 seconds) to indicate a first navigation status (e.g., following a route, executing an action, etc.) and may activate the first array of light sources 2102 at a second frequency (e.g., every 2 seconds) to indicate a second navigation status (e.g., not moving). Because the illustrated first array of light sources 2102 is positioned in a manner that allows direct viewing by entities in the environment, the brightness of their output is limited, for example, below about 200 lumens in broad daylight and below about 80 lumens in dark conditions. More generally, light sources capable of being directly viewed may be provided with between about 50 lumens and 80 lumens, or between 60 lumens and 70 lumens.

The first light source 2104A and the second light source 2104B may each include one or more light sources located on, in, behind, within, etc. a leg of the robot 2100. In some cases, the first light source 2104A and the second light source 2104B maybe oriented such that first light source 2104A and the second light source 2104B emit light directly onto a surface of the robot, in the illustrated example on a respective leg of the robot 2100. In the example of FIG. 21, each of the first light source 2104A and the second light source 2104B are oriented such that first light source 2104A and the second light source 2104B may output light on a respective leg of the robot 2100. The system may activate one or more of the first light source 2104A or the second light source 2104B to highlight a specific leg of the robot 2100 (e.g., to illustrate a leg is malfunctioning, to change a color of the leg, etc.). For observers in the environment, because the light sources 2104A, 2104B are indirectly viewed, they can be brighter than the direct viewed first array of light sources 2102, for example, greater than about 80 lumens in darkness, and greater than 200 lumens in broad daylight. More generally, indirectly viewed light sources may be provided with between about 80 lumens and 5,000 lumens, or between 200 lumens and 1000 lumens. In some cases, different types of light sources may have different lumens and/or lux. For example, a miniature LED may provide 200 lumens and 12,500,000 lux at the miniature LED and a ground-effect LED may provide 600 lumens and 14,000,000 lux at the ground-effect LED.

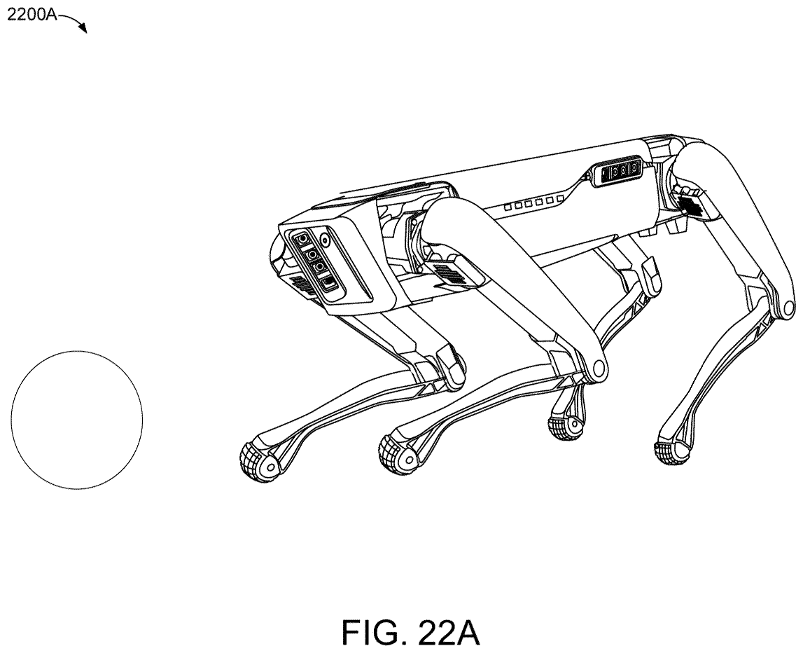

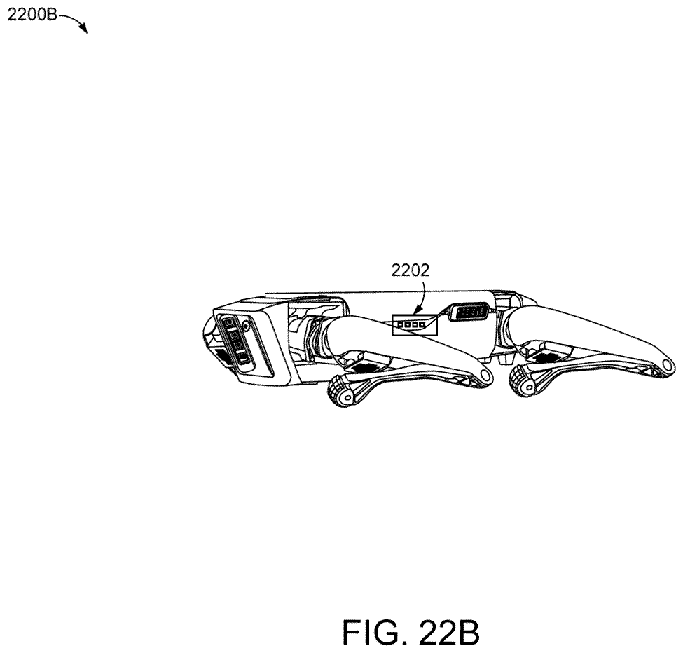

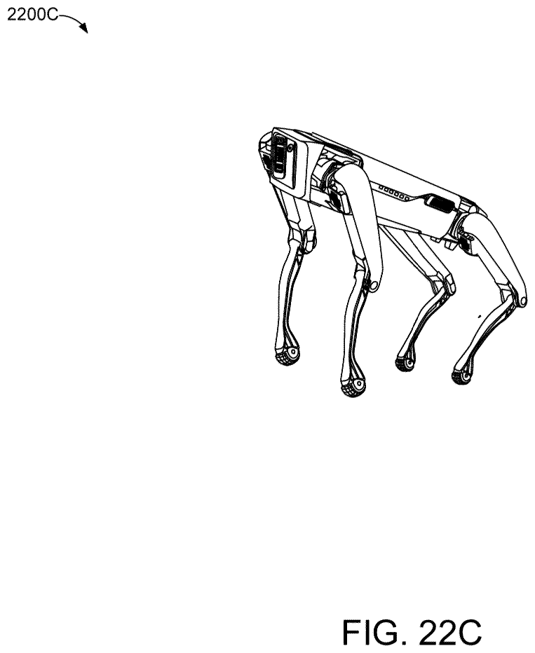

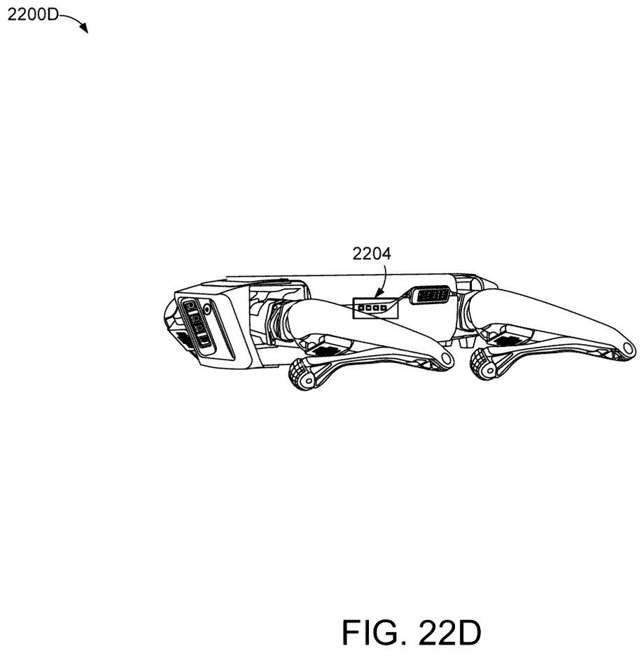

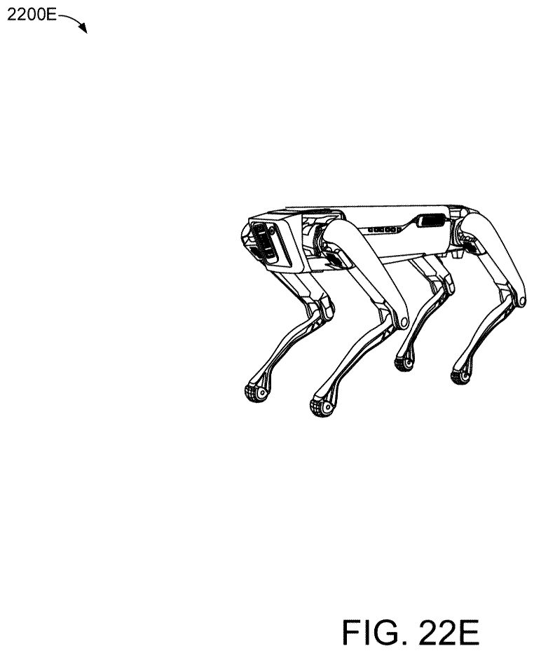

FIG. 22A depicts a view 2200A of a legged robot. The robot may include and/or may be similar or identical to the robot 2100 discussed above with reference to FIG. 21. The robot includes a body, one or more legs coupled to the body, an arm coupled to the body, and a plurality of light sources. As discussed above, the system of the robot may obtain sensor data and may identify and classify a feature as corresponding to an entity, obstacle, object, or structure in the environment of the robot. Based on the identification and classification of the feature, as discussed above with respect to FIGS. 1-15, the system can identify an alert and identify how to output light indicative of the alert.

In the example of FIG. 22A, the system identifies and classifies a feature as corresponding to a particular object (e.g., a ball). Based on identifying and classifying the feature as corresponding to a ball, the system may identify an alert. Based on the alert, the system can instruct the plurality of light sources to output light indicative of the alert. For example, the system can instruct the plurality of light sources to emit a particular pattern of light that is indicative of the alert. For example, each of the first array of light sources, the first light source and the second light source can be instructed to emit a light green light, indicating normal operation. Further, the system may cause the robot to interact with the object (e.g., by tilting downward for the robot head to “face” the object, shaking a front portion of the object, kicking the object, etc.). As the output light may be indicative of the alert, another system or person may be able to interpret the output light to identify the alert.

In some cases, based on identifying and classifying the feature, the system may determine how to output light. For example, if the system determines that the feature corresponds to an entity (e.g., a human), the system may instruct a light source to emit light with a lower intensity as compared to if the system determines that the feature corresponds to a structure (e.g., a wall).

FIG. 22B depicts a view 2200B of the legged robot of FIG. 22A. In the example of FIG. 22B, based on the data associated with the robot, the system identifies one or more parameters of the robot (e.g., the robot is in a crouching position, the robot is in a low power state, the robot is shutting down, the robot is in a standby state, the robot has encountered an issue, etc.) based on the data associated with the robot. Specifically, in the example of FIG. 22B, the system may identify that the robot is in a low power state. Based on identifying that the robot is in a low power state, the system may identify an alert (e.g., a low power alert). Based on the alert, the system can instruct the plurality of light sources to emit light (e.g., a pattern of light) indicative of the alert. In the example of FIG. 22B, the system can instruct the plurality of light sources to each output red colored light 2202 indicative of the powered off alert. Further, the system can instruct the plurality of light sources to each output red colored light in a particular pattern (e.g., a first light source may emit light during a first time period, a second light source may emit light during a second time period, etc.).

FIG. 22C depicts a view 2200C of the legged robot of FIG. 22A. In the example of FIG. 22C, based on the sensor data, the system identifies and classifies a feature as corresponding to a particular entity (e.g., a human). Based on identifying and classifying the feature as corresponding to a particular entity, the system may identify an alert. Based on the alert, the system can instruct the plurality of light sources to output light indicative of the alert. For example, the system can instruct the plurality of light sources to output a particular pattern of light that is indicative of the alert. Further, the system may cause the robot to interact with the particular entity (e.g., by directing a front portion of the robot to the human (looking up at the human)).

In some cases, based on causing the robot to interact with the particular entity (e.g., by lifting a front portion of the robot towards the human), the system may adjust lighting parameters of the light output by the plurality of light sources. Further, the system may dynamically adjust the lighting parameters as the robot interacts with the particular entity (e.g., such that the intensity of the light output by the plurality of light sources decreases as the front portion of the robot is lifted towards the human).

FIG. 22D depicts a view 2200D of the legged robot of FIG. 22A. In the example of FIG. 22D, the system identifies one or more parameters of the robot based on the data associated with the robot. Specifically, in the example of FIG. 22D, the system may identify that the robot has been powered on. Based on identifying that the robot has been powered on, is activated, is starting a navigation process, etc., the system may identify an alert (e.g., a powered on alert). Based on the alert, the system can instruct the plurality of light sources to emit light (e.g., a pattern of light) indicative of the alert. In the example of FIG. 22D, the system can instruct the plurality of light sources to output light green colored light 2204 indicative of the powered on alert so that an observer or user can recognize readiness for operation.

FIG. 22E depicts a view 2200E of the legged robot of FIG. 22A. In the example of FIG. 22E, the system identifies one or more parameters of the robot based on the data associated with the robot. Specifically, in the example of FIG. 22E, the system may identify that the robot has stood up and is ready for navigation. Based on identifying that the robot is ready for navigation, the system may identify an alert (e.g., a ready for navigation alert). Based on the alert, the system can instruct the plurality of light sources to output light (e.g., a pattern of light) indicative of the alert.

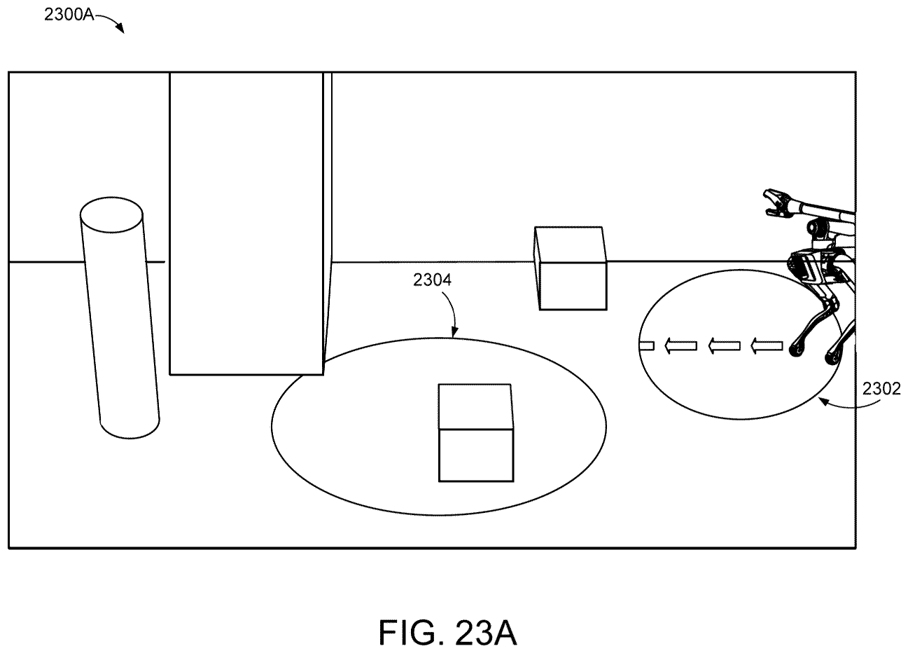

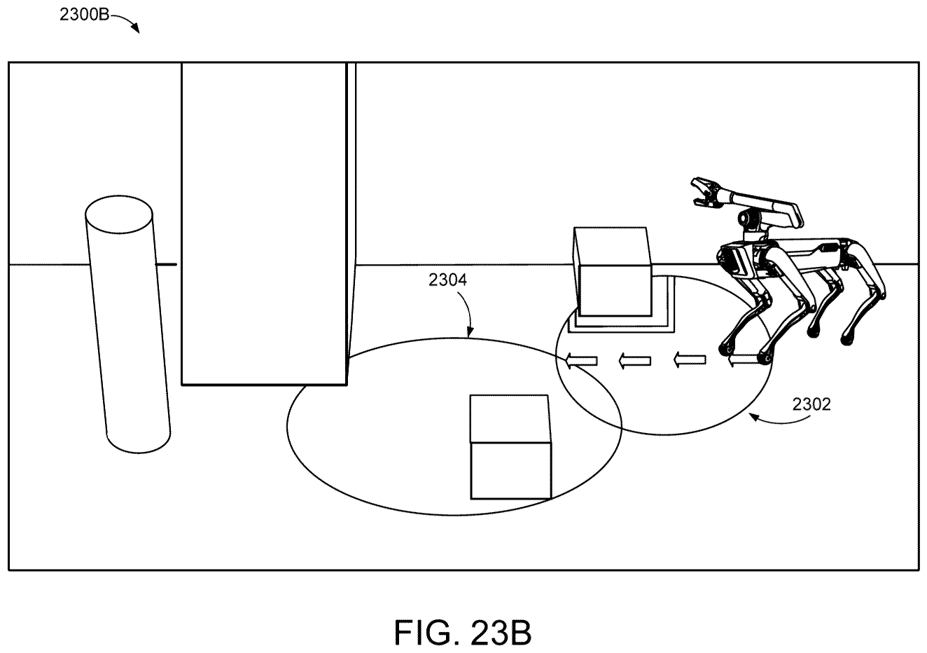

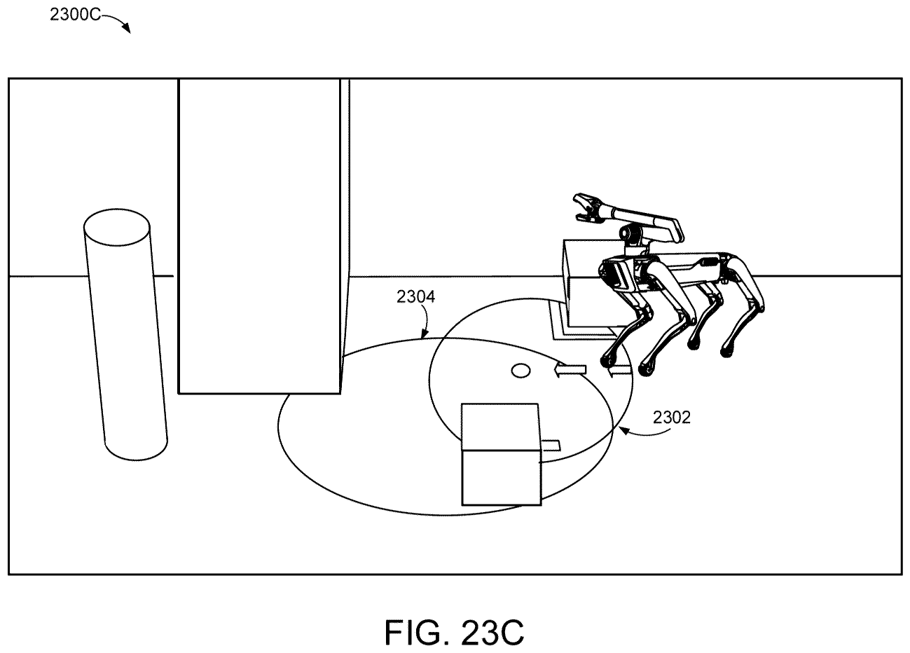

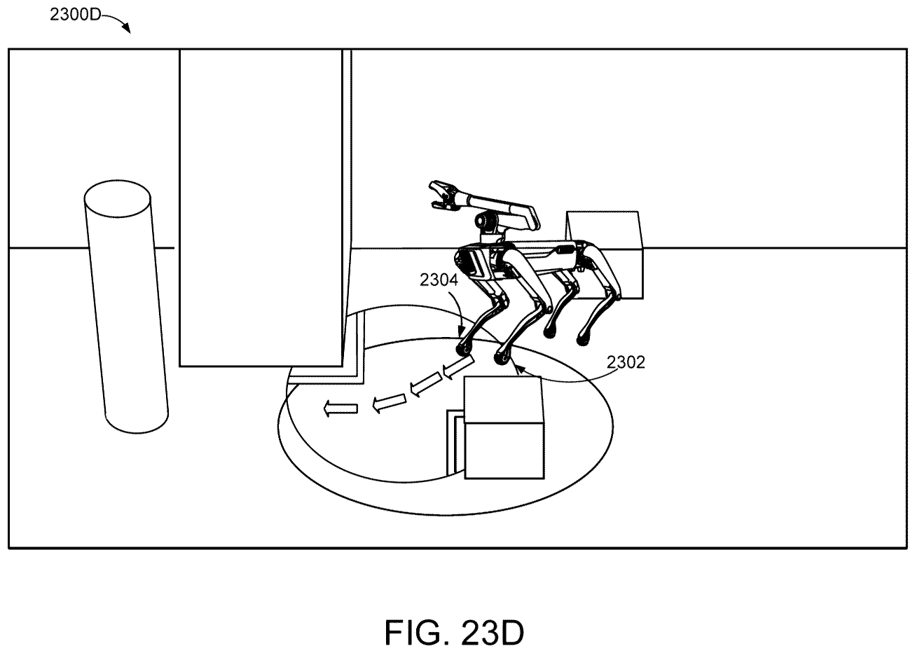

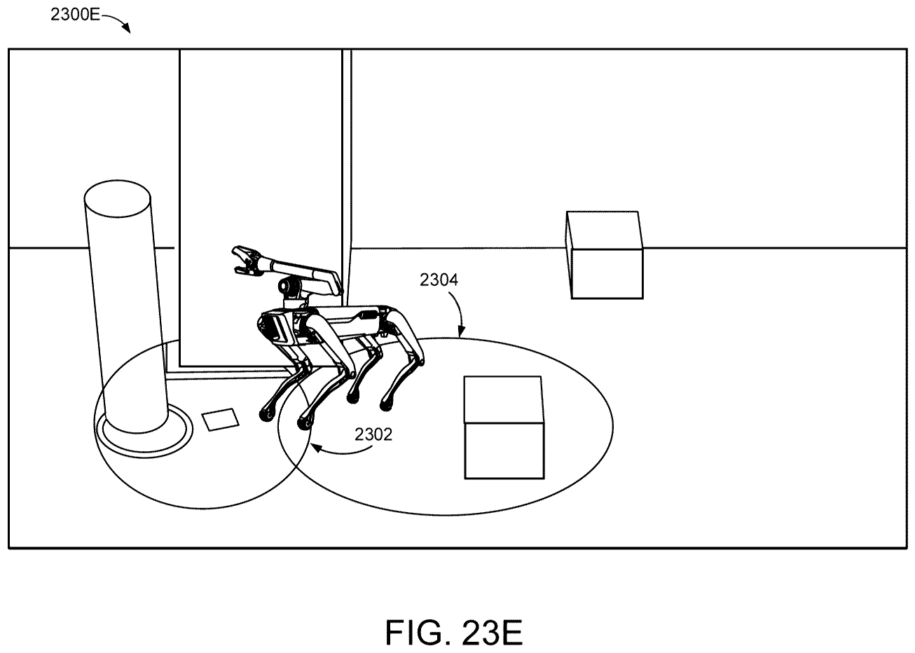

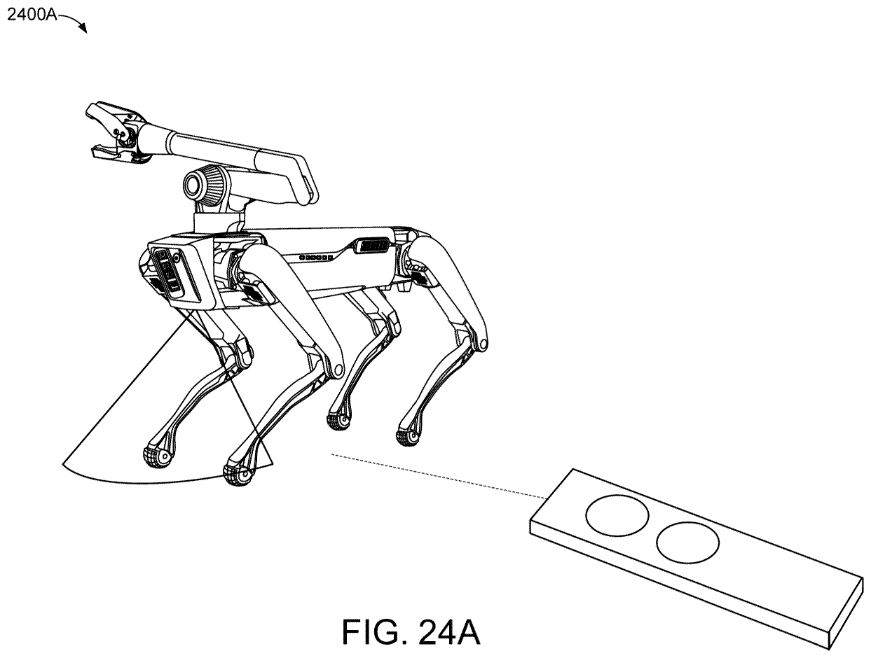

FIG. 23A depicts a view 2300A of a legged robot navigating within an environment. The robot may include and/or may be similar to the robots 1700 and 2000A-2000D discussed above with reference to FIGS. 17 and 20A-20D. The robot includes a body, one or more legs coupled to the body, an arm coupled to the body, and a plurality of light sources. In particular, the robot includes a projector light source as discussed with respect to FIGS. 20A-20D.

A system of the robot may obtain data associated with the robot. For example, the system may obtain sensor data from one or more sensors of the robot. Based on the data associated with the robot, the system can obtain route data for the robot indicative of a route of the robot. Further, based on the data associated with the robot, the system may identify and classify a feature as corresponding to an entity, obstacle, object, or structure in the environment of the robot. Based on the identification and classification of the feature and the route data, the system can identify an alert (e.g., indicative of the route data) and identify how to emit light indicative of the alert.

In the example of FIG. 23A, the system identifies a route of the robot through the environment based on the data associated with the robot. Based on identifying the route, the system may identify an alert that is indicative of the route. Based on the alert, the system can instruct the plurality of light sources to output first light 2302 and second light 2304. In some cases, the first light 2302 and/or the second light 2304 may be emitted by a light source separate and distinct from the robot.

The first light 2302 and/or the second light 2304 may be indicative of the alert. For example, the first light 2302 (e.g., a particular pattern of light) may represent the route and the second light may highlight an obstacle. In the example of FIG. 23A, the first light 2302 includes one or more arrows indicating the route that the robot is taking through the environment. FIG. 23A shows multiple colinear arrows, indicating a straight route for the robot for a period of time or distance represented by the circle of illumination.

FIG. 23B depicts a view 2300B of the legged robot of FIG. 23A navigating within the environment after traversing a few steps. In the example of FIG. 23B, the system continues to identify the route of the robot through the environment based on the data associated with the robot. Further, the system identifies a feature (and classifies the feature as corresponding to an obstacle). The system may identify features that correspond to all or a portion of an object, obstacle, entity, or structure within a particular proximity of the robot. For example, the system may identify features that correspond to all or a portion of an object, obstacle, entity, or structure such that light output by a light source of the robot will contact all or a portion of the object, obstacle, entity, or structure.

Based on identifying the route and the feature, the system may identify an alert that is indicative of the present course of the route and the obstacle corresponding to the feature. Based on the alert, the system can instruct the plurality of light sources to emit light indicative of the alert. Specifically, the system can instruct the plurality of light sources to emit light indicative of a portion of the route that corresponds to a coverage of the light (e.g., range of the light) and light indicative of an object, obstacle, entity, or structure that corresponds to a coverage of the light, as shown.

In another example, the system can instruct the plurality of light sources to emit a particular pattern of light that represents the route and the obstacle corresponding to the feature. Specifically, the pattern of light may be indicative of a buffer zone around the obstacle that the robot is to avoid. The zone around the obstacle may depend on the classification of the feature, as disclosed with respect to FIGS. 1-15. For example, the system may implement larger zones for humans or other movers as compared to zones for pallets based on the pallets not being capable of self-movement. Even larger zones may be afforded to humans compared to other movers, in order to reduce human anxiety over unexpected robot movements.

In the example of FIG. 23B, the first light 2302 includes one or more arrows indicating the route that the robot is taking (still multiple colinear arrows, indicating a straight route for the robot for a period of time or distance represented by the circle of illumination) through the environment and a zone around the portion of the obstacle that falls within the circle of illumination emitted by the projector.

In some cases, the first light 2302 and/or the second light 2304 may be output onto a surface. For example, the first light 2302 may be output on a ground surface. In some cases, the first light 2302 can be output onto the obstacle to highlight the obstacle, change the color of the obstacle, etc.

FIG. 23C depicts a view 2300C of the legged robot of FIG. 23B after further traversal of the environment. Based on identifying the route and the features, the system may identify an alert that is indicative of the route and the obstacles corresponding to the features. Based on the alert, the system can instruct the plurality of light sources to output light indicative of the alert. Specifically, the system can instruct the plurality of light sources to output a particular pattern of light that represents the route (e.g., route waypoints and/or route edges of the route) and the obstacles corresponding to the features. Specifically, the pattern of light may be indicative of zones around the obstacles that the robot is to avoid. In some cases, the zones around the obstacles may be different based on the type of obstacle.

In the example of FIG. 23C, the first light 2302 includes one or more arrows indicating the route that the robot is taking through the environment, a circle indicating a route waypoint, and buffer zones around the illuminated portions of obstacles. The trailing edge of the first obstacle now appears, with an indication of buffer zone, in the circle of illumination from the projector, and the leading edge of a second obstacle now appears within the circle of illumination, also showing a buffer zone. The projected symbols representing the route now include arrows leading to a dot, which represents a waypoint or inflection point in the route.

FIG. 23D depicts a view 2300D of the legged robot of FIG. 23E after reaching the inflection point and turning to face a new direction. Based on identifying the route and the features, the system may identify an alert that is indicative of the route and the obstacles corresponding to the features. Based on the alert, the system can instruct the plurality of light sources to project light indicative of the alert. Specifically, the system can instruct the plurality of light sources to project a particular pattern of light that represents the route and the obstacles corresponding to the features.

In the example of FIG. 23D, the first light 2302 includes one or more arrows indicating the route that the robot is taking through the environment and buffer zones around the illuminated portions of the obstacles. The first obstacle is no longer illuminated at the point of the path in FIG. 23D, a trailing edge of the second obstacle now appears, with an indication of buffer zone, in the circle of illumination from the projector, and the leading edge of a third obstacle now appears within the circle of illumination, also showing a buffer zone. The projected symbols representing the route now include arrows that change direction within the circle of illumination projected in front of the robot, indicating a turn as the robot negotiates between the second and third obstacles.

FIG. 23E depicts a view 2300E of the legged robot of FIG. 23F after further traversal of the environment. In the example of FIG. 23E, the system identifies a route of the robot through the environment based on the data associated with the robot. Further, the system identifies multiple features (and classifies the features as corresponding to obstacles). Based on identifying the route and the features, the system may identify an alert that is indicative of the route and the obstacles corresponding to the features. In the illustrated example, the robot has identified and classified a fourth obstacle as a mover. The system can instruct the plurality of light sources to project light indicative of the alert suitable for the selected route and classified object. Specifically, the system can instruct the plurality of light sources to project a particular pattern of light that represents that the navigation may cause the robot to enter the zone of the obstacle. In the example of FIG. 23E, first light 2302 includes red light and a red waypoint indicating that the waypoint is a target destination and thus stopping point, such as based upon approaching a recognized moving obstacle as the target destination. The status of the fourth obstacle as a mover, and particularly as a human, also causes the system to generate a larger buffer zone as compared to the buffer zones afforded the inanimate first, second, and third obstacles.

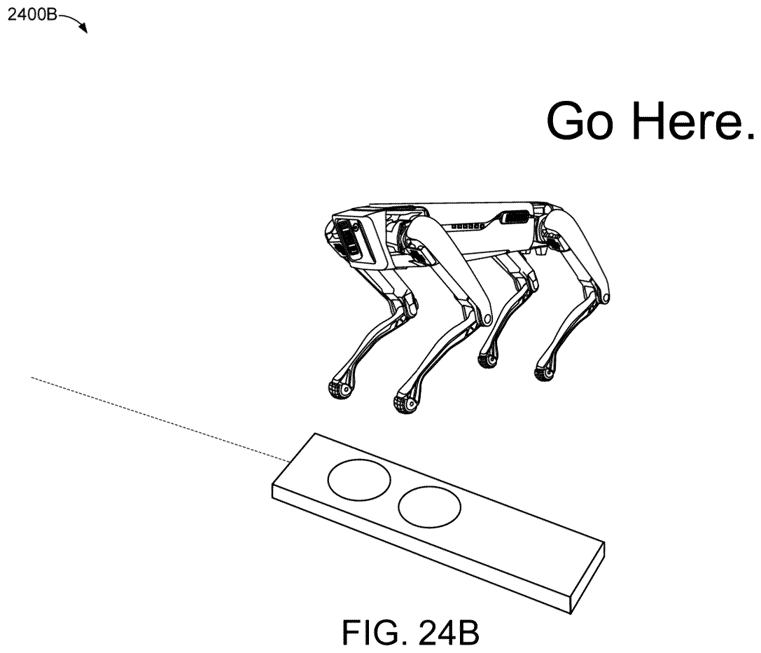

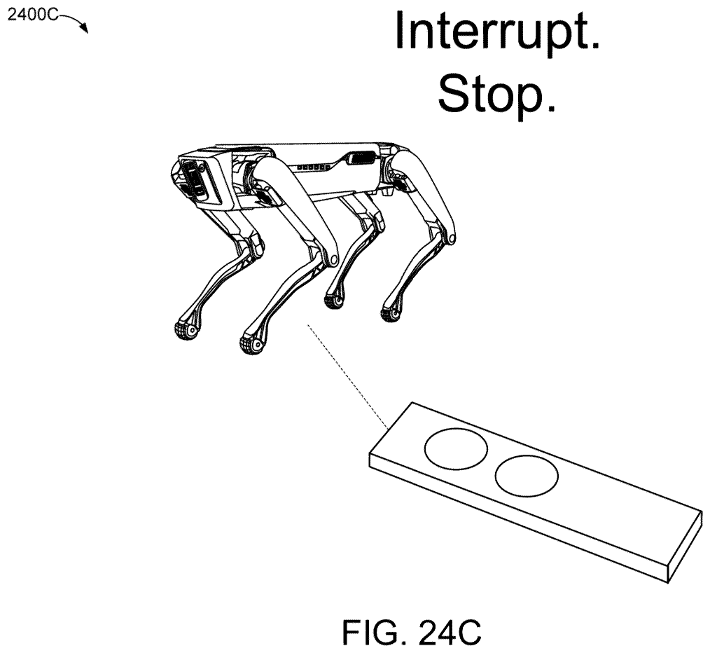

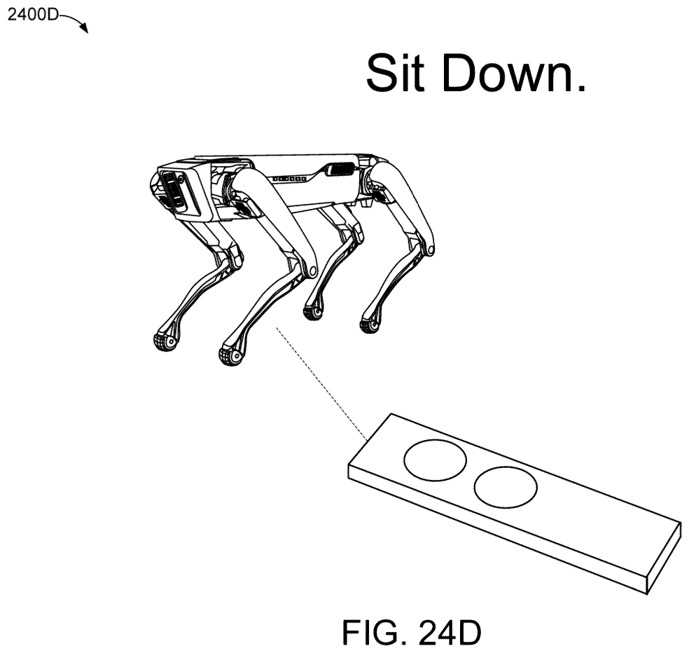

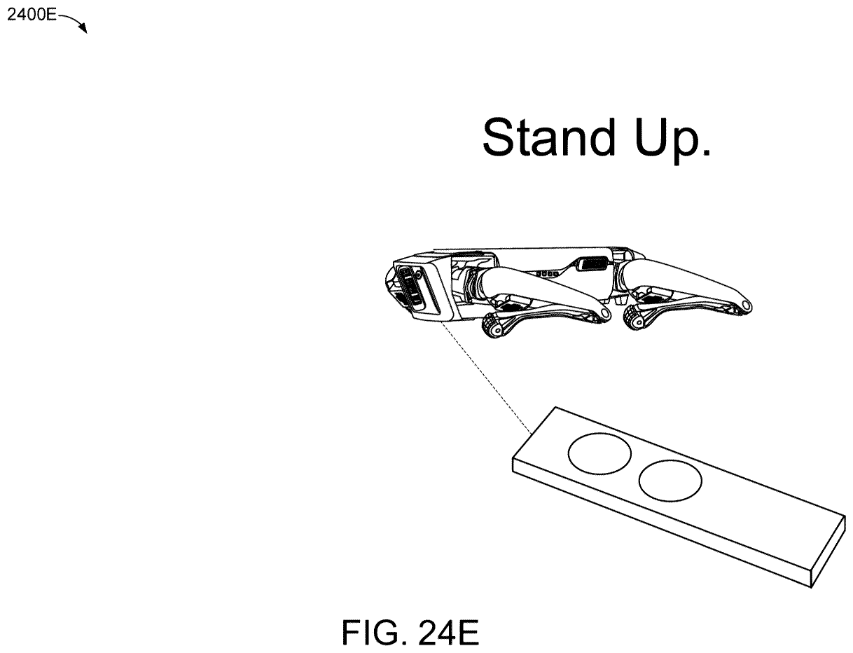

FIG. 24A depicts a view 2400A of a legged robot navigating within an environment. The robot may include and/or may be similar to the robots 1700 and 2000A-2000D discussed above with reference to FIGS. 17 and 20A-20D. The robot includes a body, one or more legs coupled to the body, an arm coupled to the body, and a plurality of light sources. In particular, the robot includes a projector light source as discussed with respect to FIGS. 20A-20D. A system of the robot may receive input via a user computing device. The input may identify an action for the robot. In some cases, the user computing device may provide a limited set of inputs (e.g., two inputs).

Based on the input, the system may identify an output of the robot. For example, the system may identify audio to output and/or light to output based on the input. In some cases, the system may adjust lighting parameters of light and/or audio parameters of audio output by sources of the robot. In some cases, the system may cause the sources to output light and/or audio based on receiving the input. For example, the system may identify a temporal or visual pattern of light to project based on the input.

FIG. 24B depicts a view 2400B of the legged robot of FIG. 24A. In some cases, the user computing device may provide the input via a laser pointer. For example, the user computing device may include and utilize the laser pointer to point (e.g., the laser pointer) to a particular location. In the example of FIG. 24B, the input may identify an instruction (e.g., command) to navigate to a particular location within the environment. Based on receiving the instruction, the robot may navigate to the particular location (e.g., by instructing movement of one or more legs of the robot). Further, based on the input, the system may identify an output of the robot that is indicative of the input. For example, the system may identify audio to output and/or light to output indicative of the instruction to navigate to a particular location (e.g., a flashing green light, audio identifying the robot is moving).

FIG. 24C depicts a view 2400C of the legged robot of FIG. 24A. In the example of FIG. 24C, the input may identify an instruction to stop navigation within the environment. Based on receiving the instruction, the robot may stop navigation (e.g., by instructing one or more legs of the robot to stop movement). Further, based on the input, the system may identify an output of the robot that is indicative of the input. For example, the system may identify audio to output and/or light to output indicative of the instruction to stop navigation (e.g., a flashing red light, audio identifying the robot is stopped).

FIG. 24D depicts a view 2400D of the legged robot of FIG. 24A. In the example of FIG. 24D, the input may identify an instruction to sit down. Based on receiving the instruction, the robot may sit down (e.g., by initiating a sit down movement). Further, based on the input, the system may identify an output of the robot that is indicative of the input. For example, the system may identify audio to output and/or light to output indicative of the instruction to sit down (e.g., a flashing yellow light, audio identifying the robot is sitting).

FIG. 24E depicts a view 2400E of the legged robot of FIG. 24A. In the example of FIG. 24E, the input may identify an instruction to stand up from a sitting down position. Based on receiving the instruction, the robot may stand up (e.g., by initiating a stand up movement). Further, based on the input, the system may identify an output of the robot that is indicative of the input. For example, the system may identify audio to output and/or light to output indicative of the instruction to stand up (e.g., a flashing green light, audio identifying the robot is standing up).

In some embodiments, the user computing device may have two buttons (e.g., to provide two inputs) and a laser pointer. The user computing device (as discussed above) may instruct the robot to move to a location using the laser pointer. Further, interactions with the first button and the second button may cause the robot to perform different actions depending on parameters or status of the robot. For example, a first interaction with the first button while the robot is navigating the environment may cause the robot to stop navigation (as seen in FIG. 24C) and a second interaction with the first button while the robot has stopped navigation but is standing up may cause the robot to sit down (as seen in FIG. 24D). Further, a first interaction with the second button while the robot is sitting down may cause the robot to stand up (as seen in FIG. 24E) and a second interaction with the second button while the robot is standing up but not navigating the environment may cause the robot to initiate navigation. Thus, robot intelligence with respect to its own status or parameters may facilitate use of a greatly simplified external controller for “manual” remote control or instruction of the robot.

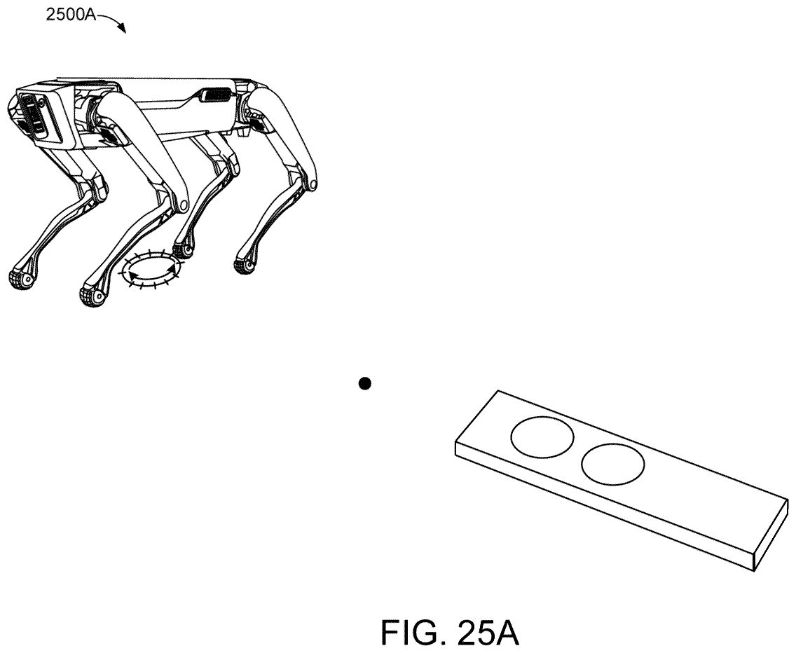

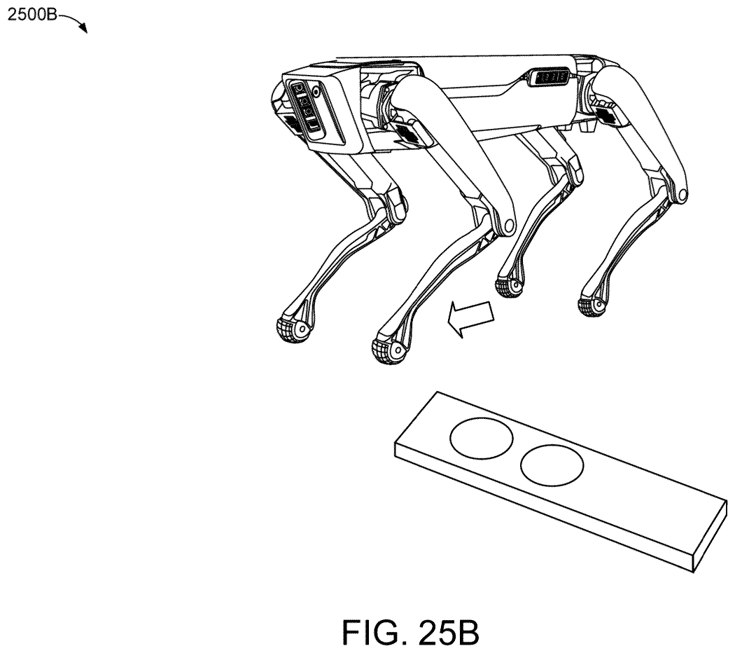

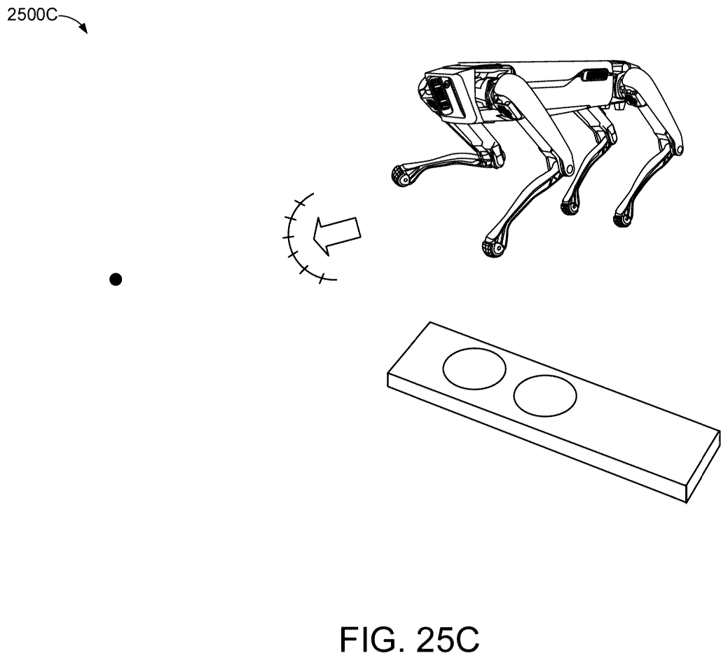

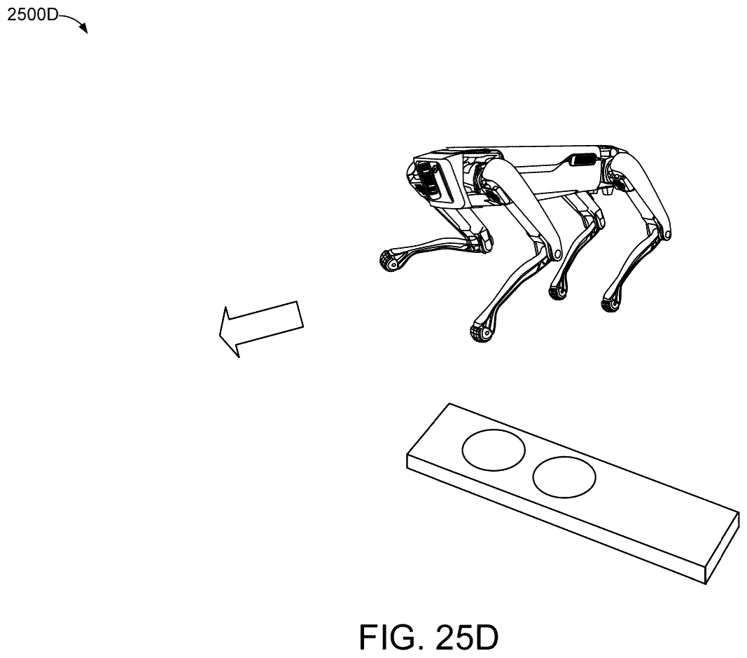

FIG. 25A depicts a view 2500A of a legged robot navigating within an environment. The robot may include and/or may be similar to the robot 1700 discussed above with reference to FIG. 17. The robot includes a body, one or more legs coupled to the body, an arm coupled to the body, and a plurality of light sources. Similar to FIG. 20A, the robot includes at least one light source that is a projector capable of projecting an image onto a surface, and electronics capable of altering the image to be projected. In the illustrated example of FIG. 25A, the projector is located on the bottom of the robot, rather than on the head, but like FIG. 20A the projector is generally pointed downwardly toward the ground. The robot may receive input via a user computing device. The input may identify an action for the robot. In some cases, the user computing device may provide a limited set of inputs (e.g., two inputs).

As discussed above, the user computing device may provide the input (e.g., via a laser pointer). The robot may read the input provided by the user computing device. For example, the robot may read the input using one or more sensors of the robot. Further, the robot may read the input and identify a location within the environment. The robot may identify the location based on the input (e.g., a laser output by a laser pointer) and may determine how to navigate to the particular location based on identifying the location.

In the example of FIG. 25A, the input may identify an instruction to navigate to a particular location within the environment. Specifically, the input may identify a location located to a side of the robot. Based on receiving the instruction, the robot may orient relative to the location and navigate to the particular location (e.g., by instructing movement of one or more legs of the robot). To orient relative to the location and navigate to the particular location, the robot may perform one or more actions (e.g., a turning action, a walking action, etc.).

As discussed above, the robot may include one or more output sources (e.g., light sources, audio sources, etc.) and may provide an output via the one or more output sources. The output may be indicative of the actions being taken by the robot. In the example of FIG. 25A, the output is indicative of a turning action (to orient relative to the location associated with the input). The output may include light projected on a ground surface underneath the robot identifying the turning action (e.g., via a circular arrow).

In some cases, the robot may provide the output via the one or more output sources and the output may indicate a potential action (e.g., a possible action), a queued action (e.g., an action from a list of actions, an ordered action, etc.), etc. For example, the output may indicate an action to turn the robot, an action to roll the robot over, an action to navigate the robot to a particular destination, an action to move in a particular direction, an action to strafe to a particular side, etc. Further, the robot may provide the output indicating a plurality of potential actions, a plurality of queued actions, etc. For example, the output may indicate a first action to turn the robot in a first direction (e.g., clockwise) and a second action to turn the robot in a second direction (e.g., counterclockwise).

The robot may provide the output indicating a plurality of potential actions in different portions of the environment. For example, the robot may provide a portion of the output identifying a first action to turn the robot on a first portion of a surface (e.g., to the left and rear of the body of the robot), a second action to roll the robot over (e.g., to the left and front of the body of the robot), etc. In some cases, the robot may determine where to provide the output indicating the plurality of potential actions such that the output is provided to a user (e.g., on a ground surface in front of the user). For example, the robot may determine that a user (with a user computing device) is located to the left of the body of the robot and may provide the output on a portion of the environment located to the left of the body based on determining that the user is located to the left of the body. In some cases, the robot may determine a location of the user (e.g., based on sensor data from one or more sensors of the robot). For example, the robot may determine a location of the user based on image data indicative of the user, image data indicative of an input provided by a user computing device (e.g., a laser provided by a laser pointer), etc.

The input may indicate a selection (a selection and an approval) of a particular action. For example, a user computing device may point at and select a particular action (from a plurality of actions). Specifically, the user computing device may, via a laser pointer, point (a laser) at a particular action indicated by the output. For example, the output may indicate a first action to turn the robot, a second action to roll the robot over, a third action to navigate the robot to a particular destination, and/or a fourth action to move in a particular direction, and the user computing device may select (e.g., based on pointing a laser) a particular action (e.g., the fourth action) to select the particular action for performance.

To identify the selection of the particular action, the robot may utilize one or more sensors of the robot to identify an input provided by the user computing device (e.g., an input provided by the user computing device). For example, the robot may identify a laser input provided on a surface of the environment by a laser pointer of the user computing device using one or more sensors of the robot. Further, the robot may identify a location of the input provided by the user computing device. For example, the robot may identify a location of the input provided by the user computing device relative to a body of the robot, a sensor of the robot, an object, entity, structure, or obstacle in the environment, etc.

The robot may identify an action associated with the location of the input provided by the user computing device. For example, the output may act as a user interface (e.g., a screen) and the user computing device (e.g., the laser pointer) may act as an input device for the user interface (e.g., a computer mouse, a touch input, etc.). Further, the robot may interpret the input provided by the user computing device based on (e.g., relative to) the output provided by the robot.

The robot may determine that an output is provided (by the robot) indicating a plurality of potential actions in different portions of the environment and may determine a plurality of locations of the environment (e.g., on the ground surface) on which the plurality of potential actions is provided. In some cases, the robot may identify locations of a pixel or a group of pixels (e.g., pixel locations, coordinates, pixel coordinates, pixel positions, etc.) of the output by the robot (e.g., projected on the ground surface by the robot) and associated with each of the plurality of potential actions. For example, the robot may identify locations of a pixel or a group of pixels associated with a particular action within the environment.

Based on determining the plurality of locations of the environment on which the plurality of potential actions is provided and the location of the input provided by the user computing device, the robot may identify a particular action associated with (e.g., provided on) the location of the input provided by the user computing device. For example, the robot may identify locations of a pixel or a group of pixels that are associated with the input and a particular action. The robot may instruct performance of the particular action based on identifying the particular action is associated with the location of the input provided by the user computing device.

In some cases, the robot may identify a display additional actions action. For example, the action indicated by the output may be a strafe action and based on identifying the strafe action is associated with the location of the input provided by the user computing device, the robot may provide additional output indicating one or more additional actions associated with the selected strafe location. Further, the one or more additional actions may be variations of the selected action. For example, if the selected action is a strafe action, the one or more additional actions may include a strafe left action, a strafe right action, etc. The robot may provide the additional output indicating the one or more additional actions in different portions of the environment for selection of a particular additional action by a user computing device.

FIG. 25B depicts a view 2500B of the legged robot of FIG. 25A. In the example of FIG. 25B, the input may identify an instruction to turn on and prepare for navigation.

As discussed above, the robot may include one or more sources (e.g., light sources, audio sources, etc.) and may provide output via the one or more sources. The output may be indicative of a state of the robot. In the example of FIG. 25B, the output is indicative of a direction of orientation of the robot. The output may include light projected on a ground surface underneath the robot identifying the direction of orientation of the robot (e.g., via an arrow).

FIGS. 25C and 25D depict views 2500C, 2500D of a legged robot navigating within an environment. The robot may include and/or may be similar to the robot 1700 discussed above with reference to FIG. 17. The robot includes a body, one or more legs coupled to the body, an arm coupled to the body, and a plurality of light sources. Similar to FIG. 20A, the robot includes at least one light source that is a projector capable of projecting an image onto a surface, and electronics capable of altering the image to be projected. In the illustrated example of FIGS. 25C and 25D, the projector is located on a forward portion of the robot bottom or head of the robot, such that the projected patterns or images are cast downwardly on the ground forward of the robot, rather than directly underneath. The robot may receive input via a user computing device identifying an action for the robot.

As discussed above, the user computing device may provide the input (e.g., via a laser pointer). The robot may identify the location based on the input simultaneously with the user computing device providing the input. For example, while a laser pointer projects a laser on the ground, the robot may identify the input and a direction of travel for the robot to the location identified based on the input. In some cases, the robot may identify the input, in real time, and provide output indicative of a direction (e.g., via a directional arrow) of the input relative to the body of the robot, in real time. For example, the robot may identify the input is located to the left and front of the body of the robot and provide, in real time, light output indicating that the input is located to the left and front of the body of the robot. In some cases, the output may follow the input in real time. For example, as the location of the input changes, the output provided by the robot may change to account for the changing location of the input.

In the example of FIG. 25C, the input may identify an instruction to navigate to a particular location within the environment. As discussed above, the robot may include one or more sources (e.g., light sources, audio sources, etc.) and may provide output via the one or more sources. The output may be indicative of a walking action and the direction of orientation or travel of the robot to the location (e.g., prior to the robot initiating travel to the location). Further, as the input changes, the output provided via the one or more sources may change to identify an updated direction of travel. The robot may provide the output before implementing the walking action. For example, the robot may provide the output and wait a period of time (e.g., 10 seconds) before implementing the walking action. In some cases, the robot may provide an output indicative of a time until the walking action is implemented (e.g., a countdown).

In the example of FIG. 25D, the input may identify an instruction to navigate to a particular location within the environment. As discussed above, the robot may include one or more sources (e.g., light sources, audio sources, etc.) and may provide output via the one or more sources. The output may be indicative of the direction of travel by the robot as the robot travels to the location.

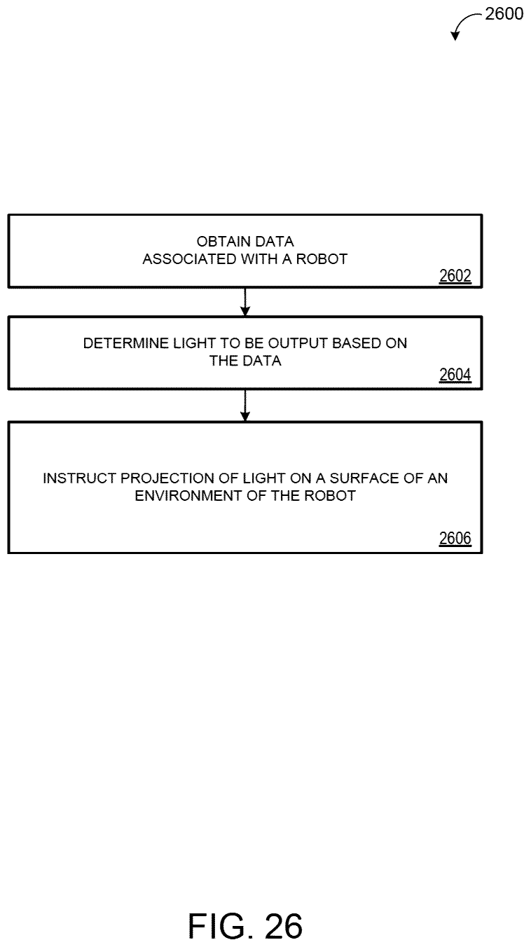

FIG. 26 shows a method 2600 executed by a computing system to operate a robot (e.g., by instructing one or more output sources of the robot to provide an output) based on data associated with the robot, according to some examples of the disclosed technologies. For example, the robot may be a legged robot with a plurality of legs (e.g., two or more legs, four or more legs, etc.), memory, and a processor. Further, the computing system may be a computing system of the robot. In some cases, the computing system of the robot may be located on and/or part of the robot. In some cases, the computing system of the robot may be distinct from and located remotely from the robot. For example, the computing system of the robot may communicate, via a local network, with the robot. The computing system may be similar, for example, to the sensor system 130, the computing system 140, the control system 170, and/or the output identification computing system 1602 as discussed above, and may include memory and/or data processing hardware.

At block 2602, the computing system obtains data (e.g., sensor data) associated with a robot. The computing system may obtain the data from one or more components (e.g., sensors) of the robot. For example, the data may include image data, lidar data, ladar data, radar data, pressure data, acceleration data, battery data (e.g., voltage data), speed data, position data, orientation data, pose data, tilt data, roll data, yaw data, ambient light data, ambient sound data, etc. The computing system can obtain the data from an image sensor, a lidar sensor, a ladar sensor, a radar sensor, pressure sensor, an accelerometer, a battery sensor, a speed sensor, a position sensor, an orientation sensor, a pose sensor, a tilt sensor, a light sensor, and/or any other component of the robot. Further, the computing system may obtain the data from a sensor located on the robot and/or from a sensor located separately from the robot.

In one example, the data may include audio data associated with a component of the robot. For example, the data may be indicative of audio output by one or more components of the robot.

The data may include data associated with an environment of the robot. For example, the computing system may identify features associated with the environment of the robot based on the data. In some cases, the data may include or may be associated with route data. For example, the data can include a map of the environment indicating one or more of an obstacle, structure, corner, intersection, path of a robot, path of a human, etc. in the environment.

The computing system may identify one or more parameters of an entity, object, structure, or obstacle in the environment, one or more parameters of the robot, or one or more parameters of the environment using the data. In some cases, the computing system may detect (e.g., identify and classify) one or more features of the environment (e.g., as corresponding to a particular entity, obstacle, object, or structure) based on the data. In some cases, the robot and the entity may be separated by one or more of an obstacle, an object, a structure, or another entity within the environment. The computing system may identify parameters of the features and/or the corresponding entity, object, structure, or obstacle. For example, the parameters may include a location of the feature, a classification of the feature (e.g., as corresponding to a mover, a non-mover, an entity, an object, an obstacle, a structure, etc.), an action associated with the feature (e.g., a communication associated with the feature, a walking action, etc.), etc. In some cases, the computing system may detect an entity (e.g., a human) based on the data. Further, the data may indicate detection of the one or more features (e.g., detection of an entity).

In some cases, the computing system may identify one or more parameters of the robot based on the data. The one or more parameters of the robot may be based on data indicating feedback from one or more components of the robot. For example, the computing system may identify an operational status (e.g., operational, non-operational, operational but limited, etc.), a charge state status (e.g., charged, not charged, partially charged, a level of charge, etc.), a battery depletion status (e.g., battery depleted, a level of battery depletion, battery partially depleted, battery not depleted, etc.), a functional status (e.g., functioning, functioning but not as instructed, not functioning, etc.), a location, a position, a network connection status (e.g., connected, not connected, connected to a particular network, etc.), etc. of the robot and/or of a component of the robot (e.g., a leg, an arm, a battery, a sensor, a motor, etc.).

The computing system may identify one or more parameters of a perception system of the robot (e.g., the data may be indicative of one or more parameters of a perception system of the robot). For example, the perception system may include one or more sensors of the robot. The one or more parameters may include a data capture rate, a data capture time period, etc. For an image sensor, the data capture rate and/or the data capture time period may be based on a shutter speed, a frame rate, etc. For example, the one or more parameters may be one or more parameters of one or more sensors.

In some cases, the computing system may identify one or more parameters of the environment based on the data. The one or more parameters of the environment may be based on data indicating one or more features associated with the parameter. For example, the one or more parameters of the environment may include a capacity status (e.g., over capacity, below capacity, at capacity, etc.), a dynamic environment status (e.g., the obstacles, entities, objects, or structures associated with the environment are dynamic or static), etc. The one or more parameters of the environment may include real-time parameters and/or historical parameters. For example, real-time parameters may include parameters of the environment based on the data indicating the presence of one or more obstacles, objects, structures, or entities within the environment corresponding to one or more features. Specifically, a real-time parameter may include a parameter of the environment indicating that the environment includes five different entities (e.g., is crowded). In another example, historical parameters may include parameters based on the data indicating that the robot is associated with the particular environment. Based on the data indicating that the robot is associated with the particular environment, the computing system may obtain and utilize environmental association data to determine whether the environment has previously been associated with one or more obstacles, objects, structures, or entities.

The robot may further include one or more light sources. For example, the one or more light sources may include one or more light emitting diodes, one or more lasers, one or more projectors, one or more optical devices, etc. In one example, the one or more light sources includes a plurality of light emitting diodes. The one or more light sources may be arranged in an array on the robot. For example, the one or more light sources may be arranged in a group of one or more rows and/or one or more columns. Further, the one or more light sources may be arranged in a physical row (e.g., such that the one or more light sources have a same or similar vertical position), column (e.g., such that the one or more light sources have a same or similar horizontal position), a diagonal, etc.

The one or more light sources may be located on the body of the robot, on a leg of the robot, on an arm of the robot, etc. For example, the one or more light sources may be located on a bottom portion of a body of the robot (e.g., the bottom portion relative to the surface of the environment such that the ground surface is closer in proximity to the bottom portion as compared to a top portion of the body). In another example, the one or more light sources may be located on a front portion of the robot relative to a traversal direction of the robot. For example, front portion of the robot may be oriented in a traversal direction of the robot such that the front portion of the robot precedes a rear portion of the robot as the robot traverses an environment.

In some cases, the one or more light sources may be at least partially covered by a cover (e.g., a shade or shield), by a leg of the robot, etc. For example, the one or more light sources may be located on a top portion of the body of the robot and may be at least partially covered such that the one or more light sources output light on the surface of the environment.

The robot may include one or more audio sources (e.g., one or more different audio sources). For example, the robot may include a buzzer, a resonator, a speaker, etc. In some cases, the robot may include a transducer (e.g., piezo transducer). For example, the transducer may be affixed to the body of the robot. The computing system may utilize the transducer to cause the body of the robot to resonate and output audio (e.g., a sound). For example, the body of the robot may include one or more cavities, panels, chassis, etc. and the computing system may utilize the transducer to cause the body of the robot to resonate and output audio based on the resonation of the one or more cavities, panels (e.g., body panels), chassis, etc.

At block 2604, the computing system determines light to be output based on the data. To determine the light to be output (e.g., by a light source of the robot), the computing system can determine an alert (e.g., a warning, a message, etc.) based on the data. For example, the computing system can determine an alert such that the alert is indicative of the data. In another example, the computing system can determine the alert such that the alert is indicative of an intent of the robot (e.g., an intent to perform an action) based on the data. The computing system may determine the light such that the light is indicative of the alert. In some cases, the computing system can determine the alert from a plurality of alerts. Further, the alert may be a visual alert (e.g., an image). The computing system may determine the alert to communicate with a detected entity (e.g., communicate a warning, a message, etc.). In some cases, the computing system may not determine an alert and may determine an output (e.g., light to be output) without determining an alert. For example, the computing system can determine light to be output such that the light is indicative of the data.

In some embodiments, the computing system may determine (e.g., select) an output (e.g., an audio output, a light output, a haptic output, etc.) based on the data. For example, in some cases, the computing system may not determine light to be output and, instead, may determine audio to be output. In another example, the computing system may determine light and audio to be output. The computing system may determine the output such that the output is indicative of the alert (e.g., indicative of an action of the robot). The computing system may determine the output from a plurality of outputs (e.g., a plurality of audio outputs, a plurality of light outputs, a plurality of haptic outputs, etc.). All or a portion of the plurality of outputs may be associated with one or more parameters (e.g., audio parameters, lighting parameters, haptic parameters, etc.).

The computing system may identify one or more sources (e.g., light sources, audio sources, etc.) of a plurality of sources (e.g., a plurality of light sources, a plurality of audio sources, etc.) of the robot to provide the output (e.g., to output the light, the audio, etc.). The computing system may identify (e.g., determine) one or more parameters for the output by the one or more sources. For example, one or more lighting parameters for a light source may include a direction (e.g., light direction), frequency, pattern (e.g., light pattern), color (e.g., light color), brightness, intensity (e.g., light intensity), illuminance, luminance, luminous flux, etc. of the light. The computing system may adjust the one or more parameters to adjust how the output is provided by the one or more sources.

The computing system may determine the one or more sources (e.g., from the plurality of sources) based on the alert. For example, the computing system may determine one or more light sources that are configured to provide (e.g., capable of providing) the alert. Further, a first light source of the plurality of light sources may be associated with a first alert and a second light source of the plurality of light sources may be associated with a second alert. For example, a first light source may be a red light source and may be configured to provide red light indicative of particular alerts and a second light source may be a green light source and may be configured to provide green light indicative of particular alerts.

The computing system may determine the one or more sources (e.g., from the plurality of sources) based on the data. The computing system may determine a portion of the environment to provide the output based on the data. For example, the computing system may identify an obstacle in the environment based on the data, may identify a location of the obstacle in the environment, and may determine one or more light sources that can output light around the obstacle indicative of a zone around the obstacle based on the location of the obstacle and a location of the one or more light sources (e.g., on the body of the robot).

The one or more sources may have one or more minimum, maximum, or ranges of parameters. For example, the one or more light sources may have a minimum brightness (e.g., a minimum brightness of light to be output by the one or more light sources).

The computing system may determine an output from the sources that blends with other output based on data associated with the robot (e.g., sensor data). For example, the computing system may identify an audio output and a light output that blend to generate particular data (e.g., a set of images with particular audio). In another example, the computing system can identify an audio output that blends with environmental audio (e.g., output by one or more other components of the robot, an entity within the environment, etc.) to output particular audio and/or a light output that blends with environment light (e.g., output by one or more other components of the robot, an entity within the environment, etc.) to output particular light. For example, the environmental audio and/or the environmental light may be background noise and/or light. Further, the computing system may determine that one or more audio sources and/or light sources (e.g., components of the robot) are outputting audio and/or light and/or predict that one or more audio sources and/or light sources will output audio and/or light during a particular time period. For example, the computing system may predict that a motor of the robot will produce particular audio during navigation. Therefore, the computing system can identify audio and/or light based on the data and determine the output based on the identified audio and/or light.

Specifically, the environment may be associated with one or more audio conditions or lighting conditions (e.g., a lighting level, a shade level, etc.). For example, the environment may include one or more light sources in the environment (e.g., light sources of another robot, light sources separate and distinct from the robot, etc.). The computing system may determine the one or more lighting conditions in the environment and may determine the alert based on the one or more lighting conditions. To determine the one or more lighting conditions, the computing system may determine the one or more light sources in the environment and identify light output by the one or more light sources in the environment. The computing system may adjust (e.g., automatically) the alert or a manner of displaying the determined alert based on the one or more lighting conditions.

In some cases, the computing system may determine the output based on determining that the data indicates an obstacle, structure, corner, intersection, path, etc. within the environment identifying a location where entities may be present (e.g., have historically been present, have been reported as being present by other systems, have been detected by the computing system during a prior time period, etc.). For example, the computing system may determine light to be output based on determining the environment includes an intersection (e.g., to provide a warning to a human potentially at the intersection). Further, the computing system may determine the output based on detecting an entity (e.g., a human) in the environment using the data (e.g., to alert the entity).

As discussed above, the alert may be indicative of the data (e.g., sensor data associated with the robot). For example, the alert may include an indication of a path of the robot, a direction of the robot, an action of the robot, an orientation of the robot, a map of the robot, a route waypoint associated with the robot, a route edge associated with the robot, a zone of the robot (e.g., an area of the environment in which one or more of an arm, a leg, or a body of the robot may operate), a state of the robot, or one or more parameters of a component of the robot (e.g., a status of a component of the robot). For example, the alert may include an indication of battery information (e.g., a battery health status) of a battery of the robot. In some cases, the alert may be indicative of an action to be performed by the robot (e.g., a traversal of the environment action). For example, the computing system may identify an action based on the data (e.g., the data indicating a request to perform the action), may instruct movement of the robot according to the action, and may determine an alert indicative of the action (and the movement).

In another example, the alert may be indicative of data associated with an obstacle, entity, object, or structure in the environment of the robot. For example, the alert may be indicative of a zone around an obstacle, entity, object, or structure in which the robot avoids.

In some cases, the computing system can determine the alert based on the light to be output and one or more shadows caused by one or more legs of the robot. For example, the computing system can determine that outputting the light (by a light source of the robot) at the one or more legs of the robot may cause one or more shadows (e.g., dynamic shadows) to be output on the surface. Further, the light sources may be positioned on a bottom of the body inwardly of the legs of the robot such that the one or more light sources positioned and configured to project light downwardly and outwardly beyond a footprint of the legs. Such a projection of the light may illuminate the inner surfaces of the legs. Further, such a projection of the light may cause projection of one or more dynamic shadows associated with the legs on a surface of an environment of the robot. The computing system can identify particular light to be output such that the one or more shadows are indicative of the alert. To identify the particular light to be output, the computing system can identify how the one or more legs may move over time (e.g., as the robot traverses the environment) and may determine how to output light at the one or more legs such that the one or more shadows are output on the environment.

All or a portion of the plurality of alerts may be associated with one or more base lighting parameters. For example, all or a portion of the plurality of alerts may be associated with an intensity, color, direction, pattern, etc. In some cases, the computing system may adjust the alert (e.g., one or more base lighting parameters of the alert) based on the data. For example, the computing system can identify a battery health status based on data, determine a battery health status alert, and adjust one or more base lighting parameters of the battery health status alert based on data indicating that a body of the robot is tilted and an entity is located in the environment. In some cases, the computing system may not adjust the alert (e.g., one or more base lighting parameters of the alert) based on the data. Instead, the computing system can adjust how a manner of displaying the determined alert (e.g., light indicative of the determined alert). For example, the computing system can identify an alert based on the data, identify light indicative of the alert, and adjust one or more lighting parameters of the light based on data indicating that a body of the robot is tilted and an entity is located in the environment. In some cases, the computing system may not adjust the alert (e.g., one or more base lighting parameters of the alert) based on the data and, instead, the computing system can determine an alert based on particular parameters. For example, the computing system can identify one or more lighting parameters of light based on data indicating that a body of the robot is tilted and an entity is located in the environment, identify an alert associated with (e.g., having the one or more lighting parameters), and identify light indicative of the alert.

In some cases, the computing system may determine the one or more lighting parameters for the light based on the data. The computing system may determine an orientation, tilt, position, pose, etc. of the robot (e.g., of a body of the robot) relative (e.g., with respect to) the environment) based on the data. In some cases, the computing system may determine the orientation, tilt, position, pose, etc. of the robot by predicting a future orientation, tilt, position, pose, etc. of the robot based on performance of a roll over action, a lean action, a climb action, etc. by the robot, a map associated with the robot, or a feature within the environment of the robot.

The computing system can determine the one or more lighting parameters based on the determined orientation, tilt, position, pose, etc. Further, the computing system can determine the one or more lighting parameters based on the determined orientation, tilt, position, pose, etc. and a determined location of an entity in the environment to avoid impairing an entity. For example, based on the data indicating that the body of the robot is tilted (e.g., is not level), the computing system can adjust the brightness or intensity of the light to avoid impairing an entity within the environment (e.g., the computing system can decrease the intensity of the light based on determining that the body of the robot is tilted). In another example, based on the data indicating that the body of the robot is not tilted (e.g., is level), the computing system can maintain the brightness or intensity of the light such that the brightness or intensity of the light is less if the body of the robot is tilted as compared to if the body of the robot is not tilted.

Further, the computing system may determine whether the orientation, tilt, position, pose, etc. of the robot matches, exceeds, is predicted to match, is predicted to exceed, etc. a threshold orientation, tilt, position, pose, etc. of the robot. If the computing system determines the orientation, tilt, position, pose, etc. of the robot matches, exceeds, is predicted to match, is predicted to exceed, etc. the threshold orientation, tilt, position, pose, etc. of the robot, the computing system may adjust the one or more lighting parameters (e.g., decrease the intensity of the light such that the intensity of the light is less than 80 lumens) and/or validate that the one or more lighting parameters are below a particular level (e.g., the intensity of the light is less than 80 lumens).

In some cases, the adjustment of the one or more lighting parameters may be an adjustment of the intensity (e.g., to less than 80 lumens) according to a threshold (e.g., a dim threshold, an intensity threshold, a light threshold, a threshold dim, a threshold intensity, a threshold light, etc.). For example, the threshold may be a dynamic dim threshold or a variable dim threshold. The computing system may determine (e.g., define) a threshold intensity level (e.g., 80 lumens, 200 lumens, etc.) based on environmental data (e.g., environmental light data indicating ambient light), a lux on a surface of the environment, a lux at one or more light sources, a distance associated with the robot (e.g., a distance between the one or more light sources and the surface and/or a distance between the one or more light sources and an entity in the environment), etc. For example, the computing system may determine an 80 lumens threshold intensity level based on environmental data indicating a dark environment and a distance of 5 meters between the one or more light sources and the entity in the environment. In another example, the computing system may determine a 160 lumens threshold intensity level based on environmental data indicating a lit environment and a distance of 10 meters between the one or more light sources and the entity in the environment.

If the computing system determines the orientation, tilt, position, pose, etc. of the robot does not match, exceed, is not predicted to match, is not predicted to exceed, etc. the threshold orientation, tilt, position, pose, etc. of the robot, the computing system may adjust the one or more lighting parameters such that the light is a high intensity of light (e.g., the intensity of the light exceeds 80 lumens, 200 lumens, etc.) and/or validate that the one or more lighting parameters exceed a particular level (e.g., the intensity of the light exceeds 80 lumens, 200 lumens, etc.). For example, the computing system may adjust the one or more lighting parameters such that the light may have lighting parameters exceeding the threshold (e.g., may have an intensity over 200 lumens).

In some cases, the computing system can determine different lighting parameters for different light sources based on the determined orientation, tilt, position, pose, etc. For example, based on the determined orientation, tilt, position, pose, etc., the computing system may determine that a first light source is directed to an entity (e.g., exposed to the entity) and a second light source is not directed to the entity. Based on determining that the first light source is directed to the entity and the second light source is not directed to the entity, the computing system may adjust a lighting parameter of light provided by the first light source (e.g., to decrease an intensity of the light) and may not adjust a lighting parameter of light provided by the second light source.

In some cases, the computing system can determine light to be output by a light source that is separate and distinct from the robot (e.g., a light source of another robot, a light source associated with an obstacle, etc.). For example, the computing system can determine light to be output by a light source located within the environment.

At block 2606, the computing system instructs projection of light on a surface of an environment of the robot. The computing system can instruct projection of the light using the one or more light sources of the robot. Based on the computing system instructing projection of the light, the one or more light sources may output the light on the surface.

In some cases, the computing system may instruct movement of the robot according to an action (e.g., a movement action) in response to instructing the projection of light on the surface. For example, the light may be indicative of the path of the robot and the computing system may instruct movement of the robot along the path in response to instructing the projection of light indicative of the path.

The computing system can instruct projection of the light according to the identified one or more lighting parameters. For example, the computing system can determine a brightness of light to be output by the one or more light sources based on the data and can instruct projection of the light according to the determined brightness. In some cases, the determined brightness may be greater (e.g., higher) than a minimum brightness associated with the one or more light sources.

The surface of the environment may include a ground surface (a support surface for the robot), a wall, a ceiling, a surface of a structure, object, entity, or obstacle within the environment. For example, the surface of the environment may include a stair, a set of stairs (e.g., a staircase), etc. In some cases, the computing system can identify a surface on which to output light and the computing system can orient a body of the robot (and the one or more light sources) such that the light is output on the surface. For example, the computing system can turn the body of the robot such that the light is output on a wall of the environment or a ceiling of the environment. In such embodiments, the robot may first ensure that any light sensitive entities are not between the robot and the wall or ceiling such that projecting light on the wall or ceiling will not blind a light sensitive entity, e.g., a person in the environment.

In some cases, in instructing projection of light on the surface of the environment, the computing system may determine image data to be displayed and instruct display of image data on the surface. For example, the image data may include an image (e.g., a modifiable image) of a component of the robot (e.g., a battery), an entity, obstacle, object, or structure in the environment, etc. The computing system may determine the image data and instruct the display of the image data according to the one or more lighting parameters. For example, the computing system can determine the image data based on the one or more lighting parameters and instruct display of the image data according to the one or more lighting parameters. Further, the image data may include an image indicating a status of a component of the robot, an entity, obstacle, object, or structure in the environment. For example, the image data may include an image indicating a battery health status for a battery of the robot.

The computing system may instruct projection of the light based on detecting an entity (e.g., a moving entity, a human, etc.) in the environment of the robot. For example, the computing system may instruct a display of image data indicating a message (e.g., a welcome message) based on detecting the entity. Further, the image data may include visual text (e.g., “Hi”). In some cases, the computing system may obtain environmental association data linking the environment to one or more entities. For example, the environmental association data may indicate that the environment has previously been associated with an entity (e.g., a human), has been associated with an entity for a particular quantity of sensor data (e.g., over 50% of the sensor data is associated with an entity), etc.

As discussed above, in some cases, the output may be or may include an audio output (e.g., an audible alert, an output indicative of an audible alert, etc.). In some cases, a user computing device may provide an input to the computing system identifying the audio output (e.g., a message, a warning, etc.). For example, the audio output may include audio data provided by the user computing device. The computing system may identify the audio data for the audio output, identify the audio output, and instruct output of the audio output via an audio source (e.g., a resonator) of the robot. For example, the computing system may instruct output of the output using a resonator and the resonator may resonate and output the audible alert based on the resonation.

All or a portion of a plurality of audio outputs may be associated with a particular audio source (e.g., a resonator or a speaker) of the robot. The computing system may determine that the audio output is associated with an audio source and instruct output of the audio via the audio source. The plurality of audio sources may be associated with different environment audio levels based on an audio level (e.g., a sound level) of the audio source. In some cases, the computing system may obtain the data and determine an audio level associated with the environment of the robot. The computing system may determine whether the audio level matches or exceeds a threshold audio level (e.g., 85 decibels) based on the data. Based on determining the audio level matches or exceeds the threshold audio level, the computing system may determine audio to be output, determine to output the audio via a speaker of the robot, and instruct output of the light using the speaker. Based on determining the audio level matches or is less than the threshold audio level, the computing system may determine audio to be output, determine to output the audio via a resonator of the robot, and instruct output of the light using the resonator.

In some cases, the computing system may identify an alert and may identify light to be output that is indicative of the alert and audio to be output that is indicative of the alert. The computing system may instruct projection of the light using the one or more light sources and output of the audio using the audio source. In some cases, the computing system may instruct projection of the light using the one or more light sources and output of the audio using the audio source based on identifying that an output indicative of the alert corresponds to a combination of the light to be output and the audio to be output.

In some cases, the computing system may obtain the data and determine an audio level associated with the environment of the robot. The computing system may determine whether the audio level matches or exceeds a threshold audio level (e.g., 85 decibels) based on the data. Based on determining the audio level matches or exceeds the threshold audio level, the computing system may determine light to be output, may not determine audio to be output, and may instruct output of the light. Based on determining the audio level matches or is less than the threshold audio level, the computing system may determine audio to be output, may not determine light to be output, and may instruct output of the audio.

In some cases, the computing system may obtain the data and determine image data associated with the environment of the robot. For example, the computing system may determine whether the view of an entity in the environment is obstructed, whether a light level in the environment matches or exceeds a threshold light level, etc. based on the data. Based on determining the view of the entity is obstructed, the computing system may determine audio to be output and may instruct output of the audio. Based on determining the light level matches or exceeds the threshold light level, the computing system may determine audio to be output, may not determine light to be output, and may instruct output of the audio. Based on determining the light level matches or is less than the threshold light level, the computing system may determine light to be output, may not determine audio to be output, and may instruct output of the light.

The computing system may instruct projection of the light (e.g., a visual alert, an output indicative of a visual alert, etc.) and/or output of the audio according to a light or audio pattern (e.g., a visual pattern or a temporal pattern). The pattern may be based on the data and may be indicative of an alert (e.g., the pattern may represent a path of the robot). For example, the computing system may instruct simultaneous display of light using a plurality of light sources of the robot and/or may instruct iterative display of light using a plurality of light sources (e.g., a first portion of the light may correspond to a first light source and a second portion of the light may correspond to a second light source). In another example, the computing system may instruct simultaneous display of audio using a plurality of audio sources of the robot and/or may instruct iterative display of audio using a plurality of audio sources (e.g., a first portion of the audio may correspond to a first audio source and a second portion of the audio may correspond to a second audio source). In some cases, the pattern may be a modifiable pattern. For example, the computing system may adjust (e.g., dynamically) the pattern.

As discussed above, a robot may include one or more light sources and may provide an output using the one or more light sources. The output may be indicative of a zone of potential movement by the robot, a zone of a potential event (e.g., a hazard, an incident, etc.). For example, the output may be indicative of a zone where the robot and/or an appendage of the robot (e.g., an arm) may move (e.g., with a particular velocity, timing, etc.) such that the robot and/or the appendage may move into and/or in the zone before an entity can move out of the zone and/or identify the robot and/or the appendage. In another example, the output may be indicative of a planned movement of the robot (e.g., indicative of a zone into which the robot plans to move based on a route). In another example, the output may be indicative of a likelihood of occurrence of the potential event or movement, an effect (e.g., a severity, a zone, etc.) of the potential event or movement, etc. In some cases, the event or movement may be or may be based on unintended movement of the robot (e.g., a fall, contact with an entity, a trip, a slip, a stumble, etc.).

The computing system may determine the likelihood of the occurrence of the event or movement and/or the effect of the occurrence of the event or movement based on an environmental condition (e.g., an environment including a slippery ground surface, an environment including less than a threshold number of features, etc.), a status and/or condition of the robot (e.g., an error status, a network connectivity status, a condition of a leg of the robot), objects, structures, obstacles, or entities within the environment, an action or task to be performed by the robot and/or other robots within the environment (e.g., running, climbing, etc.), an object, structure, entity, or obstacle associated with the action or task (e.g., an irregular shaped box, a damaged box that is in danger of falling apart, etc.), etc. For example, the likelihood of the occurrence of the event or movement and/or the effect of the occurrence of the event or movement may be uniform for a standing robot and may be non-uniform for a running or jumping robot. In another example, the likelihood of the occurrence of the event or movement and/or the effect of the occurrence of the event or movement may be associated with a smaller zone for a standing robot as compared to a zone for a running or jumping robot due to increased kinetic energy and/or sensitivity to balance.

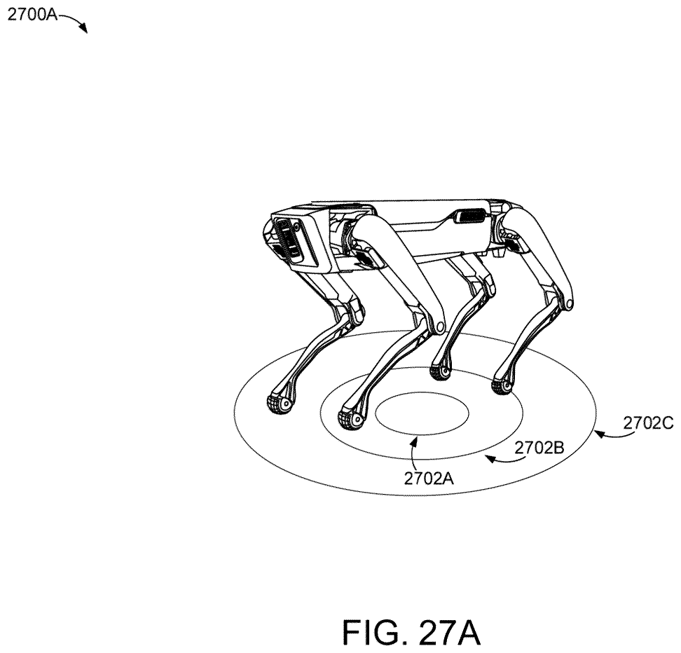

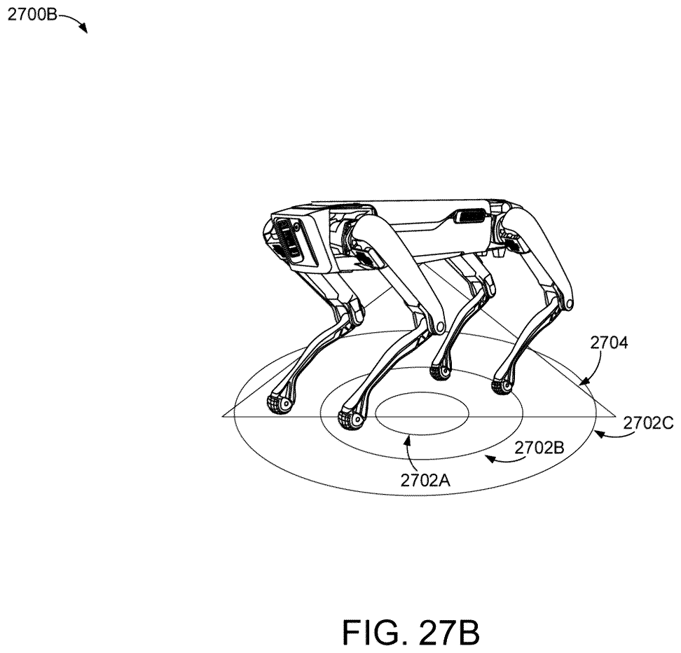

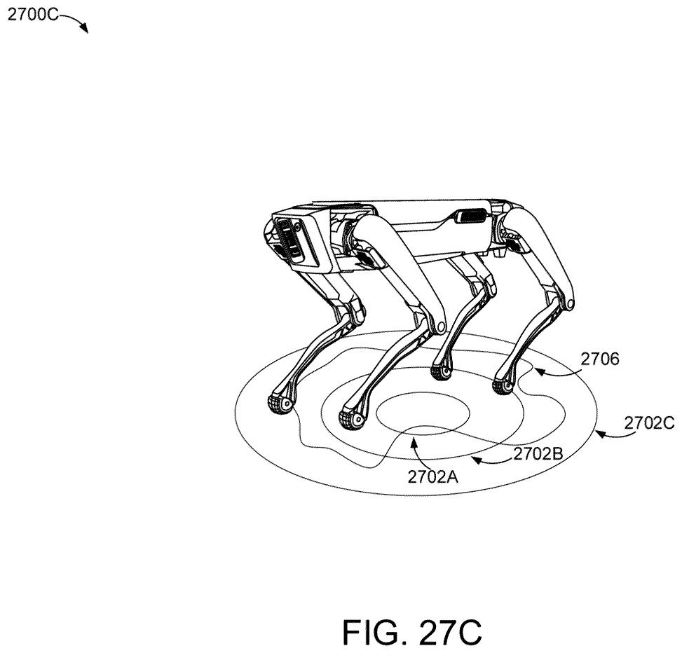

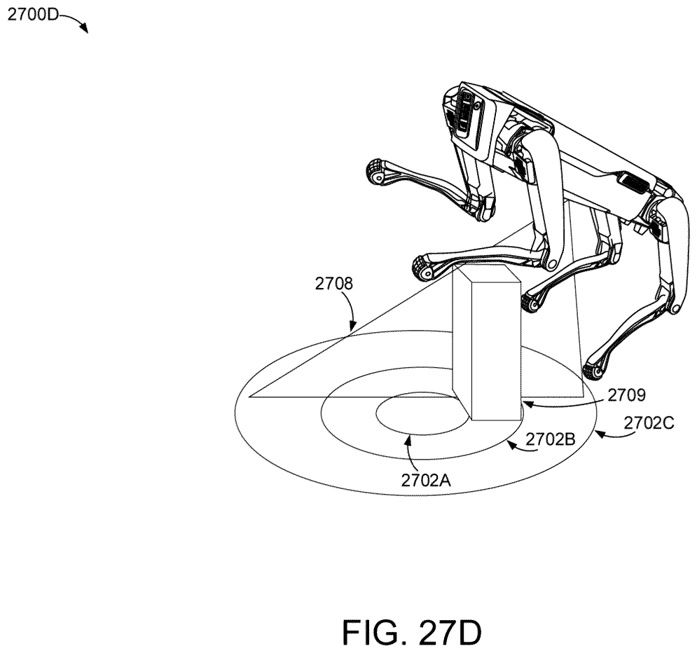

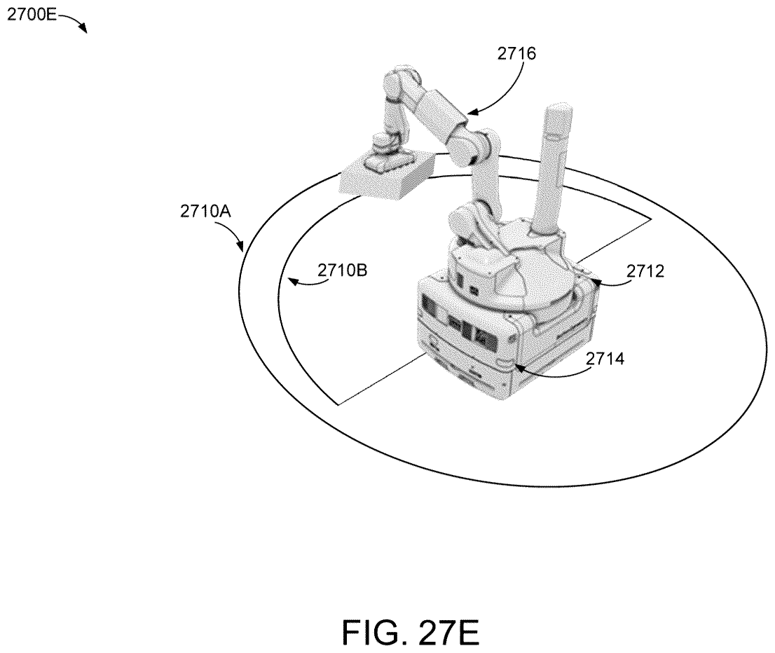

FIG. 27A depicts a view 2700A of a robot navigating within an environment. The robot may include and/or may be similar to the robot 1700 discussed above with reference to FIG. 17. The robot includes a body, one or more legs or other appendage coupled to the body.

One or more light sources (located on the robot, within the environment of the robot, etc.) may produce an output by projecting image data onto a surface of the environment. In the illustrated example of FIG. 27A, the output (e.g., the image data projected on the surface of the environment) includes three zones (a first zone 2702A, a second zone 2702B, and a third zone 2702C). Each of the three zones may be associated with a respective likelihood of occurrence of an event or movement (e.g., a likelihood of the robot experiencing a fall), an effect of the potential event or movement (e.g., an area in the environment in which the event or movement (if it occurs) is predicted to occur), a likelihood of an effect (e.g., impact) on an entity, obstacle, structure, or object if the event or movement occurs and the entity, obstacle, structure, or object is located in the zone.

In some cases, all or a portion of the first zone 2702A, the second zone 2702B, and the third zone 2702C may be based on (e.g., have) a respective manner of output (e.g., a direction, frequency, pattern, color, brightness, intensity, illuminance, luminance, luminous flux, etc. of the light). For example, the color of the light for a respective zone may indicate a likelihood of occurrence of an event within the respective zone (e.g., green light may indicate a low likelihood such as 5%, red light may indicate a high likelihood such as 75%, etc.). In another example, the flash frequency or light intensity may indicate a likelihood of occurrence of an event within the respective zone (e.g., flashing light may indicate a greater than 50% likelihood, non-flashing light may indicate a less than 50% likelihood, etc.). In some cases, the system may identify data linking a respective manner of output (e.g., a direction, frequency, pattern, color, brightness, intensity, illuminance, luminance, luminous flux, etc. of the light) to a respective likelihood, a respective effect, etc. In some cases, the data may be dynamic (e.g., the system may obtain updates and may update the data based on the updates). In some cases, the system may provide a user interface to a user computing device and may receive an input defining the data via the user interface (e.g., the user may provide the data).

FIG. 27B depicts a view 2700B of a robot navigating within an environment. The robot may include and/or may be similar to the robot discussed above with reference to FIG. 27A. Similar to FIG. 20A, the robot includes at least one light source that is a projector capable of producing an output by projecting an image onto a surface, and electronics capable of altering the image to be projected. The robot may include a light source that produces light 2704. The robot may produce the output using the light 2704 (the first zone 2702A, the second zone 2702B, and the third zone 2702C).

FIG. 27C depicts a view 2700C of a robot navigating within an environment. The robot may include and/or may be similar to the robot discussed above with reference to FIG. 27A. As discussed above, the robot includes at least one light source that is a projector capable of producing an output by projecting that includes one or more zones. The one or more zones may correspond to one or more shapes (e.g., rectangles, squares, ovals, circles, triangles, freeform shapes, etc.). In the example of FIG. 27C, the output includes a first zone 2702A, a second zone 2702B, and a third zone 2702C that each correspond to a circle or oval (a regular geometric shape) and a fourth zone 2706 that corresponds to a freeform shape. A system may use zones corresponding to freeform shapes (e.g., a chalk outline) to identify particular characteristics. For example, the freeform shapes may indicate an outline of a zone effected by a previous (e.g., historical) fall of the robot (e.g., where the robot fell). In some cases, the freeform shapes may indicate zones with higher levels of granularity while non-freeform shapes may indicates zones with lower levels of granularity. In some cases, the freeform shapes may indicate a zone associated with an appendage (e.g., a reach of the appendage). For example, the freeform shapes may indicate a potential reach of the appendage, a predicted movement of the appendage to perform a task, a historical movement of the appendage to perform the same or a similar task. It will be understood that the output may include more, less, or different zones.

FIG. 27D depicts a view 2700D of a robot navigating within an environment that includes an obstacle 2709. The robot may include and/or may be similar to the robot discussed above with reference to FIG. 27A. As discussed above, the robot may include a light source that produces light 2708. The robot may produce the output using the light 2708 (the first zone 2702A, the second zone 2702B, and the third zone 2702C) as the robot performs an action such that the output is indicative of the action being performed. In the example of FIG. 27D, the robot is climbing the obstacle 2709 and the output indicates a respective likelihood of a fall and/or a respective effect of the fall for each of the first zone 2702A, the second zone 2702B, and the third zone 2702C.

FIG. 27E depicts a view 2700E of a robot navigating within an environment. In the example of FIG. 27E, the robot includes an arm 2716, a base 2712, and one or more light sources. The robot may be a stationary robot, a partially stationary robot (e.g., the arm 2716 of the robot may move, but the base 2712 may not move), or a mobile robot (e.g., a legged robot, a wheeled robot, etc.). For example, the robot may be a legged robot including one or more legs or a wheeled robot including one or more wheels (e.g., the one or more legs and/or one or more wheels may be located underneath the base 2712). While reference may be made to a robot that includes one or more legs herein, it will be understood that the robot may include one or more wheels in addition to or instead of one or more legs.

As discussed herein, the robot may include one or more light sources that produce light. In the example of FIG. 27E, the robot may include a base 2712 (e.g., a lower portion of the robot closer to the ground surface). The one or more light sources may be located on the robot. In the example of FIG. 27E, the one or more light sources are located on the base 2712, however, it will be understood that the one or more light sources may be located on the arm 2716, on a gripper on the arm 2716, on a body portion (e.g., a torso portion, a tower portion, etc.) of the robot connected to the base 2712, or elsewhere on the robot. A first light source 2714 may be located on a first corner of the base 2712. It will be understood that the robot may include more, less, or different light sources. For example, one or more light sources may be located on all or a portion of the corners of the base 2712, one or more light sources may be located on a side, top, or bottom of the base 2712, one or more light sources may be located on the arm 2716, etc.

The robot may produce an output (the first zone 2710A and the second zone 2710B) using the one or more light sources. In the example of FIG. 27E, the output indicates a respective likelihood of the arm 2716 contacting an entity, obstacle, object, or structure and/or a respective effect of such contact for each of the first zone 2710A and the second zone 2710B as the robot performs a task (e.g., maneuvers a box using the arm 2716). As discussed herein, a system may determine the likelihood of the arm 2716 contacting an entity, obstacle, object, or structure and/or a respective effect of such contact based on the task or action to be performed by the robot (e.g., moving a box from a first location to a second location), an object, structure, entity, or obstacle associated with task or action (e.g., whether performance of the task is obstructed by an obstacle, whether the action includes moving an item that the system determines is damaged based on image data, whether the action includes moving an item that when carried by the robot extends beyond a gripper of the robot, etc.), environmental conditions (e.g., whether the environment for performance of the task or action is slippery or icy), etc.

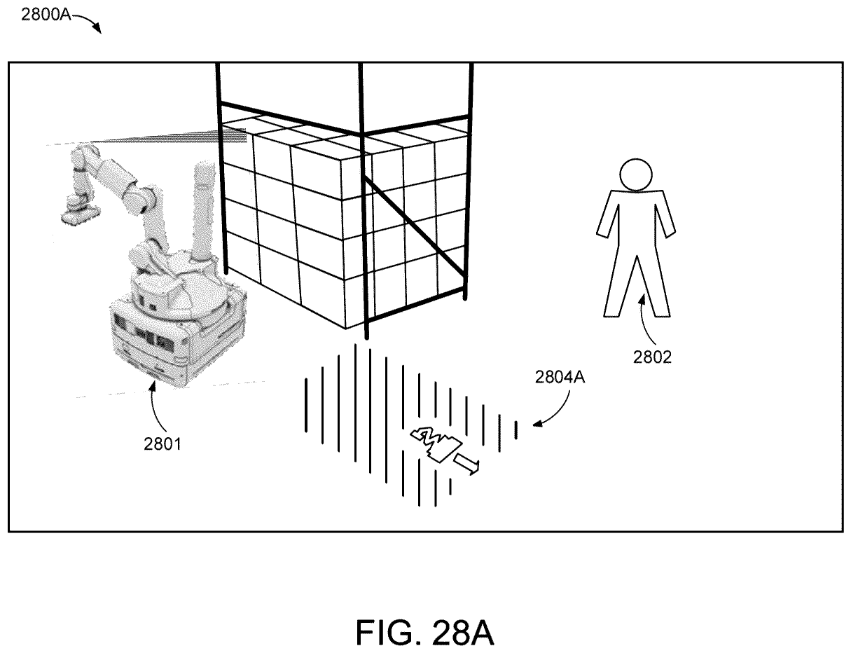

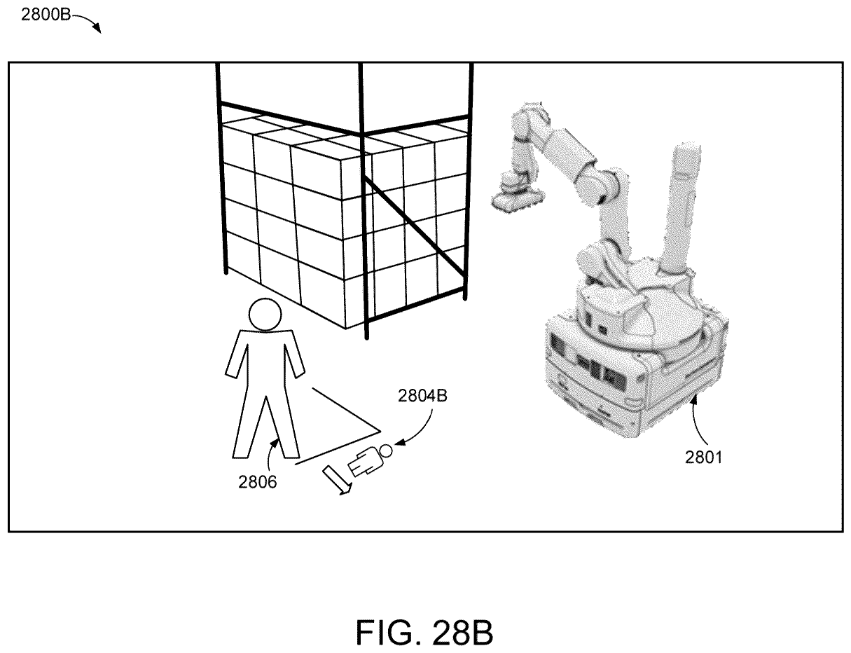

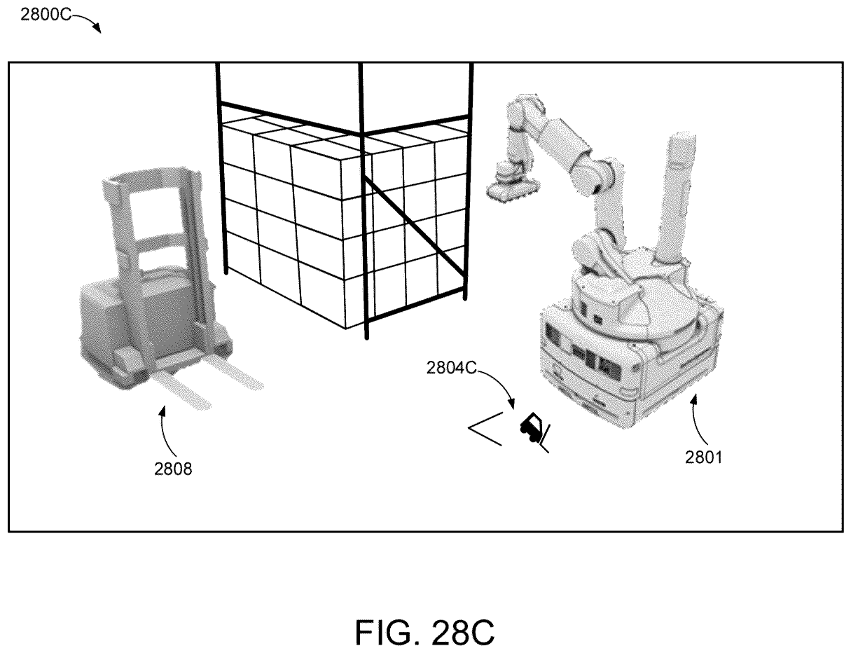

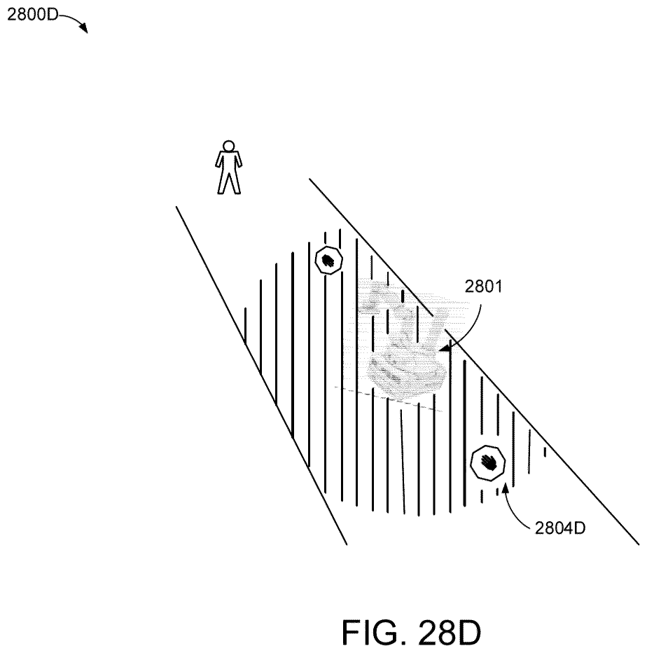

FIG. 28A depicts a view 2800A of a robot 2801 navigating within an environment. The illustrated environment is a warehouse including rows of shelving that create blind spots for workers and robots. The robot 2801 may include and/or may be similar to the robot discussed with reference to FIG. 27E. The robot 2801 includes a base, an arm coupled to the base, one or more wheels coupled to the base for mobility, and a plurality of light sources. In particular, the robot 2801 includes a projector light source as discussed with respect to FIGS. 20A-20D that can project light with sufficient intensity to create visible patterns on the floor. The illustrated embodiment is capable of projecting recognizable images on the floor as described hereinabove.

A system of the robot 2801 may obtain data associated with the robot 2801 (e.g., sensor data). Based on the data associated with the robot, the system can obtain route data for the robot 2801 indicative of a route of the robot 2801 and can identify and classify a feature within the environment as corresponding to an entity, obstacle, object, or structure. As discussed herein, based on the identification and classification of the feature and the route data, the system can identify an alert (e.g., indicative of the route data) and identify how to emit light indicative of the alert.

In the example of FIG. 28A, the system identifies a route of the robot 2801 through the environment based on the data associated with the robot 2801. In some cases, the system may determine that the route and/or the environment is associated with (e.g., includes) a danger zone (e.g., a corner, a blind corner, etc.) and may output light to indicate that the robot 2801 is approaching the danger zone such that an entity approaching the robot 2801 via the danger zone is notified of the presence of the robot 2801. The danger zone may be any zone for approaching the robot 2801 in which the entity approaching via the zone may not be able to see the robot 2801. In some cases, the system may output light to indicate that the robot 2801 is approaching while the robot 2801 is navigating the environment (e.g., regardless of whether the robot 2801 is approaching a danger zone).

Based on identifying the route, the system may identify an alert that is indicative of the route. Based on the alert, the system can instruct the plurality of light sources to output light 2804A. In the example of FIG. 28A, the system may determine that the route of the robot 2801 causes the robot 2801 to approach a danger zone (e.g., a blind corner). Based on determining that the route of the robot 2801 causes the robot 2801 to approach a danger zone, the system may identify a portion of the environment that an entity approaching via the danger zone is predicted to be able to see and may output light 2804A indicative of the robot 2801 and/or the route of the robot 2801 on the portion of the environment.

FIG. 28B depicts a view 2800B of the robot 2801 of FIG. 28A after further traversal of the environment. As discussed herein, the system may identify a route of the robot 2801 and a feature 2806 within the environment of the robot 2801. The system may identify an alert that is indicative of the route and the obstacles, structures, entities, or objects corresponding to the features. Based on the alert, the system can instruct the plurality of light sources to output light 2804B indicative of the alert. Specifically, the system can instruct the plurality of light sources to output a particular pattern of light that represents the route (e.g., route waypoints and/or route edges of the route) and the obstacles, structures, entities, or objects corresponding to the features. Specifically, the pattern of light may be indicative of zones around the obstacles, structures, entities, or objects that the robot 2801 is to avoid.

In the example of FIG. 28B, the light 2804B indicates a buffer zone around an entity (e.g., a human) corresponding to the feature 2806, a route of the entity, and an indicator of the entity. The projection of the light 2804B thus indicates to the identified entity that the robot recognizes the entity's presence and plans to avoid interfering with the entity's path, such that the entity feels safe.

FIG. 28C depicts a view 2800C of the robot 2801 of FIG. 28A after further traversal of the environment. As discussed herein, the system may identify a route of the robot 2801 and a feature 2808 (e.g., a forklift) within the environment of the robot 2801. The system may identify an alert and may instruct the plurality of light sources to output light 2804C indicative of the alert. Specifically, the system can instruct the plurality of light sources to output a particular pattern of light that represents the route and the obstacles, structures, entities, or objects corresponding to the features. Specifically, the pattern of light may be indicative of zones around the robot that should be avoided.

In the example of FIG. 28C, the light 2804C indicates a buffer zone around the robot 2801 and an indicator of an obstacle corresponding to the feature 2808. Thus, the feature 2808, whether another robot, a human, or a human operated vehicle, can be secure if it avoids the buffer indicated by the projected light 2804C. The entity itself, or any bystanding entities, can also feel secure in the knowledge that the robot 2801 has recognized potentially moving entities in its environment and will plan its own movements accordingly.

FIG. 28D depicts a view 2800D of the robot 2801 of FIG. 28A after further traversal of the environment. As discussed herein, the system may identify a zone of the environment (e.g., to be avoided by an entity) that the robot 2801 is operating within (e.g., maneuvering within) to perform a task (e.g., is predicted to operate within to perform the task). The system may identify an alert and may instruct the plurality of light sources to output light 2804D indicative of the alert. Specifically, the system can instruct the plurality of light sources to output a particular pattern of light that represents the zone.

In the example of FIG. 28D, the light 2804D indicates the zone around the robot 2801 and warnings to avoid the zone.

In some cases, the one or more light sources may be located on (e.g., affixed to, recessed within, etc.) the robot and/or may be located within an environment of the robot (e.g., may be affixed to a stand, a pole, a wall, etc. that is physically separate from the robot). For example, the one or more light sources may be located within the environment and may not be located on the robot. The one or more light sources may communicate with the robot (e.g., via a network communication protocol). For example, the one or more light sources may be internet of things devices (or may be included within internet of things devices) and may transmit data over a network (e.g., via Bluetooth, WiFi, etc.). In some cases, the one or more light sources may communicate directly with other light sources, audio sources, the robot, etc. and/or may communicate with an intermediate system and/or central sever (e.g., for warehouse robot fleet management) that may communicate with all or a portion of the light sources, audio sources, the robot, etc. A computing system of the robot and/or the intermediate system (and/or central server) may communicate with the one or more light sources and cause the one or more light sources to output light according to particular lighting parameters.

In some cases, the one or more audio sources (as discussed herein) may be located on (e.g., affixed to, etc.) the robot and/or may be located within an environment of the robot (e.g., may be affixed to a stand, a pole, a wall, etc. that is physically separate from the robot). For example, the one or more audio sources may be located within the environment and may not be located on the robot. The one or more audio sources may communicate with the robot (e.g., the one or more audio sources may be internet of things devices (or may be included within internet of things devices) and may transmit data over a network). In some cases, the one or more audio sources may communicate directly with other light sources, audio sources, the robot, etc. and/or may communicate with the intermediate system and/or central sever that may communicate with all or a portion of the light sources, audio sources, the robot, etc. A computing system of the robot and/or the intermediate system (and/or central server) may communicate with the one or more audio sources and cause the one or more audio sources to output audio according to particular audio parameters.

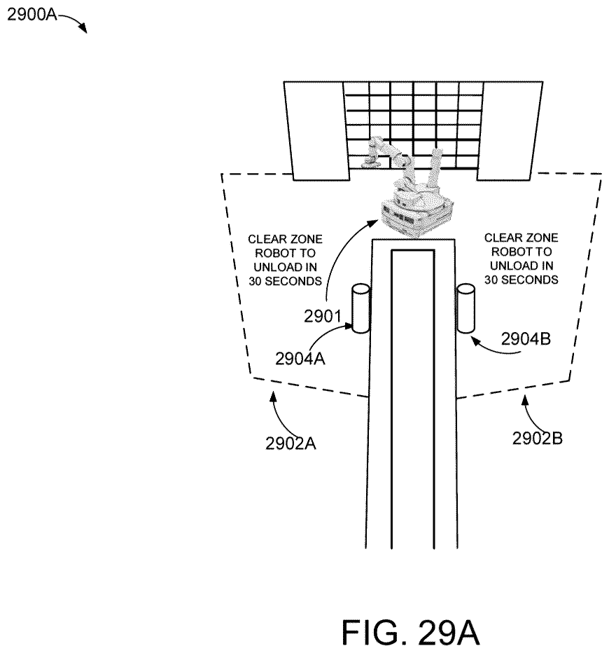

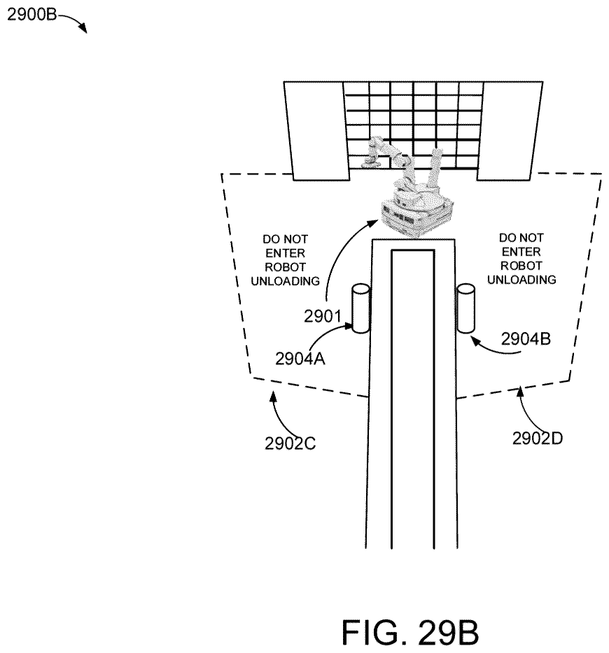

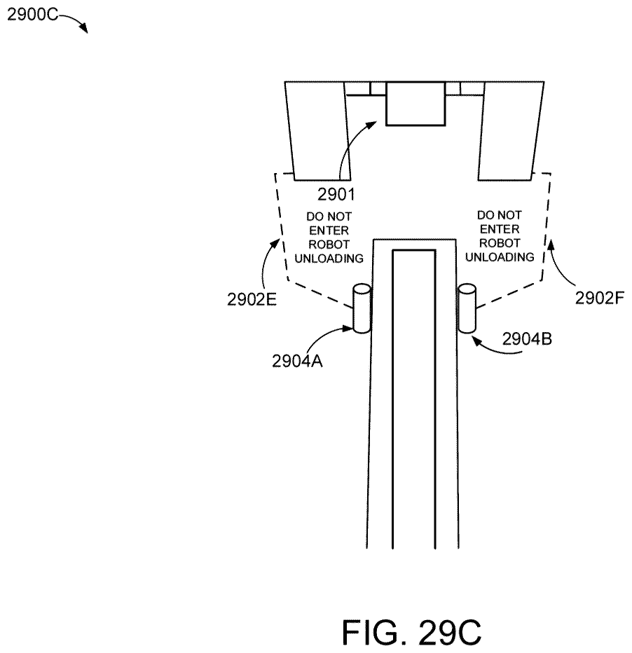

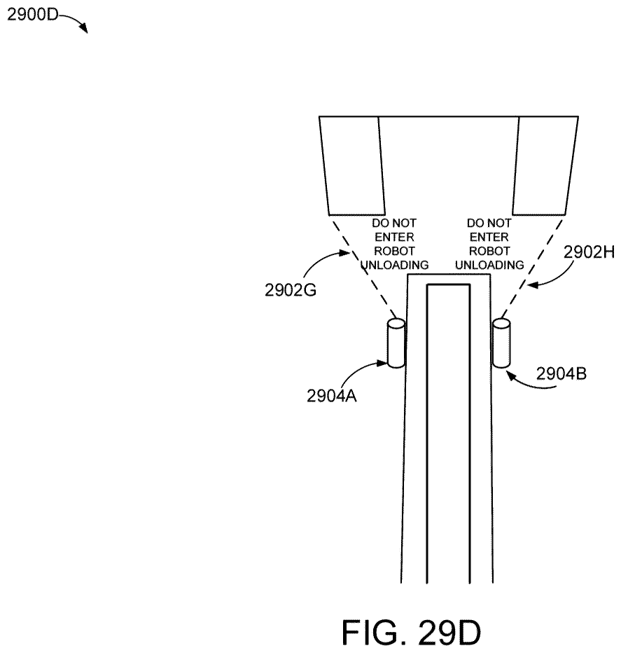

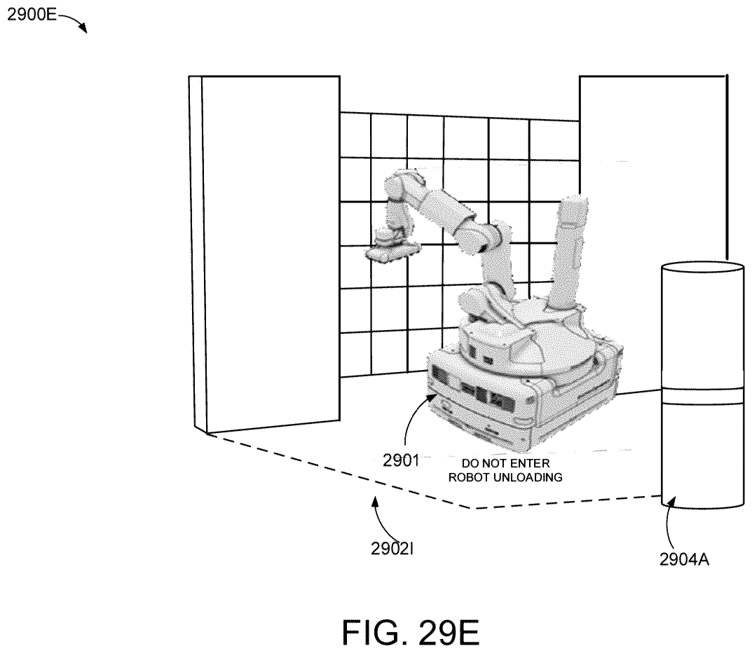

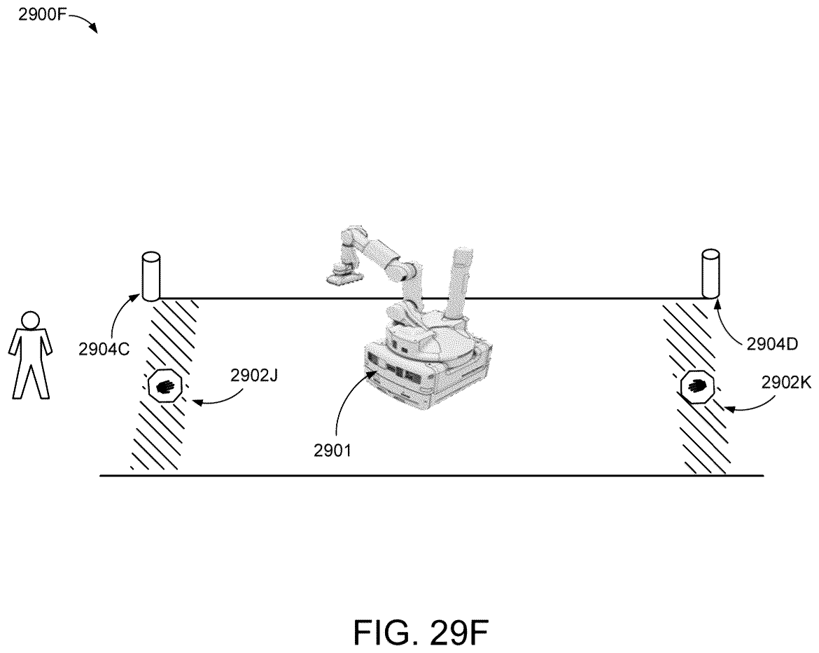

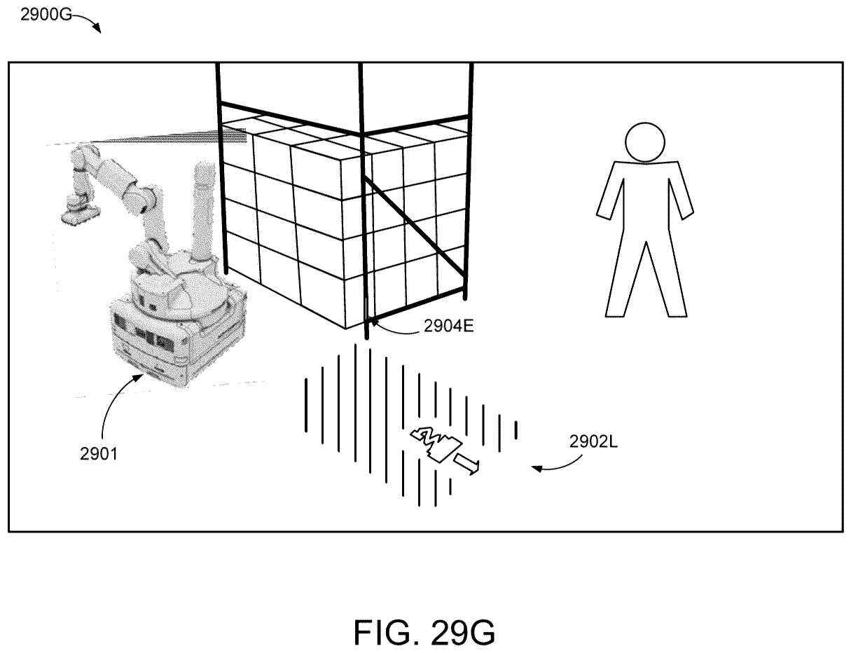

FIG. 29A depicts a view 2900A of a robot 2901 navigating within an environment that includes light sources separate from the robot 2901. The robot 2901 may include and/or may be similar to the robot discussed with reference to FIG. 27E. The robot 2901 includes a base, an arm coupled to the base, and one or more wheels coupled to the base. The environment includes a first light source 2904A and a second light source 2904B. The first light source 2904A and/or the second light source 2904B may be integrated within equipment (e.g., a conveyor belt), a structure (e.g., a pole, a frame, etc.), etc. In the illustrated embodiment, the light sources 2904A, 2904B are on opposite sides of a load/unload platform, such as one including a conveyor belt.

A system of the robot 2901 may obtain data associated with the robot 2901 (e.g., sensor data). Based on the data associated with the robot, the system can obtain motion data for the robot 2901 indicative of motion of the robot 2901. For example, the motion data may indicate a motion of the robot 2901 (e.g., of an arm of the robot 2901) to perform a task, a route of the robot 2901, an area designated for (e.g., set aside for) motion of the robot 2901 for performance of the task, etc. As discussed herein, based on the motion data, the system can identify an alert (e.g., indicative of the motion data) and identify how to emit light indicative of the alert.

In the example of FIG. 29A, the system identifies motion of the robot 2901 (e.g., motion of an arm of the robot 2901) through the environment based on the data associated with the robot 2901. For example, the motion may be based on performance of a task (e.g., loading of a container) by the robot 2901.

Based on identifying the motion, the system may identify an alert that is indicative of the motion. Based on the alert, the system can instruct the first light source 2904A to output light 2902A and the second light source 2904B to output light 2902B indicative of the alert. Specifically, the system can instruct the first light source 2904A and the second light source 2904B to output a particular pattern of light that represents a zone around the robot 2901 to be avoided and indicates a timing associated with the task (e.g., a time remaining in performance of the task, a time remaining before initiation of performance of the task).

In the example of FIG. 29A, the light 2902A and the light 2902B indicate the zone around the robot 2901 and warnings to avoid the zone. The warnings may include text indicating to clear the zone and a time before the robot 2901 initiates the task. In the illustrated example, the text states “CLEAR ZONE ROBOT TO UNLOAD IN 30 SECONDS” and the numeric indicator of seconds will count down from 30 seconds. The system may correlate the light 2902A and the light 2902B and performance of the task by the robot 2901 such that when the light 2902A and the light 2902B reads “0 SECONDS,” the system instructs the robot 2901 to initiate performance of the task.

FIG. 29B depicts a view 2900B of the robot 2901 of FIG. 29A after the robot has progressed to actually unloading. As discussed herein, the system continues to identify a zone of the environment (e.g., to be avoided by an entity) that the robot 2901 is operating within (e.g., maneuvering within) to perform a task (e.g., is predicted to operate within to perform the task). The system may identify an alert and may instruct the first light source 2904A and the second light source 2904B to output light 2902C and light 2902D indicative of the alert. Specifically, the system can instruct the plurality of light sources to output a particular pattern of light that represents a zone around the robot 2901 to be avoided and indicates that the robot 2901 is performing a task.

In the example of FIG. 29B, the light 2902C and the light 2902D indicate the zone around the robot 2901 and warnings to avoid the zone (e.g., text indicating to clear the zone and that the robot 2901 is performing the task). In the illustrated example, the text states “DO NOT ENTER ROBOT UNLOADING.”

FIG. 29C depicts a view 2900C of the robot 2901 of FIG. 29A at a different stage of the unloading task. As discussed herein, the system may identify a zone of the environment that the robot 2901 is operating within to perform a task. The system may identify an alert and may instruct the first light source 2904A and the second light source 2904B to output light 2902E and light 2902F indicative of the alert (e.g., representing a zone around the robot 2901 to be avoided and indicating that the robot 2901 is performing a task). The zone represented by the light 2902E and the light 2902F may be dynamic and may change as the robot 2901 performs the task.

In the example of FIG. 29C, the light 2902E and the light 2902F indicate the zone around the robot 2901 and warnings to avoid the zone. The zone depicted in FIG. 29C may be smaller as compared to the zone depicted in FIG. 29A and FIG. 29B as the system may determine that the robot 2901 has entered a container or truck to perform the task. Because at the illustrated stage of unloading, items (e.g., boxes) have already been unloaded from the container or truck, the robot 2901 moves deeper into the container or truck to reach additional items. Because the robot 2901 is now in the container or truck and the platform extended to follow, the reach of the robot 2901 and thus the zone of exclusion is more limited. In the illustrated example, the text continues to state “DO NOT ENTER ROBOT UNLOADING” but now within a shrunken exclusion zone as compared to the exclusion zones corresponding to the light 2902A, the light 2902B, the light 2902C, and/or the light 2902D.

FIG. 29D depicts a view 2900D of the robot 2901 of FIG. 29A at a stage of unloading after that of FIG. 29C. As discussed herein, the system may identify a zone of the environment that the robot 2901 is operating within to perform a task. The system may identify an alert and may instruct the first light source 2904A and the second light source 2904B to output light 2902G and light 2902H indicative of the alert (e.g., representing the alert).

In the example of FIG. 29D, the light 2902G and the light 2902H indicate the zone around the robot 2901 and warnings to avoid the zone. The zone depicted in FIG. 29D may be even smaller as compared to the zones depicted in FIG. 29A, FIG. 29B, and FIG. 29C as the system may determine that the robot 2901 has further entered the container and thus has an even more limited reach into the unloading chamber. The warning text continues to state “DO NOT ENTER Robot Unloading” but now within an even further shrunken exclusion zone as compared to the exclusion zone corresponding to the light 2902A, the light 2902B, the light 2902C, 2902D, 2902E, and/or the light 2902F.

FIG. 29E depicts a view 2900E of the robot 2901 of FIG. 29A at the stage of FIG. 29B from a different perspective, showing a worker blindly approaching the unloading area. As discussed herein, the system may identify a zone of the environment that the robot 2901 is operating within to perform a task. The system may identify an alert and may instruct the first light source 2904A to output the light 2902I indicative of the alert. As can be seen, the robot 2901 may not be visible to the worker, but the projected warning, showing both the exclusion zone and the warning text “DO NOT ENTER ROBOT UNLOADING” may be visible to the worker before the worker can see the robot 2901.

FIG. 29F depicts a view 2900F of the robot 2901 of FIG. 29A in a different location of the environment. As discussed herein, the system may identify a zone of the environment that the robot 2901 is operating within to perform a task. The system may identify an alert and may instruct a third light source 2904C and a fourth light source 2904D to output light 2902J and light 2902K indicative of the alert.

In the example of FIG. 29F, the third light source 2904C and the fourth light source 2904D are located on opposite ends of a rack that defines an aisle, and the light 2902J and the light 2902K indicate the zone (e.g., the entire row or aisle) of the robot 2901 and warnings to avoid the zone.

FIG. 29G depicts a view 2900G of the robot 2901 of FIG. 29A at a different location of the environment. As discussed herein, the system may identify a zone of the environment that the robot 2901 is operating within to perform a task. The system may identify an alert and may instruct a fifth light source 2904E to output light 2902L indicative of the alert.

In the example of FIG. 29G, the fifth light source 2904E are located on the ends of a rack and the light 2902L indicates the zone (e.g., a row) of the robot 2901 and warnings to avoid the zone. The warning represented by the projected light 2902L is similar to the output light 2804A of FIG. 28A, and serves the same function to warn entities in the environment that may not be able to directly see the robot 2901 of the approach of the robot 2901. FIG. 29G differs from FIG. 28A in that the light is projected from the fifth light source 2904E that is fixed in the environment, e.g., on a wall or rack, as compared to the mobile light source that is part of the robot 2801 of FIG. 28A.

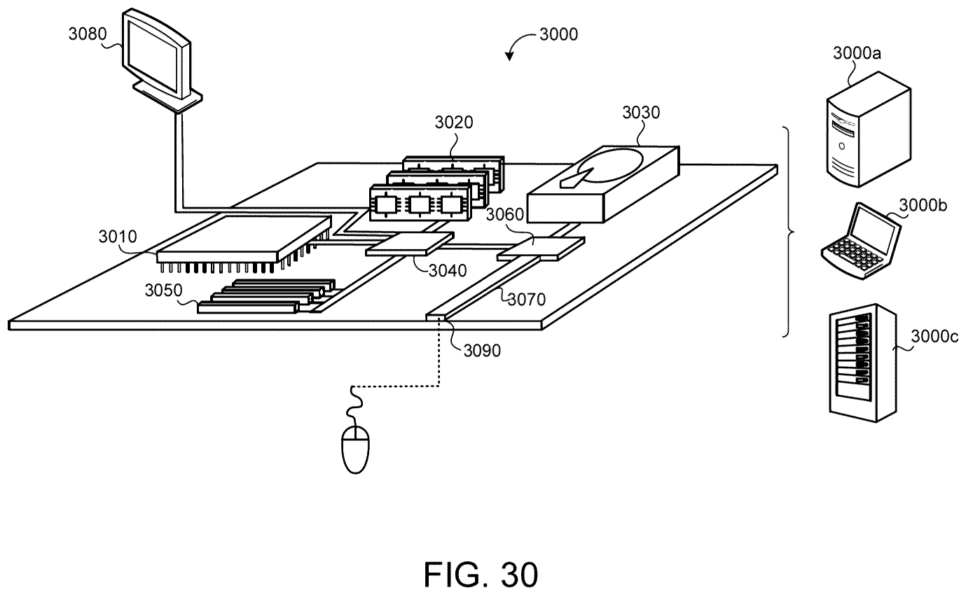

FIG. 30 is a schematic view of an example computing device 3000 that may be used to implement the systems and methods described in this document. The computing device 3000 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 3000 includes a processor 3010, memory 3020 (e.g., non-transitory memory), a storage device 3030, a high-speed interface/controller 3040 connecting to the memory 3020 and high-speed expansion ports 3050, and a low-speed interface/controller 3060 connecting to a low-speed bus 3070 and a storage device 3030. All or a portion of the processor 3010, the memory 3020, the storage device 3030, the high-speed interface/controller 3040, the high-speed expansion ports 3050, and/or the low-speed interface/controller 3060 may be interconnected using various busses, and may be mounted on a common motherboard or in other manners as appropriate. The processor 3010 can process instructions for execution within the computing device 3000, including instructions stored in the memory 3020 or on the storage device 3030 to display graphical information for a graphical user interface (GUI) on an external input/output device, such as display 3080 coupled to the high-speed interface/controller 3040. In other implementations, multiple processors and/or multiple buses may be used, as appropriate, along with multiple memories and types of memory. Also, multiple computing devices 3000 may be connected, with each device providing portions of the necessary operations (e.g., as a server bank, a group of blade servers, or a multi-processor system).

The memory 3020 stores information non-transitorily within the computing device 3000. The memory 3020 may be a computer-readable medium, a volatile memory unit(s), or non-volatile memory unit(s). The memory 3020 may be physical devices used to store programs (e.g., sequences of instructions) or data (e.g., program state information) on a temporary or permanent basis for use by the computing device 3000. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 3030 is capable of providing mass storage for the computing device 3000. In some implementations, the storage device 3030 is a computer-readable medium. In various different implementations, the storage device 3030 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 3020, the storage device 3030, or memory on processor 3010.

The high-speed interface/controller 3040 manages bandwidth-intensive operations for the computing device 3000, while the low-speed interface/controller 3060 manages lower bandwidth-intensive operations. Such allocation of duties is exemplary only. In some implementations, the high-speed interface/controller 3040 is coupled to the memory 3020, the display 3080 (e.g., through a graphics processor or accelerator), and to the high-speed expansion ports 3050, which may accept various expansion cards (not shown). In some implementations, the low-speed interface/controller 3060 is coupled to the storage device 3030 and a low-speed expansion port 3090. The low-speed expansion port 3090, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 3000 may be implemented in a number of different forms, as shown in the figure. For example, it may be implemented as a standard server 3000a or multiple times in a group of such servers 3000a, as a laptop computer 3000b, or as part of a rack server system 3000c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. A processor can receive instructions and data from a read only memory or a random-access memory or both. The essential elements of a computer are a processor for performing instructions and one or more memory devices for storing instructions and data. A computer can include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

1. A method for operating a legged robot, comprising:
obtaining sensor data associated with an environment of a legged robot from one or more sensors of the legged robot;
determining an alert based on the sensor data; and
instructing a projection of light on a surface of the environment of the legged robot indicative of the alert using one or more light sources of the legged robot.

2. The method of claim 1, wherein the surface of the environment of the legged robot comprises:
a ground surface of the environment of the legged robot;
a wall of the environment of the legged robot; or
a surface of a structure, object, entity, or obstacle within the environment of the legged robot.

3. The method of claim 1, further comprising:
determining a brightness of light to be emitted based on the sensor data, wherein instructing the projection of light on the surface of the environment of the legged robot comprises instructing the projection of light on the surface of the environment of the legged robot according to the determined brightness of light.

4. The method of claim 3, wherein the one or more light sources are associated with a minimum brightness of light, wherein the determined brightness of light is greater than the minimum brightness of light.

5. The method of claim 1, wherein instructing the projection of light on the surface of the environment of the legged robot comprises instructing display of image data on the surface of the environment of the legged robot.

6. The method of claim 5, further comprising:
detecting a moving entity in the environment of the legged robot, wherein instructing display of the image data on the surface of the environment of the legged robot is based on detecting the moving entity in the environment of the legged robot.

7. The method of claim 5, further comprising:
obtaining environmental association data linking the environment of the legged robot to one or more entities, wherein instructing display of the image data on the surface of the environment of the legged robot is based on the environmental association data.

8. The method of claim 5, further comprising determining the image data to be displayed, wherein determining the image data to be displayed comprises, based on the sensor data, determining one or more of:
a light intensity of the image data to be displayed;
a light color of the image data to be displayed;
a light direction of the image data to be displayed; or
a light pattern of the image data to be displayed.

9. The method of claim 5, further comprising determining the image data to be displayed, wherein determining the image data to be displayed comprises:
determining an orientation of the legged robot with respect to the environment of the legged robot based on the sensor data; and
determining a light intensity of the image data based on the orientation of the legged robot.

10. The method of claim 5, wherein the image data comprises text.

11. The method of claim 1, wherein the one or more light sources are located on at least one of:
a bottom portion of a body of the legged robot relative to the surface of the environment of the legged robot; or
at least one leg of the legged robot.

12. The method of claim 1, wherein the alert comprises a visual alert, wherein determining the alert comprises:
determining the visual alert of a plurality of visual alerts based on the sensor data, wherein each of the plurality of visual alerts is associated with one or more of a respective light intensity, a respective light color, a respective light direction, or a respective light pattern; and
determining the one or more light sources of a plurality of light sources of the legged robot based on the sensor data and the visual alert, the plurality of light sources including at least two light sources each associated with different visual alerts of the plurality of visual alerts.

13. The method of claim 12, further comprising:
determining lighting conditions in the environment of the legged robot based on the sensor data; and
adjusting one or more of the determined visual alert or a manner of displaying the determined visual alert based on the lighting conditions in the environment of the legged robot.

14. The method of claim 12, wherein the determined visual alert comprises an indication of one or more of:
a path of the legged robot;
a direction of the legged robot;
an action of the legged robot;
an orientation of the legged robot;
a map of the legged robot;
a route waypoint;
a route edge;
a zone of the legged robot, wherein the zone of the legged robot indicates an area of the environment of the legged robot in which one or more of an arm, a leg, or a body of the legged robot may operate;
a state of the legged robot;
a zone associated with one or more of an obstacle, entity, object, or structure in the environment of the legged robot; or
battery information of a battery of the legged robot.

15. The method of claim 12, further comprising:
identifying an action based on the sensor data, wherein the sensor data indicates a request to perform the action; and
instructing movement of the legged robot according to the action, wherein the visual alert indicates the action.

16. The method of claim 12, wherein the determined visual alert is based on light output by the one or more light sources and one or more shadows caused by one or more legs of the legged robot.

17. The method of claim 1, further comprising:
determining data associated with the environment of the legged robot;
determining an action of the legged robot based on the data; and
selecting an output from a plurality of outputs based on the action, wherein each of the plurality of outputs is associated with one or more of a respective intensity, a respective direction, or a respective pattern, wherein the selected output indicates the action, and wherein the projection of light is associated with the selected output.

18. The method of claim 1, wherein instructing the projection of light on the surface of the environment of the legged robot comprises one or more of:
instructing simultaneous display of a light output using a plurality of light sources of the legged robot; or
instructing iterative display of the light output using the plurality of light sources, wherein a first light source of the legged robot corresponds to a first portion of the light output and a second light source of the legged robot corresponds to a second portion of the light output.

19. The method of claim 1, further comprising:
selecting a light pattern to output based on data associated with the environment of the legged robot, wherein the selected light pattern comprises one or more of a temporal pattern of lights to be emitted or a visual pattern of lights to be emitted, wherein instructing the projection of light on the surface of the environment of the legged robot comprises instructing the projection of light on the surface of the environment of the legged robot according to the light pattern.

20. The method of claim 19, wherein the light pattern indicates a path of the legged robot.

21.-53. (canceled)

54. A robot comprising:
a body;
two or more legs coupled to the body; and
one or more light sources positioned on the body and configured to project light on a ground surface of an environment of the robot.

55. The robot of claim 54, wherein the one or more light sources are positioned on a bottom of the body inwardly of the two or more legs.

56. The robot of claim 54, wherein the one or more light sources are located on a side of the body, wherein the one or more light sources are at least partially shielded to prevent upward projection of light in a stable position.

57. The robot of claim 54, wherein the one or more light sources are further configured to project light having an angular range on the ground surface of the environment of the robot such that the light extends beyond a footprint of the two or more legs based on the angular range.

58. The robot of claim 54, wherein the one or more light sources are further configured to project the light on the ground surface of the environment of the robot such that a modifiable image or a modifiable pattern is projected on the ground surface of the environment of the robot.

59. The robot of claim 54, wherein the one or more light sources are positioned on a bottom of the body inwardly of the two or more legs, the one or more light sources positioned and configured to project light downwardly and outwardly beyond a footprint of the two or more legs such that inner surfaces of the two or more legs are illuminated.

60.-64. (canceled)

65. A legged robot comprising:
a body;
four legs coupled to the body; and
one or more light sources located on one or more of:
a leg of the four legs;
a bottom portion of the body, the bottom portion of the body closer in proximity to a ground surface of an environment about the legged robot as compared to a top portion of the body when the legged robot is in a stable position; or
a side of the body, wherein any light sources located on the top portion of the body are at least partially shielded to prevent upward projection of light in the stable position,
wherein the one or more light sources are positioned and configured to project light on the ground surface of the environment of the legged robot.

66. The legged robot of claim 65, wherein the one or more light sources are further configured to project the light on the ground surface according to a light pattern, wherein the light pattern comprises one or more of a temporal pattern of lights to be emitted by the one or more light sources or a visual pattern of lights to be emitted by the one or more light sources.

67. The legged robot of claim 65, wherein the one or more light sources are further configured to project light downwardly and outwardly beyond a footprint of the four legs such that one or more dynamic shadows associated with the four legs are projected on a surface of the environment.

68. The legged robot of claim 65, wherein the one or more light sources are further configured to illuminate one or more inner surfaces of the four legs.

69.-134. (canceled)
